(19) United States
(12) Patent Application Publication
(10) Pub. No.: US 2026/0330528 A1
(43) Pub. Date: Oct. 22, 2026

(54) Systems and Methods for Generating Vehicle Modification Packages for a Target Vehicle

(71) Applicant: ModPro AI, Andover, MA (US)

(72) Inventors: Aaron Bent, Andover, MA (US); Jasper Bent, Andover, MA (US); Caleb White, Newberg, OR (US)

(21) Appl. No.: 19/650,233

(22) Filed: Apr. 16, 2026

Related U.S. Application Data
(60) Provisional application No. 63/790,634, filed on Apr. 17, 2025.
(60) Provisional application No. 63/790,639, filed on Apr. 17, 2025.

(51) Int. Cl. G06Q 30/0601

(52) U.S. Cl. CPC G06Q 30/0631

(57) ABSTRACT

System and method for generating a vehicle modification package for a target vehicle. A computing device receives vehicle-identifying information, a budget, and a user objective. Using stored vehicle and parts data, the computing device intelligently identifies a plurality of vehicle modifications that are compatible with the target vehicle and with one another, forms candidate package-level combinations from the plurality of vehicle modifications, and selects a recommended package according to a projected performance-per-cost score for the target vehicle. The computing device generates the vehicle modification package as the recommended package, generates a predicted performance output for the target vehicle based on installation of the recommended package, and causes an electronic display of a user device to render the vehicle modification package and the predicted performance output.

### RELATED APPLICATIONS

This application claims the benefit of priority to U.S. Provisional Patent Application No. 63/790,634 entitled “Systems and Methods for Generating Artificial Intelligence-Based Vehicle Modification Recommendations” filed on Apr. 17, 2025 and U.S. Provisional Patent Application No. 63/790,639 entitled “Crowdsourced Learning System for Generating Vehicle Modification Guidance” filed on Apr. 17, 2025, the entire contents of both of which are hereby incorporated by reference for all purposes.

### BACKGROUND

Vehicle customization, performance optimization, maintenance, and related automotive transactions have become increasingly data-intensive and fragmented. Modern vehicle owners, enthusiasts, businesses, and service providers may interact with vehicle specification data, diagnostic data, aftermarket product data, community content, service-provider information, and marketplace listings across separate systems that store information in different formats. As a result, users often lack a unified way to create and maintain an accurate digital representation of a vehicle, its installed modifications, its planned modifications, and the technical and commercial information associated with that vehicle.

Existing systems may provide generic part search tools, community forums, social features, or isolated recommendation tools, but often do not maintain a validated knowledge base of automotive brands and parts that may be reused across users, vehicles, and transactions. User-entered modification data may be incomplete, duplicated, misspelled, inconsistently categorized, or associated with inconsistent brand references. In addition, useful information may exist on external product pages or other web resources, yet current systems often cannot reliably ingest a product link, extract relevant automotive information, determine whether the linked item is a valid automotive part, resolve the corresponding brand and part identity, and create a structured modification record associated with a particular vehicle.

Existing vehicle recommendation tools also tend to focus on individual parts or generic suggestions rather than full compatible build packages tailored to a specific vehicle and budget. Many such systems do not generate multiple package options at different budget levels, account for currently installed modifications, predict combined performance effects of a proposed set of modifications, or express confidence in the resulting package based on source credibility, historical outcomes, or community validation. This may leave users to manually compare unrelated recommendations and estimate likely outcomes on their own.

Existing retrieval and search methods in the aftermarket field frequently rely on static catalogs, keyword search, or unweighted browsing of forum discussions and user content. Such approaches may fail to prioritize data associated with similar vehicles, documented builds, validated part combinations, or community-validated outcomes. In particular, current systems often do not retrieve vehicle-specific build records using weighted popularity, engagement, similarity, or validation metrics, and then use those retrieved records as context to generate more accurate vehicle-specific recommendations.

Further, current garage, social, and business tools are often not organized around a vehicle-centric architecture. Generic user profiles may not preserve a vehicle build history, associated parts, linked media, a shareable garage identity, or collaboration between users and businesses around actual vehicles and actual builds. This fragmentation may make it difficult to document work performed on a vehicle, share trusted build information, connect with relevant communities or businesses, or maintain a persistent and technically useful digital garage.

Marketplace and transaction systems in the aftermarket field also remain limited. Users frequently must manually search for compatible parts and services across disparate websites, and existing systems often do not apply actual vehicle fitment, installed-part history, user preferences, watch lists, inventory conditions, or related signals to personalize product discovery, bundled offers, supplier recommendations, or other purchase opportunities. Similarly, businesses may lack efficient ways to present vehicle-specific services, inventory, or promotions to users whose stored vehicle data indicates they are likely relevant.

In addition, existing systems often fail to effectively integrate user-specific inputs, vehicle-specific records, community feedback, validated parts data, marketplace information, and artificial intelligence into a unified technical platform. As a result, users may still rely on trial-and-error, inconsistent online advice, or manual comparison of parts, builds, and service options, even when large volumes of potentially relevant data are available.

Accordingly, there is a need for improved systems and methods that integrate validated automotive part and brand data, vehicle-specific build records, artificial intelligence-based package generation, retrieval-augmented reasoning, visualization, community intelligence, garage and business collaboration, and fitment-aware marketplace operations into a unified platform.

### SUMMARY

Various aspects include methods of generating a vehicle modification package for a target vehicle, the method which may include receiving vehicle identifying information which may include at least a year, make, model, and trim of the target vehicle, receiving a budget and a user objective for the target vehicle, processing the vehicle identifying information, the budget, and the user objective using stored vehicle and parts data to identify, for the target vehicle, a plurality of vehicle modifications that are compatible with the target vehicle and with one another and to select, from candidate package level combinations formed from the plurality of vehicle modifications, a recommended package according to a projected performance per cost score for the target vehicle, generating the vehicle modification package as the recommended package which may include at least a subset of the plurality of vehicle modifications, generating a predicted performance output for the target vehicle based on installation of the recommended package, and causing an electronic display of a user device to render the vehicle modification package and the predicted performance output.

In some aspects, processing the vehicle identifying information, the budget, and the user objective may include generating a structured vehicle record for the target vehicle from the vehicle identifying information, retrieving, using the structured vehicle record, candidate part records for the target vehicle, each candidate part record which may include a part identifier, compatibility metadata, and cost data, generating the candidate package level combinations from the candidate part records, applying vehicle fitment constraints and component interaction constraints to the candidate package level combinations to identify candidate package level combinations that satisfy the vehicle fitment constraints and the component interaction constraints, obtaining, for each candidate package level combination that satisfies the vehicle fitment constraints and the component interaction constraints, predicted performance data and total installed cost, generating, for each candidate package level combination that satisfies the vehicle fitment constraints and the component interaction constraints, a respective projected performance per cost score from the predicted performance data and the total installed cost, and selecting, from the candidate package level combinations that satisfy the vehicle fitment constraints and the component interaction constraints, the recommended package according to the respective projected performance per cost scores, the budget, and the user objective.

Some aspects may further include generating a structured package record for the vehicle modification package, the structured package record which may include normalized part identifiers for the subset of the plurality of vehicle modifications and the predicted performance output, and causing a digital vehicle record associated with the target vehicle to be updated with the structured package record to store the vehicle modification package in association with the target vehicle.

In some aspects, retrieving the candidate part records may include generating a request embedding from at least a portion of the vehicle identifying information, the budget, and the user objective, retrieving a candidate set of vehicle build records using semantic similarity between the request embedding and stored vehicle build record embeddings in a vector database, ranking the candidate set of vehicle build records according to semantic relevance and at least one of a popularity score, a source credibility score, a historical outcome consistency score, or community validated fitment data, and supplementing the candidate part records with normalized part identifiers and associated fitment metadata retrieved from a top ranked subset of the candidate set.

Some aspects may further include determining a recurring subset of the normalized part identifiers across the top ranked subset of the candidate set, generating a package confidence score based on (i) recurrence counts for the recurring subset, (ii) one or more source credibility scores associated with the top ranked subset, (iii) historical outcome consistency data associated with the recurring subset, and (iv) community validated fitment data associated with the recurring subset, and causing the electronic display of the user device to render the package confidence score with the vehicle modification package.

Some aspects may further include receiving currently installed vehicle modifications for the target vehicle, receiving real time vehicle sensor data from an onboard diagnostic interface associated with the target vehicle, receiving a driving purpose and one or more priority weights for the user objective, and generating a current vehicle state from the currently installed vehicle modifications and the real time vehicle sensor data, in which obtaining, for each candidate package level combination that satisfies the vehicle fitment constraints and the component interaction constraints, the predicted performance data may include obtaining the predicted performance data based further on the current vehicle state, the driving purpose, and the one or more priority weights.

In some aspects, generating the predicted performance output may include generating a baseline performance profile for the target vehicle from stored vehicle specification data and the current vehicle state, and generating the predicted performance output relative to the baseline performance profile. In some aspects, the predicted performance output may include at least one predicted horsepower value, at least one predicted torque value, at least one predicted braking metric, at least one predicted handling metric, or at least one graphical performance curve, and causing the electronic display of the user device to render the vehicle modification package and the predicted performance output may include causing the electronic display of the user device to render the baseline performance profile together with the predicted performance output.

In some aspects, generating the candidate package level combinations may include determining a plurality of budget bands from the budget, generating a plurality of candidate packages corresponding to the plurality of budget bands, obtaining, for each candidate package, respective predicted performance data and respective total installed cost, generating, for each candidate package, a respective projected performance per cost score from the respective predicted performance data and the respective total installed cost, ranking the plurality of candidate packages according to the respective projected performance per cost scores, and selecting the recommended package from the plurality of candidate packages according to the ranking.

Some aspects may further include receiving an edit input associated with the vehicle modification package, the edit input specifying replacement, removal, or addition of at least one vehicle modification, generating an edited vehicle modification package from the edit input, resolving each vehicle modification in the edited vehicle modification package against the candidate part records to identify a corresponding candidate part record, reapplying the vehicle fitment constraints and the component interaction constraints to the edited vehicle modification package and to the corresponding candidate part records to verify compatibility of the edited vehicle modification package, regenerating the predicted performance output for the edited vehicle modification package, and causing the electronic display of the user device to render the edited vehicle modification package together with the regenerated predicted performance output.

Further aspects may include a computing device (e.g., server, mobile device, etc.) having a processor configured with processor-executable instructions to perform various operations corresponding to the methods discussed above. Further aspects may include a computing device having various means for performing functions corresponding to the method operations discussed above. Further aspects may include a non-transitory processor-readable storage medium having stored thereon processor-executable instructions configured to cause a processor to perform various operations corresponding to the method operations discussed above.

### BRIEF DESCRIPTION OF THE DRAWINGS

The accompanying drawings, which are incorporated herein and constitute part of this specification, illustrate exemplary aspects of the invention, and together with the general description given above and the detailed description given below, serve to explain the features of the invention.

FIGS. 1A-1C are system diagrams illustrating various components in a computing system that could be configured to implement the various embodiments.

FIG. 1D is a system diagram illustrating a vehicle-centric garage, business-garage, and sharable profile architecture in accordance with some embodiments.

FIG. 2 is a process flow diagram illustrating a method for data normalization of automotive inputs in accordance with some embodiments.

FIG. 3A is a process flow diagram illustrating a method for retrieval-augmented generation (RAG) based automotive data retrieval in accordance with some embodiments.

FIG. 3B is a process flow diagram illustrating a method for document-based, popularity-weighted retrieval augmented generation for vehicle build recommendations in accordance with some embodiments.

FIGS. 4A-4C are process flow diagrams that illustrate methods of extended reality (XR) based modification visualization in accordance with some embodiments.

FIG. 5 is a process flow diagram illustrating a method for modification kit generation in accordance with some embodiments.

FIG. 6 is a process flow diagram illustrating a method for interactive installation guidance in accordance with some embodiments.

FIG. 7 is a process flow diagram illustrating a method for generating and using a learning system for crowdsourced installation knowledge in accordance with some embodiments.

FIG. 8 is a process flow diagram illustrating a method for community matching in accordance with some embodiments.

FIG. 9A is a process flow diagram illustrating a method for professional service recommendation and integration in accordance with some embodiments.

FIG. 9B is a process flow diagram illustrating a method for fitment-aware marketplace filtering and personalized bundle or deal generation in accordance with some embodiments.

FIG. 10A is a process flow diagram illustrating a method for data normalization and integration for vehicle modification insights in accordance with some embodiments.

FIG. 10B is a process flow diagram illustrating a method for generating and maintaining a validated automotive brand and part knowledge base in accordance with some embodiments.

FIG. 10C is a process flow diagram illustrating a method for link-based modification ingestion and structured modification record creation in accordance with some embodiments.

FIGS. 11A-11G are process flow diagrams that illustrate methods of validating vehicle authenticity and detecting fraudulent modifications in accordance with some embodiments.

FIGS. 12A-12E are process flow diagrams that illustrate methods of diagnosing vehicle performance issues based on sound analysis in accordance with some embodiments.

FIGS. 13A-13C are process flow diagrams that illustrate methods of generating vehicle modification recommendations in accordance with various embodiments.

FIG. 13D is a process flow diagram illustrating a method for generating multiple AI-orchestrated vehicle modification packages based on vehicle data, user preferences, driving objectives, and budget constraints in accordance with some embodiments.

FIG. 13E is a process flow diagram illustrating a method for editing, validating, and storing an AI-generated vehicle modification package in association with a vehicle record in accordance with some embodiments.

FIGS. 14A and 14B are process flow diagrams illustrating method for generating a vehicle modification recommendation for a target vehicle in accordance with some embodiments.

FIG. 15 is a component diagram of a computing system suitable for implementing some embodiments.

FIG. 16 is a component block diagram of a laptop that is a computing device suitable for implementing some embodiments.

FIG. 17 is a component block diagram of a mobile computing device suitable for implementing some embodiments.

FIG. 18 is a component block diagram of a server computing device suitable for implementing some embodiments.

### DETAILED DESCRIPTION

The various embodiments may be described in detail with reference to the accompanying drawings. Wherever possible, the same reference numbers may be used throughout the drawings to refer to the same or like parts. References made to particular examples and implementations are for illustrative purposes and are not intended to limit the scope of the invention or the claims.

In overview, the embodiments include methods, computing devices, and processing systems configured to assist users in building, validating, visualizing, sharing, maintaining, recommending, buying, selling, and otherwise managing vehicle modifications and related vehicle information using artificial intelligence (AI), retrieval-augmented generation (RAG), data normalization, and other similar technologies. The processing system may integrate diverse data sources, including vehicle specifications, VIN-linked vehicle records, real-time sensor data, historical modification outcomes, user preferences, user-generated content, community engagement data, manufacturer data, aftermarket product data, service-provider data, and marketplace data. In some embodiments, the processing system may organize these inputs into structured vehicle, part, brand, user, business, package, and marketplace records that may be reused across multiple workflows.

Some embodiments may maintain a validated automotive knowledge base that includes automotive brands, parts, part numbers, source-confidence fields, fitment attributes, vector embeddings, and related metadata. The processing system may ingest structured, semi-structured, or unstructured information from user entries, external webpages, scraped product sources, images, documents, or other sources, determine whether the information corresponds to a valid automotive part or brand, and create or update structured records based on that determination. In some embodiments, the processing system may receive a product link, extract relevant webpage content, parse the content with an AI model, resolve corresponding brand and part identities, and create a modification record associated with a vehicle, a smart package, a collection, a marketplace workflow, etc.

Some embodiments may also create and maintain vehicle-specific build records or vehicle documents in a document database, vector database, or related retrieval structure. The processing system may retrieve related records based on year, make, model, trim, engine type, similarity, popularity, community validation, or other weighted criteria and may provide the retrieved records as context to a language model or other AI model. By using retrieved build records, part histories, and related vehicle information, the processing system may generate more accurate vehicle-specific recommendations, validate parts and packages with greater confidence, and identify combinations of modifications that have demonstrated compatibility or popularity across similar vehicles.

Some embodiments may generate vehicle-specific modification packages based on a user vehicle, currently installed modifications, budget, intended driving style, and other priority inputs. The processing system may generate multiple candidate packages, predict performance changes for each package, calculate confidence values based on source credibility and other factors, and store a selected package as a vehicle-linked smart collection. In some embodiments, the processing system may further support vehicle-centric user garages, business garages, sharable profile links, community and business collaboration, and fitment-aware marketplace operations that recommend compatible parts, services, bundles, suppliers, or transaction opportunities based on stored vehicle and user data.

In some embodiments, the processing system may further maintain a multi-dimensional user intelligence profile that extends beyond static vehicle specifications and includes behavioral, demographic, social, and purchase-intent signals. By way of example, the user intelligence profile may include one or more of geographic information, age range, spending behavior, preferred brands, current vehicles, past vehicles, desired future vehicles, dream vehicles, saved parts, watched products, watchlist activity, purchase frequency, purchase-readiness indicators, time-to-close indicators, followed businesses, followed tuners, followed creators, forum participation, group participation, liked content, shared content, search history, and other engagement or preference signals. The processing system may correlate these signals with vehicle-specific data, modification histories, community outcomes, business inventory conditions, and marketplace data to generate recommendations that are specific both to the vehicle and to the user rather than recommendations based only on year, make, model, and budget.

In some embodiments, the processing system may derive higher-level behavioral intelligence from the user intelligence profile and associated vehicle records. For example, the processing system may detect emerging purchase intent, identify probable next modifications, identify likely future vehicle interests, estimate demand for categories of parts across regions or climates, or rank candidate businesses, communities, sellers, bundles, or grouped modification packages according to predicted user relevance. The resulting intelligence may be used by a data-driven vehicle modification recommendation system, a marketplace system, a vendor network interface, a connections system, a social interaction module, and a RAG system to provide individualized packages, targeted content, community suggestions, recommended suppliers, personalized deal opportunities, and other similar information or functionalities.

The term “computing device” may be used herein to refer to any or all of server computing devices, personal computing devices, desktop computers, workstations, laptops, tablets, smartphones, connected vehicles, autonomous vehicles, electric vehicles (EVs), drones, wearable devices (e.g., smartwatches, fitness trackers, augmented reality (AR) glasses, virtual reality (VR) headsets, mixed reality (MR) devices, earbuds, smart clothing, etc.), multimedia-enabled mobile devices, Internet of Things (IoT) devices (e.g., smart TVs, smart speakers, smart locks, lighting systems, smart thermostats, doorbell cameras, security systems, smart home hubs, smart mirrors, smart displays, etc.), audio devices (e.g., HomePod™, Echo™, Google Nest™, Sonos™, etc.), gaming systems (e.g., PlayStation™, Xbox™, Nintendo Switch™, Steam Deck™, Meta Quest™, etc.), media players (e.g., Roku™, Apple TV™, Chromecast™, Fire TV™, etc.), smart appliances (e.g., smart refrigerators, smart ovens, smart washing machines, robotic vacuums, etc.), e-readers (e.g., Kindle™, Kobo™), portable projectors, foldable smartphones, and other similar devices that include memory and programmable processors for providing the functionality described herein.

The term “processing system” may be used herein to refer to one or more processors, including multi-core processors, that are organized and configured to perform various computing functions. Various embodiment methods may be implemented in one or more of multiple processors within a processing system as described herein.

The term “system on chip” (SoC) is used herein to refer to a single integrated circuit (IC) chip that contains multiple resources or independent processors integrated on a single substrate. A single SoC may contain circuitry for digital, analog, mixed-signal, and radio-frequency functions. A single SoC may include at least one processor of a processing system that includes any number of general-purpose or specialized processors (e.g., network processors, digital signal processors, modem processors, video processors, etc.), memory blocks (e.g., ROM, RAM, Flash, etc.), and resources (e.g., timers, voltage regulators, oscillators, etc.). For example, an SoC may include an applications processor that operates as the SoC's main processor, central processing unit (CPU), microprocessor unit (MPU), arithmetic logic unit (ALU), etc. An SoC processing system may also include software for controlling integrated resources and processors, as well as for controlling peripheral devices.

The term “system in a package” (SIP) is used herein to refer to a single module or package that contains multiple resources, computational units, cores, or processors on two or more IC chips, substrates, or SoCs. For example, a SIP may include a single substrate on which multiple IC chips or semiconductor dies are stacked vertically. Similarly, the SIP may include one or more multi-chip modules (MCMs) on which multiple ICs or semiconductor dies are packaged into a unifying substrate. An SIP may also include multiple independent SOCs coupled together via high-speed communication circuitry and packaged in close proximity, such as on a single motherboard, in a single UE, or a single CPU device. The proximity of the SoCs facilitates high-speed communications and the sharing of memory and resources.

The terms “machine learning algorithm,” “artificial intelligence model” and the like may be used herein to refer to any of a variety of information structures that may be used by a computing device to perform a computation or evaluate a specific condition, feature, factor, dataset, or behavior on a device. Examples of machine learning (ML) algorithms include network models, neural network models, inference models, neuron models, classifiers, random forest models, spiking neural network (SNN) models, convolutional neural network (CNN) models, recurrent neural network (RNN) models, deep neural network (DNN) models, generative network models, ensemble networks, generative adversarial networks, and genetic algorithm models. In some embodiments, a machine learning algorithm may include an architectural definition (e.g., the neural network architecture, etc.) and one or more weights (e.g., neural network weights, etc.).

The term “neural network” may be used herein to refer to an interconnected group of processing nodes (or neuron models) that collectively operate as a software application or process that controls a function of a computing device and/or generates an overall inference result as output. Individual nodes in a neural network may attempt to emulate biological neurons by receiving input data, performing simple operations on the input data to generate output data, and passing the output data (also called “activation”) to the next node in the network. Each node may be associated with a weight value that defines or governs the relationship between input data and output data. A neural network may learn to perform new tasks over time by adjusting these weight values. In some cases, the overall structure of the neural network and/or the operations of the processing nodes do not change as the neural network learns a task. Rather, learning is accomplished during a “training” process in which the values of the weights in each layer are determined. As an example, the training process may include causing the neural network to process a task for which an expected/desired output is known, comparing the activations generated by the neural network to the expected/desired output, and determining the values of the weights in each layer based on the comparison results. After the training process is complete, the neural network may begin “inference” to process a new task with the determined weights.

The term “inference” may be used herein to refer to a process that is performed at runtime or during execution of the software application program corresponding to the machine learning algorithm. Inference may include traversing the processing nodes in a network (e.g., neural network, etc.) along a forward path (which may include some backwards traversals) to produce one or more values as an overall activation or overall “inference result”.

The term “deep neural network” may be used herein to refer to a neural network that implements a layered architecture in which the output/activation of a first layer of nodes becomes an input to a second layer of nodes, the output/activation of a second layer of nodes becomes an input to a third layer of nodes, and so on. As such, computations in a deep neural network may be distributed over a population of processing nodes that make up a computational chain. Deep neural networks may also include activation functions and sub-functions between the layers. The first layer of nodes of a multilayered or deep neural network may be referred to as an input layer. The final layer of nodes may be referred to as an output layer. The layers in-between the input and final layer may be referred to as intermediate layers.

The term “transformer” may be used herein to refer to a specific type of neural network that includes an encoder and/or a decoder and is particularly well-suited for sequence data processing. Transformers may use multiple self-attention components to process input data in parallel rather than sequentially. The self-attention components may be configured to weigh different parts of an input sequence when producing an output sequence. Unlike solutions that focus on the relationship between elements in two different sequences, self-attention components may operate on a single input sequence. The self-attention components may compute a weighted sum of all positions in the input sequence for each position, which may allow the model to consider other parts of the sequence when encoding each element. This may offer advantages in tasks that benefit from understanding the contextual relationships between elements in a sequence, such as sentence completion, translation, and summarization. The weights may be learned during the training phase, allowing the model to focus on the most contextually relevant parts of the input for the task at hand. Transformers, with their specialized architecture for handling sequence data and their capacity for parallel computation, often serve as foundational elements in constructing large generative AI models (LXM).

The term “large generative AI model” (LXM) may be used herein to refer to an advanced computational framework that includes any of a variety of specialized AI models including, but not limited to, large language models (LLMs), large speech models (LSMs), large/language vision models (LVMs), vision language models (VLMs)), hybrid models, and multi-modal models. An LXM may include multiple layers of neural networks (e.g., RNN, LSTM, transformer, etc.) with millions or billions of parameters. Unlike traditional systems that translate user prompts into a series of correlated files or web pages for navigation, LXMs support dialogic interactions and encapsulate expansive knowledge in an internal structure. As a result, rather than merely serving a list of relevant websites, LXMs are capable of providing direct answers and/or are otherwise adept at various tasks, such as text summarization, translation, complex question-answering, conversational agents, etc. In various embodiments, LXMs may operate independently as standalone units, may be integrated into more comprehensive systems and/or into other computational units (e.g., those found in a SoC or SIP, etc.), and/or may interface with specialized hardware accelerators to improve performance metrics such as latency and throughput. In some embodiments, the LXM component may be enhanced with or configured to perform an adaptive algorithm that allows the LXM to better understand context information, evaluating weights of connections between nodes in a feature graph, etc. In some embodiments, the adaptive algorithms may be performed by the same processing system that manages the core functionality of the LXM and/or may be distributed across multiple independent processing systems.

The term “extended reality” (XR) may be used herein to refer to any of a variety of sense-enhancing technologies, including virtual reality (VR), augmented reality (AR), mixed reality (MR), and other technologies for processing, manipulating or presenting digital output (e.g., images, text, sounds, haptic feedback, tactile output, etc.) in two or three dimensions. For example, an XR application may be a virtual reality application that simulates a user's physical presence in a virtual environment, incorporating the temporal dimension and spatial positioning within that environment. An XR application may also be an augmented reality application that combines real-world images from a user's physical environment with computer-generated imagery, presenting images and information about people and/or objects to the user superimposed on the visual world as an augmented scene (and adding a spatial dimension). As yet another example, an XR software application may be a mixed reality application that merges real and virtual worlds to produce new environments and visualizations in which physical and digital objects co-exist and interact in real time (and including both temporal and spatial dimensions).

The term “user objective” may be used herein to refer to a computer-implemented data structure stored in memory that encodes a target state for a vehicle workflow. A processing system may generate, store, retrieve, update, or compare the user objective during package generation, ranking, validation, output generation, etc. As further examples, a user objective may identify one or more desired vehicle outcomes, operating modes, preference weights, constraint states, or optimization states. In some embodiments, the processing system may derive a user objective from user input, vehicle data, historical data, community data, or a learned model.

The term “budget” may be used herein to refer to a computer-readable constraint data element stored in memory that bounds an allowed package resource level for a vehicle workflow. In some embodiments, the processing system may compare the budget to aggregate package resource values during candidate generation, ranking, validation, or selection. In some embodiments, the budget may be represented as a scalar value, a range, a ceiling, a floor, a band, or a multidimensional constraint vector. In some embodiments, the processing system may derive the budget from user input, vehicle data, historical records, model output, or another stored data structure.

The term “vehicle modification” may be used herein to refer to a computer-implemented data structure stored in memory that identifies a change element associated with a vehicle. In some embodiments, the processing system may generate, store, retrieve, update, rank, validate, or output the vehicle modification during package construction, package editing, or vehicle-state management. In some embodiments, the vehicle modification may identify a part record, a calibration record, a configuration record, a service record, an installation step, or a dependency record.

The term “vehicle modification package” may be used herein to refer to a computer-implemented data structure stored in memory that groups one or more vehicle modifications for a selected vehicle. In some embodiments, the processing system may generate, store, retrieve, update, rank, validate, or output the vehicle modification package as a single build object. In some embodiments, the vehicle modification package may correspond to a candidate package, a recommended package, an edited package, a saved package, or an installed package.

The term “recommended package” may be used herein to refer to a computer-implemented data structure stored in memory that identifies a selected vehicle modification package from a candidate set. In some embodiments, the processing system may select the recommended package according to one or more ranking outputs, constraint states, or learned outputs. In some embodiments, the recommended package may remain linked to a vehicle record, a package record, or a display object.

The term “compatible” may be used herein to refer to a computer-readable compatibility state stored in memory that represents whether two or more records satisfy one or more vehicle constraints or package constraints. In some embodiments, the processing system may generate, store, retrieve, update, compare, or validate the compatibility state during filtering, package construction, package editing, or package verification. In some embodiments, the compatibility state may represent direct compatibility, conditional compatibility, compatibility with dependency records, or incompatibility.

The term “projected performance-per-cost score” may be used herein to refer to a computer-implemented score stored in memory that a processing system derives from predicted performance data and one or more package resource fields. In some embodiments, the processing system may generate, store, retrieve, update, compare, or output the projected performance-per-cost score during ranking, filtering, or selection. In some embodiments, the projected performance-per-cost score may be represented as a scalar value, a vector value, a rank, a band, or another comparative output.

The term “predicted performance output” may be used herein to refer to a computer-implemented data structure stored in memory that represents a predicted vehicle result associated with one or more vehicle modifications or a vehicle modification package. In some embodiments, the processing system may generate, store, retrieve, update, compare, or output the predicted performance output from one or more models, rules, or learned functions. In some embodiments, the predicted performance output may include one or more values, ranges, curves, profiles, confidence fields, warning fields, or tradeoff fields.

The term “render” may be used herein to refer to a process executed by a processing system that causes perceivable output at a display device. In some embodiments, the processing system may render by generating, transmitting, formatting, or updating display data for text, graphics, curves, tables, cards, overlays, or another display object. In some embodiments, the rendering may occur on a local or remote device.

The term “part identifier” may be used herein to refer to a computer-readable data element stored in memory that identifies a part record. In some embodiments, the processing system may generate, store, retrieve, compare, resolve, or transmit the part identifier during part resolution, package construction, validation, or display generation. In some embodiments, the part identifier may correspond to a canonical identifier, a source identifier, or another identifier value linked to a part record.

The term “normalized part identifier” may be used herein to refer to a computer-readable data element stored in memory that represents a normalized form of a part identifier within a common schema. In some embodiments, the processing system may generate the normalized part identifier by mapping alias data, source-specific data, or extracted data to a canonical record. In some embodiments, the processing system may store, retrieve, compare, or reuse the normalized part identifier across vehicle records, package records, and part records.

The term “vehicle-build record” may be used herein to refer to a computer-implemented data structure, stored in memory, that represents a vehicle configuration and one or more associated vehicle modifications. In some embodiments, the processing system may generate, store, retrieve, update, rank, embed, or output the vehicle-build record for search, recommendation, validation, or learning. In some embodiments, the vehicle-build record may include vehicle identity fields, modification fields, outcome fields, fitment fields, provenance fields, engagement fields, or another structured field. In some embodiments, the vehicle-build record may be stored as a document object or another structured object.

The term “current vehicle state” may be used herein to refer to a computer-implemented data structure, stored in memory, that represents a present vehicle condition for a selected vehicle. In some embodiments, the processing system may generate, store, retrieve, update, compare, or output the current vehicle state from installed-modification data, sensor data, diagnostic data, or another vehicle data source. In some embodiments, the current vehicle state may include configuration fields, operating fields, fault fields, constraint fields, or baseline-linked fields.

The term “onboard diagnostic interface” may be used herein to refer to a hardware component, within a computing device or vehicle communication path, that exchanges vehicle data with a processing system. In some embodiments, the onboard diagnostic interface may expose sensor data, diagnostic data, control-unit data, or other vehicle-state data to the processing system. In some embodiments, the onboard diagnostic interface may be implemented as a port, an adapter, a gateway, a telematics module, or another hardware interface. In some embodiments, the processing system may poll, read, receive, parse, or normalize data received through the onboard diagnostic interface.

The term “baseline performance profile” may be used herein to refer to a computer-implemented data structure, stored in memory, that represents a reference performance state for a selected vehicle. In some embodiments, the processing system may generate, store, retrieve, update, compare, or output the baseline performance profile from vehicle specification data, current vehicle state data, or another reference data source. In some embodiments, the baseline performance profile may include one or more values, ranges, curves, confidence fields, or linked reference fields.

The term “cost data” may be used herein to refer to a computer-implemented data structure, stored in memory, that represents one or more package resource values associated with a part record or a package record. In some embodiments, the processing system may generate, store, retrieve, update, or aggregate the cost data during package construction, ranking, scoring, or selection. In some embodiments, the cost data may be represented as a scalar value, a range, a normalized weight, or another resource field.

The term “total installed cost” may be used herein to refer to an aggregate package resource value, generated by a processing system, from multiple package elements. In some embodiments, the processing system may generate the total installed cost by aggregating resource fields associated with line items, dependency items, installation steps, or other package elements. In some embodiments, the total installed cost may be used during package ranking, filtering, selection, or output generation.

The term “vehicle data” may be used herein to refer to a computer-implemented collection of data associated with a selected vehicle. In some embodiments, the processing system may receive, store, retrieve, normalize, update, compare, or output the vehicle data during recommendation generation, ranking, validation, or package generation. In some embodiments, the vehicle data may include vehicle-identifying information, currently installed vehicle modifications, vehicle specification data, performance measurement data, modification preference data, driving-habit data, sensor data, historical modification records, or combinations thereof.

The term “industry data” may be used herein to refer to a computer-implemented collection of external automotive information associated with a selected vehicle. In some embodiments, the processing system may retrieve, compare, normalize, or output the industry data during recommendation generation, compatibility analysis, or ranking. In some embodiments, the industry data may include manufacturer specification data, historical performance data, aftermarket parts compatibility data, crash statistics, safety data, or other external automotive reference data.

The term “structured vehicle data” may be used herein to refer to a normalized computer-implemented data structure generated from vehicle data and, in some embodiments, industry data. In some embodiments, the processing system may generate, store, retrieve, compare, rank, or output the structured vehicle data during feature extraction, retrieval, recommendation generation, or package generation. In some embodiments, the structured vehicle data may include normalized vehicle identity fields, vehicle specification fields, installed-modification fields, performance-related fields, preference fields, and compatibility-related fields arranged according to a standardized automotive schema.

The term “candidate modification set” may be used herein to refer to a computer-implemented grouping of one or more candidate vehicle modifications identified for a selected vehicle before final recommendation selection. In some embodiments, the processing system may generate, store, retrieve, evaluate, rank, filter, or output the candidate modification set during recommendation generation. In some embodiments, the candidate modification set may include one or more parts, tuning adjustments, supporting modifications, or other compatible vehicle modifications associated with one or more projected outcomes.

The term “structured vector database” may be used herein to refer to a data store configured to maintain vector representations of, for example, automotive data together with indexed relationships among vehicle characteristics, modification outcomes, and fitment constraints. In some embodiments, the processing system may store, retrieve, search, rank, or update records in the structured vector database during recommendation generation, similarity searching, feasibility analysis, or package generation. In some embodiments, the structured vector database may store vector embeddings corresponding to vehicle data, vehicle-build records, modification histories, historical outcomes, or related metadata.

The term “vehicle performance profile” may be used herein to refer to a computer-implemented data structure that represents one or more actual or predicted performance characteristics of a selected vehicle. In some embodiments, the processing system may generate, store, retrieve, update, compare, or output the vehicle performance profile from vehicle specification data, real-time vehicle data, current vehicle state data, historical modification data, or model-generated predicted modification effects. In some embodiments, the vehicle performance profile may include baseline performance parameters, predicted modification effects, scalar values, ranges, confidence intervals, curves, or trade-off indicators.

The term “modification ruleset” may be used herein to refer to a computer-readable set of rules, thresholds, or constraints used to evaluate a proposed vehicle modification relative to a selected vehicle. In some embodiments, the processing system may apply, store, retrieve, update, or compare the modification ruleset during recommendation generation, compatibility filtering, feasibility analysis, or package generation. In some embodiments, the modification ruleset may define compatibility constraints between vehicle components, performance thresholds, safety constraints, dependency constraints, or component interaction constraints.

The term “modification feasibility score” may be used herein to refer to a computer-implemented score representing the suitability of a candidate vehicle modification for a selected vehicle. In some embodiments, the processing system may generate, store, retrieve, update, compare, or output the modification feasibility score during recommendation generation or interactive recommendation presentation. In some embodiments, the modification feasibility score may be based on projected performance impact, component compatibility, safety constraints, reliability factors, or combinations thereof.

The term “projected outcome data” may be used herein to refer to a computer-implemented set of predicted results associated with a candidate vehicle modification or candidate modification set. In some embodiments, the processing system may generate, store, retrieve, update, compare, rank, or output the projected outcome data during recommendation generation. In some embodiments, the projected outcome data may include projected performance gains, projected safety impacts, projected compatibility results, projected cost data, or trade-off data.

The term “outcomes dataset” may be used herein to refer to a computer-implemented dataset storing implemented vehicle modifications and corresponding observed outcomes. In some embodiments, the processing system may generate, store, retrieve, update, compare, or use the outcomes dataset during model retraining, ranking refinement, or recommendation refinement. In some embodiments, the outcomes dataset may include installed parts, actual performance outcomes, user selections, acceptance or rejection signals, measured results, or post-installation telemetry.

The various embodiments improve the accuracy, transparency, efficiency, and usability of vehicle customization, maintenance, build planning, validation, and related automotive transactions.

The various embodiments include methods of generating a vehicle modification package for a target vehicle. A processing system may be configured to receive vehicle-identifying information including at least a year, make, model, and trim of a target vehicle, and to receive a budget and a user objective for the target vehicle. The processing system may further process the vehicle-identifying information, the budget, and the user objective using stored vehicle and parts data to identify, for the target vehicle, a plurality of vehicle modifications that are compatible with the target vehicle and with one another and to select, from candidate package-level combinations formed from vehicle modifications, a recommended package according to a projected performance-per-cost score for the target vehicle. The processing system may further generate a vehicle modification package as the recommended package, with the vehicle modification package comprising at least a subset of vehicle modifications, generate a predicted performance output for the target vehicle based on installation of the recommended package, and cause an electronic display of a user device to render the vehicle modification package and the predicted performance output.

In some embodiments, the processing system may process the vehicle-identifying information, the budget, and the user objective by generating a structured vehicle record for the target vehicle from the vehicle-identifying information and retrieving, using the structured vehicle record, candidate part records for the target vehicle. Each candidate part record may include a part identifier, compatibility metadata, and cost data. The processing system may further generate the candidate package-level combinations from the candidate part records, apply vehicle fitment constraints and component interaction constraints to the candidate package-level combinations to identify candidate package-level combinations that satisfy the vehicle fitment constraints and the component interaction constraints, obtain, for each candidate package-level combination that satisfies the vehicle fitment constraints and the component interaction constraints, predicted performance data and total installed cost, generate, for each candidate package-level combination that satisfies the vehicle fitment constraints and the component interaction constraints, a respective projected performance-per-cost score from the predicted performance data and the total installed cost, and select, from the candidate package-level combinations that satisfy the vehicle fitment constraints and the component interaction constraints, the recommended package according to the respective projected performance-per-cost scores, the budget, and the user objective.

In some embodiments, the processing system may generate a structured package record for the vehicle modification package, with the structured package record comprising normalized part identifiers for the subset of the plurality of vehicle modifications and the predicted performance output. The processing system may further cause a digital vehicle record associated with the target vehicle to be updated with the structured package record to store the vehicle modification package in association with the target vehicle.

In some embodiments, the processing system may retrieve the candidate part records by generating a request embedding from at least a portion of the vehicle-identifying information, the budget, and the user objective, retrieving a candidate set of vehicle-build records using semantic similarity between the request embedding and stored vehicle-build-record embeddings in a vector database, ranking the candidate set of vehicle-build records according to semantic relevance and at least one of a popularity score, a source-credibility score, a historical-outcome-consistency score, or community-validated fitment data, and supplementing the candidate part records with normalized part identifiers and associated fitment metadata retrieved from a top-ranked subset of the candidate set.

In some embodiments, the processing system may determine a recurring subset of the normalized part identifiers across the top-ranked subset of the candidate set and may generate a package confidence score based on recurrence counts for the recurring subset, one or more source-credibility scores associated with the top-ranked subset, historical-outcome-consistency data associated with the recurring subset, and community-validated fitment data associated with the recurring subset. The processing system may further cause the electronic display of the user device to render the package confidence score with the vehicle modification package.

In some embodiments, the processing system may receive currently installed vehicle modifications for the target vehicle, receive real-time vehicle sensor data from an onboard diagnostic interface associated with the target vehicle, receive a driving purpose and one or more priority weights for the user objective, and generate a current vehicle state from the currently installed vehicle modifications and the real-time vehicle sensor data. In some such embodiments, the processing system may obtain, for each candidate package-level combination that satisfies the vehicle fitment constraints and the component interaction constraints, the predicted performance data based further on the current vehicle state, the driving purpose, and the one or more priority weights.

In some embodiments, the processing system may generate the predicted performance output by first generating a baseline performance profile for the target vehicle from stored vehicle specification data and the current vehicle state, and then generating the predicted performance output relative to the baseline performance profile. In some embodiments, the processing system may generate the predicted performance output to include at least one predicted horsepower value, at least one predicted torque value, at least one predicted braking metric, at least one predicted handling metric, or at least one graphical performance curve. In some embodiments, the processing system may cause the electronic display of the user device to render the vehicle modification package and the predicted performance output by rendering the baseline performance profile together with the predicted performance output. In some embodiments, the processing system may generate candidate package-level combinations by determining a plurality of budget bands from the budget and generating a plurality of candidate packages corresponding to each budget band. The processing system may further obtain, for each candidate package, respective predicted performance data and respective total installed cost, generate, for each candidate package, a respective projected performance-per-cost score from the respective predicted performance data and the respective total installed cost, rank the plurality of candidate packages according to the respective projected performance-per-cost scores, and select the recommended package from candidate packages according to the ranking.

In some embodiments, the processing system may receive an edit input associated with the vehicle modification package that specifies the replacement, removal, or addition of at least one vehicle modification, and may generate an edited vehicle modification package from the edit input. The processing system may further resolve each vehicle modification in the edited vehicle modification package against the candidate part records to identify a corresponding candidate part record, reapply the vehicle fitment constraints and the component interaction constraints to the edited vehicle modification package and to the corresponding candidate part records to verify compatibility of the edited vehicle modification package, regenerate the predicted performance output for the edited vehicle modification package, and cause the electronic display of the user device to render the edited vehicle modification package together with the regenerated predicted performance output. In some embodiments, the processing system may cause the electronic display of the user device to render the vehicle modification package and the predicted performance output by causing an electronic display of the computing device to render the vehicle modification package and the predicted performance output. In some embodiments, the processing system may cause the electronic display of the user device to render the vehicle modification package and the predicted performance output by causing an electronic display of a remote computing device to render the vehicle modification package and the predicted performance output.

Unlike conventional solutions that rely on disconnected part searches and manual comparison, the embodiments may provide a coordinated vehicle-specific recommendation workflow for a target vehicle. A processing system may receive a budget, a user objective, and vehicle-identifying information that includes at least a year, make, model, and trim for the target vehicle. The processing system may identify vehicle modifications compatible with the target vehicle and with one another, select a recommended package from candidate package-level combinations based on a projected performance-per-cost score, and generate a predicted performance output for the recommended package. The processing system may further cause an electronic display to present the vehicle modification package together with the predicted performance output. This workflow may tie the vehicle modification package to the target vehicle, the budget, the user objective, and a predicted vehicle result.

Conventional vehicle recommendation tools focus on isolated part suggestions, static catalogs, or generic search results. Those tools lack a coordinated workflow in which a processing system receives vehicle-identifying information, budget data, and user objective data, applies compatibility constraints to candidate package-level combinations, selects a recommended package according to a projected performance-per-cost score, generates a predicted performance output for the recommended package, and causes a display to present the vehicle modification package together with the predicted performance output. Rather than automate part search, fitment lookup, or performance estimation in isolation, some embodiments provide an ordered interaction among vehicle identification, inter-part compatibility, package-level scoring, predicted performance generation, and rendered package output within one vehicle-specific recommendation workflow.

In some embodiments, the vehicle modification package and the predicted performance output may function as structured technical outputs that remain linked to the target vehicle after selection of the recommended package. The processing system may generate a structured vehicle record for the target vehicle, retrieve candidate part records having compatibility metadata and cost data, apply vehicle fitment constraints and component interaction constraints to identify candidate package-level combinations, select the recommended package from the candidate package-level combinations, and generate a structured package record that stores normalized part identifiers for the vehicle modification package together with the predicted performance output in association with a digital vehicle record. The processing system may further use the structured package record for compatibility verification, package editing, package retrieval, marketplace presentation, installation planning, and post-installation outcome updates for the target vehicle. As a result, the embodiments may transform vehicle-identifying information, parts data, and predicted performance data into persistent machine-readable records that support later storage, retrieval, validation, and update operations of the processing system.

By using structured record generation, compatibility filtering, package scoring, predicted performance generation, and persistent package storage within a single vehicle-specific workflow, the embodiments may improve the performance and functionality of the computing device. The processing system may generate and maintain a structured vehicle record, candidate part records, a vehicle modification package, a predicted performance output, and a structured package record for later validation, storage, retrieval, editing, and update operations. Early compatibility filtering may reduce evaluation of incompatible candidate package-level combinations. Structured package records and vehicle-linked build states may preserve machine-readable outputs for later recommendation, marketplace, and garage workflows. As a result, the embodiments may narrow the computational search space, reduce redundant evaluation operations, and improve response quality and practical functionality for a computing system or network that supports vehicle-specific package generation, package presentation, and package update workflows.

In some embodiments, the processing system may address high latency and excess memory traffic during vehicle-specific package selection from large part datasets. The processing system may generate a structured vehicle record and candidate part records, apply compatibility constraints before package construction, generate a request embedding, query a vector database, and supplement the candidate part records with normalized part identifiers from top-ranked vehicle-build records. The processing system may further generate a baseline performance profile and package scores, and output a structured package record for a recommended package. In a benchmark with 1.2 million part records, the memory-controller counters may show, for example, a 35% to 55% reduction in DRAM read traffic. Across 10,000 requests, NIC telemetry together with processor power-rail data may show, for example, a 22% to 34% reduction in payload bytes per request and a 9% to 16% reduction in joules per recommendation. These technical effects follow from, for example, early compatibility pruning and vector-database retrieval because the processing system may avoid transfer of non-matching records and repeat scoring passes. For all these reasons, the embodiments improve the performance and functioning of the computing devices, the communication networks, and their constituent components.

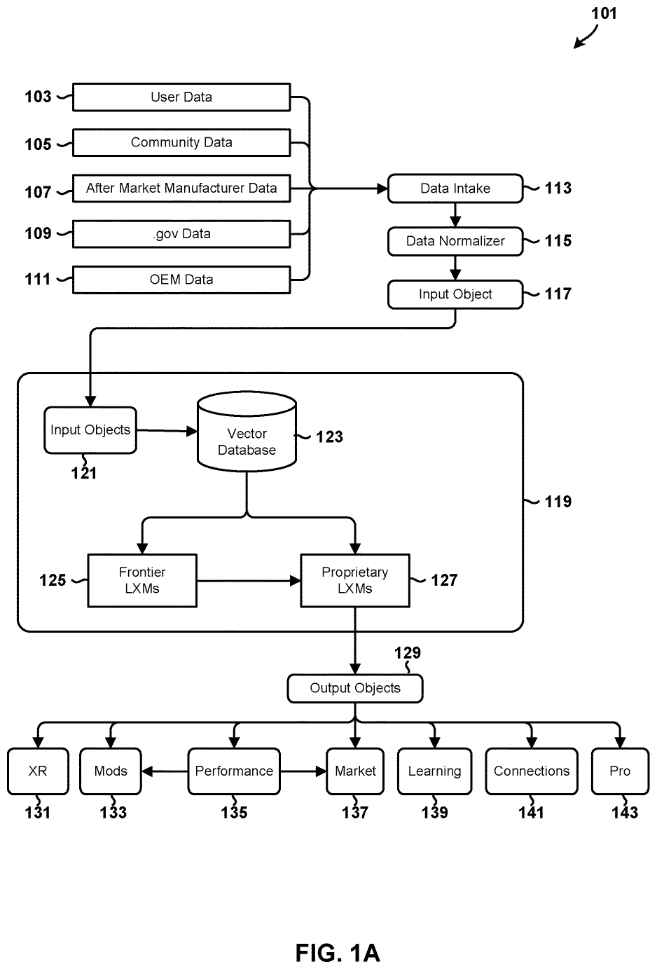

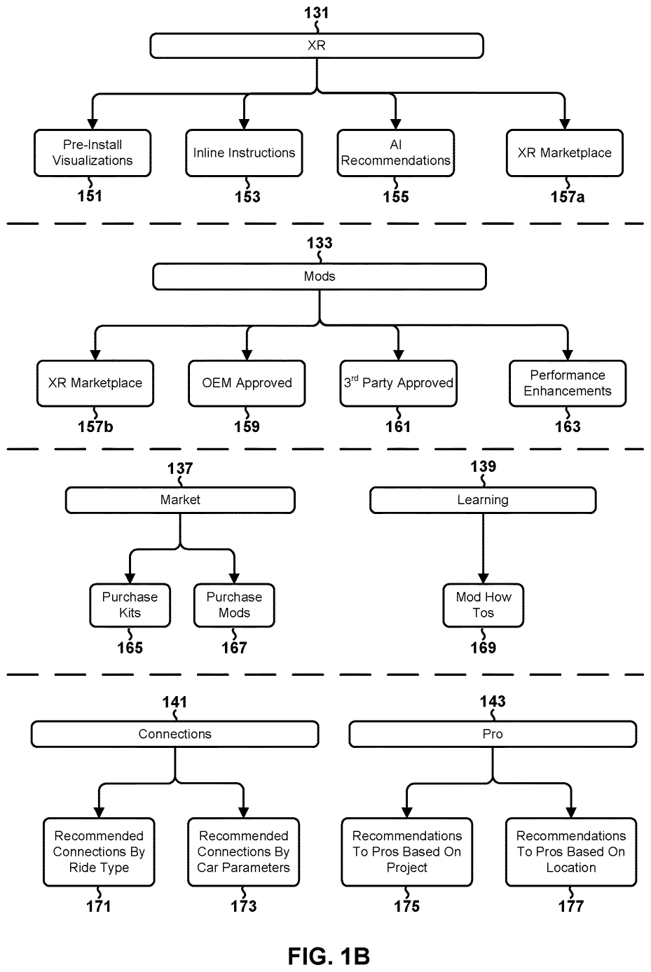

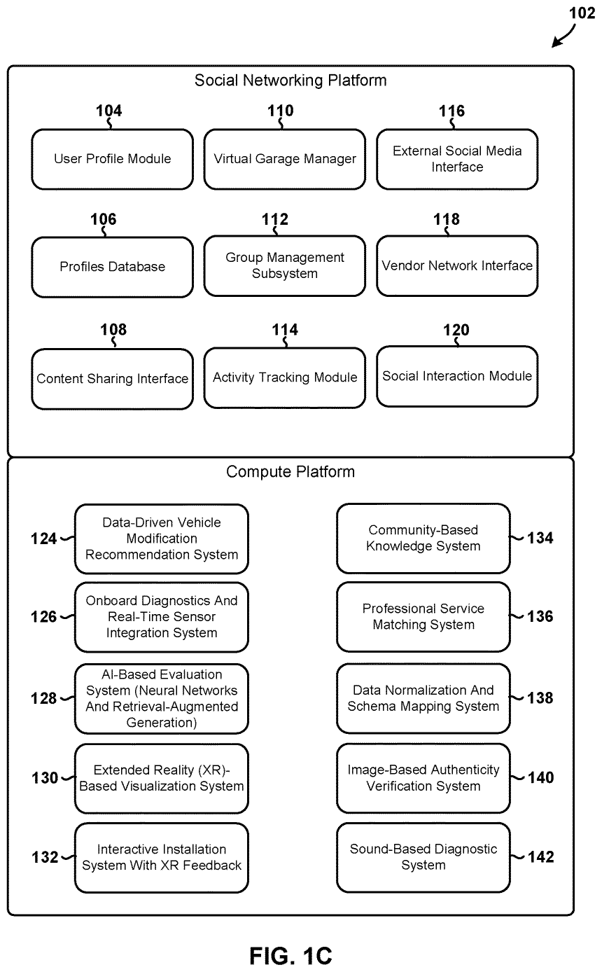

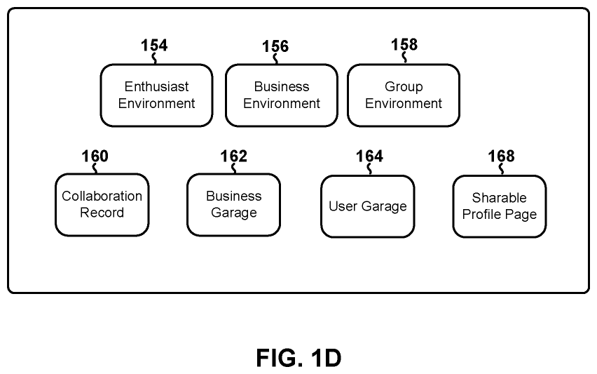

FIGS. 1A-1C are system diagrams illustrating various components in a computing system 101, 102 that could be configured to implement the various embodiments. The computing systems illustrated and described with reference to FIGS. 1A-1C may integrate data analytics, augmented reality, artificial intelligence, community-generated insights, and other systems that collectively provide comprehensive vehicle modification recommendations, real-time diagnostic insights, verified professional assistance, accurate modification visualizations, interactive installation guidance, and reliable authenticity verification.

In the example illustrated in FIGS. 1A and 1B, the computing system 101 accepts user data 103, community data 105, aftermarket manufacturer data 107, government data 109, and OEM data 111 through a data intake 113. The data normalizer 115 converts these inputs into standardized input objects 117 for subsequent analysis. A RAG system 119 applies the input objects 121 to a vector database 123 and uses frontier LXMs 125 or proprietary LXMs 127 to generate refined output objects 129. In some embodiments, the input objects 121 or output objects 129 may further include canonical brand records, canonical part records, vehicle-centric build documents, smart package records, collaboration records, and fitment-aware marketplace records. These refined output objects may feed into an XR system 131, a mods system 133, a performance system 135, a marketplace system 137, a learning system 139, a connections system 141, or a pro system 143, and may further be consumed by auxiliary services that perform link-based modification ingestion, validated brand or part resolution, popularity-weighted vehicle-build retrieval, package orchestration, or short-link garage publishing. The XR system 131 may produce pre-install visualizations 151 and inline installation instructions 153, offer AI recommendations 155, provide an XR marketplace 157a, and present vehicle modifications with guidance for accurate installation. The modification system 133 may provide an XR marketplace 157b, OEM-approved modifications 159, third-party approved modifications 161, or performance enhancements 163, and may enable users to search, validate, or add modifications suited to specific vehicles. In some embodiments, the marketplace system 137 may support purchase, sale, recommendation, or exchange of modification kits 165, individual components 167, vehicles, and related automotive services based on computing system 101 recommendations, vehicle-specific fitment analyses, and user-specific marketplace preferences. The marketplace system 137 may operate as a user-to-user marketplace, a user-to-business marketplace, a business-to-user marketplace, or a hybrid marketplace that presents listings from individual enthusiasts, verified suppliers, tuning shops, dealerships, installers, and other vendors. The marketplace system 137 may evaluate marketplace listing data against vehicle records associated with a user, including make, model, year, trim, engine configuration, installed modifications, planned modifications, and compatibility constraints, and may prioritize exact-fit or high-confidence-fit listings while suppressing incompatible listings. In addition, the marketplace system 137 may generate personalized bundles, promotions, recommended suppliers, and purchasing opportunities responsive to user-specific vehicle data, saved items, watchlists, budget constraints, community behavior, or seller inventory conditions. The learning system 139 may offer instructional guides 169 derived from manufacturer documentation, community content, or user insights. The connections system 141 may recommend connections by ride type 171 or vehicle parameters 173 and match users or businesses who share interests, vehicles, or build characteristics. The pro system 143 may recommend automotive professionals based on project type 175 or user location 177 and may further support build collaborations associated with real vehicle records.

In some embodiments, the RAG system 119 may further maintain a vehicle-build document repository that stores vehicle-specific build documents derived from user data 103, community data 105, aftermarket manufacturer data 107, government data 109, and OEM data 111. Each vehicle-build document may correspond to a vehicle or vehicle configuration identified by year, make, model, trim, engine, drivetrain, vehicle identification number, or another vehicle identifier, and may include installed modifications, removed modifications, planned modifications, performance measurements, fitment outcomes, dyno results, maintenance records, verified brand or part identifiers, user engagement metrics, and source-confidence metrics. The RAG system 119 may generate vector embeddings for the vehicle-build documents or portions thereof, store the vector embeddings in the vector database 123, and provide ranked vehicle-build documents as context to frontier LXMs 125 and/or proprietary LXMs 127 for use in generating community-informed vehicle modification recommendations, grouped modification packages, or related output objects 129.

In some embodiments, the marketplace system 137 may further operate as a fitment-aware marketplace that leverages vehicle records stored by the virtual garage manager 110 and validated part records stored by the data normalization and schema mapping system 138. The fitment-aware marketplace may automatically filter parts listings, bundled offers, business promotions, or peer-to-peer listings based on a user's known vehicles, installed modifications, or compatibility constraints. For example, when a user accesses marketplace listings for brakes or suspension components, the marketplace system 137 may prioritize listings compatible with the user's year, make, model, trim, current brake package, or wheel dimensions rather than presenting only generic search results.

In some embodiments, the marketplace system 137 may support peer-to-peer and business-to-user transactions involving both parts and vehicles. The marketplace system 137 may combine vehicle fitment data, user behavior data, wishlist data, saved-item data, and business inventory data to generate hyper-personalized bundles, promotions, or purchase recommendations. For example, the marketplace system 137 may identify that a user has saved suspension components compatible with a tracked vehicle and may then recommend a discounted bundle from a business profile whose inventory matches the user's vehicle and budget. In some embodiments, the marketplace system 137 may also use validated modification data and build-history data to improve listing accuracy for modified vehicles or parts sold through peer-to-peer interfaces.

In the example illustrated in FIG. 1C, the computing system 102 includes a processing system that implements all or portions of a user profile module 104, a profiles database 106, a content sharing interface 108, a virtual garage manager 110, a group management subsystem 112, an activity tracking module 114, an external social media interface 116, a vendor network interface 118, a social interaction module 120, a data-driven vehicle modification recommendation system 124, an onboard diagnostics and real-time sensor integration system 126, AI-based evaluation system 128, XR-based visualization system 130, interactive installation system with XR feedback 132, a community-based knowledge system 134, a matching system 136, a data normalization and schema mapping system 138, an image-based authenticity verification system 140, and a sound-based diagnostic system 142, any or all of which may include or work in conjunction with any or all of the components 101-177 illustrated and described with reference to FIGS. 1A-1B.

In some embodiments, the computing system 102 may further implement one or more auxiliary subsystems that extend the functionalities illustrated in FIGS. 1A-1C. The auxiliary subsystems may include a smart package orchestration subsystem, a vehicle-document repository and popularity-weighted retrieval subsystem, a validated brand and parts knowledge-base subsystem, a link-based modification ingestion subsystem, a business garage subsystem, a build collaboration subsystem, a profile publishing subsystem configured to generate shareable short-link garage pages, and a fitment-aware marketplace subsystem. The auxiliary subsystems may execute as standalone services or in conjunction with the user profile module 104, virtual garage manager 110, external social media interface 116, vendor network interface 118, social interaction module 120, data-driven vehicle modification recommendation system 124, AI-based evaluation system 128, and data normalization and schema mapping system 138. In some embodiments, these auxiliary subsystems may cooperate to maintain vehicle-centric build records, validate automotive brands and parts across multiple data sources, generate grouped modification packages through AI, publish shareable garage pages, coordinate collaborations around real-world vehicle builds, and facilitate fitment-aware buying, selling, or recommendation experiences.

In some embodiments, the computing system 102 may support multiple user environments including enthusiast profiles, business profiles, and group-based community environments. Each environment may share a common identity, vehicle, content, and transaction framework, yet may expose different interfaces, permissions, and data views. For example, an enthusiast profile may emphasize vehicle history, installed modifications, planned builds, and personalized recommendations; a business profile may emphasize services, verified capabilities, product showcases, storefront functions, and customer interactions; and a group environment may emphasize membership controls, moderated content feeds, and organized community discussions. These environments may interact through shared discovery, search, tagging, following, messaging, and recommendation features so that vehicle data, marketplace data, and social engagement data reinforce one another throughout the computing system 102.

The user profile module 104 may manage multiple profile types within the community platform, including individual enthusiast profiles, business profiles, creator profiles, and administrator profiles associated with groups or clubs. The user profile module 104 may allow each profile to store identity data, vehicle ownership or affiliation data, interests, geographic information, privacy settings, and permission rules governing access to associated vehicles, posts, groups, or collaborations. In addition, the user profile module 104 may allow an enthusiast profile to associate multiple current vehicles, past vehicles, planned future vehicles, or other vehicles such as motorcycles or trucks with the profile, and may allow a business profile to associate services, specialties, supported vehicle makes, portfolio vehicles, verified partners, or external links with the business profile. The user profile module 104 may further integrate with the virtual garage manager 110, vendor network interface 118, and social interaction module 120 to personalize discovery functions, enable collaboration around specific vehicle builds, and support sharing of vehicle or business profiles inside or outside the platform.

The profiles database 106 may store user account details, authentication credentials, vehicle ownership information, and user-specific parameters relevant to modification suggestions. In addition, the profiles database 106 may maintain versioned records of user data to track profile changes over time. Versioned records may provide historically informed modification suggestions or enable users to revert to earlier vehicle configurations. In addition, the profiles database 106 may integrate user data with social networking components, such as shared installation experiences or participation in community discussions.

The content sharing interface 108 may be configured to allow users to upload vehicle-related multimedia content such as images, videos, or written descriptions of modifications or automotive experiences. The content sharing interface 108 may support tagging or categorizing uploaded content to simplify discovery within the user community. In addition, the content sharing interface 108 may link uploaded multimedia content directly to user profiles or community groups. This linkage may allow community members to view, comment, react, or share the content, thereby increasing user engagement and facilitating collaborative interaction.

The virtual garage manager 110 may be configured to allow users to build and maintain virtual representations of their real-world vehicles and corresponding build histories. The virtual garage manager 110 may aggregate data from the profiles database 106, user-submitted modifications, business-provided installation records, user-uploaded documents, or onboard sensor readings to accurately present each vehicle's current state, historical modifications, planned modifications, performance metrics, maintenance logs, and related media. In addition, the virtual garage manager 110 may maintain vehicle-specific collections of modifications, including installed parts, candidate parts, or AI-generated packages associated with the vehicle, and may permit users to compare multiple vehicles in a single garage view. The virtual garage manager 110 may further support creation of public, private, or permissioned garage views that may be shared with other community members, linked to collaborations with businesses, or published through generated short links or social interactions.

In some embodiments, the virtual garage manager 110 may maintain vehicle-specific marketplace profiles for one or more user vehicles. A vehicle-specific marketplace profile may include vehicle identity information, installed component data, planned modifications, preferred brands, performance targets, compatibility constraints, and purchase-interest indicators such as saved searches, watched parts, or desired vehicle listings. The virtual garage manager 110 may expose these vehicle-specific marketplace profiles to the marketplace system 137 and vendor network interface 118 so that marketplace listings, recommended bundles, and seller recommendations may be filtered or ranked according to actual fitment and user-specific vehicle goals. Where a user maintains multiple vehicles in the virtual garage, the virtual garage manager 110 may allow marketplace interactions to be scoped to a selected vehicle or may automatically associate marketplace recommendations with the most relevant vehicle profile.

In some embodiments, the virtual garage manager 110 may further support vehicle-centric build records that distinguish among current modifications, planned modifications, historical modifications, and AI-generated grouped packages. The virtual garage manager 110 may organize modifications into structured collections associated with a specific vehicle, such as installed collections, wish lists, service collections, or smart packages generated by the data-driven vehicle modification recommendation system 124. Each collection may include canonical part identifiers, brand identifiers, fitment data, projected performance data, validation states, installation states, and provenance metadata identifying whether a component originated from a user submission, a business listing, a manufacturer source, or an AI-generated recommendation. For example, when a user accepts a grouped recommendation package, the virtual garage manager 110 may associate the package with the vehicle as a smart collection, store predicted horsepower or torque values, and later update the collection as individual components are purchased, installed, or replaced.

In some embodiments, the virtual garage manager 110 may store build-level associations between users, businesses, and vehicle records to represent work performed on real vehicles. A vehicle record may include one or more collaboration entries identifying a business that installed a component, tuned a system, supplied a part, or otherwise contributed to the build, together with timestamps, media, invoices, validation documents, or performance results. The virtual garage manager 110 may present these collaboration entries within the vehicle history so that users may maintain persistent build provenance and businesses may showcase verified work associated with actual vehicle records.

The group management subsystem 112 may organize community interactions by managing user-created groups or clubs focused on specific vehicles, brands, regions, driving styles, modification interests, or projects. The group management subsystem 112 may handle membership settings such as public, private, or invite-only access and may provide moderation and administrative tools for approving members, managing posted content, assigning roles, pinning high-value content, or sending targeted announcements to selected users within the group. In addition, the group management subsystem 112 may support collaborative functions including shared build discussions, project-specific posts, event coordination, and curation of vehicle, business, or modification content relevant to the group. The group management subsystem 112 may further integrate with the content sharing interface 108, activity tracking module 114, and social interaction module 120 to populate group-specific feeds, highlight collaborative builds, and promote relevant user, business, or vehicle content to group members.

The activity tracking module 114 may monitor and record user activities, including multimedia content uploads, modifications completed, interactions through comments, and participation in group activities. The activity tracking module 114 may log these events, associate them with corresponding user profiles, vehicles, or groups, and generate personalized activity timelines or community-wide newsfeeds. In addition, the activity tracking module 114 may provide real-time notifications to inform users about recent activities performed by their social connections, such as completed vehicle modifications or new community posts. In addition, the activity tracking module 114 may analyze user interaction patterns, such as identifying posts with high engagement, to highlight popular modifications or suggest new community groups relevant to user interests.

The external social media interface 116 may allow users or businesses to publish vehicle modifications, build updates, business pages, or community events externally through third-party platforms while preserving a canonical in-platform profile view. In some embodiments, the external social media interface 116 may generate a short link or other shareable profile link associated with a user garage, business garage, or specific vehicle, where the short link resolves to a platform-hosted page that presents the corresponding vehicle records, modification history, media, and selected external links in a unified view. The external social media interface 116 may further support exporting selected content such as vehicle images, build summaries, collaboration records, or business updates for posting to external networks, and may support importing social handles, contacts, or linked profiles to simplify onboarding and identity mapping. This external publishing capability may broaden discovery of garages, businesses, or collaborative builds while maintaining the platform as a source of record for vehicle-specific data.

In some embodiments, the external social media interface 116 may support generation of a compact shareable profile link that resolves to a garage page associated with a user or business profile. The shareable profile link may present a curated summary of one or more vehicles, installed modifications, specifications, media, posts, external social links, business information, or marketplace listings without requiring the receiving user to navigate multiple external platforms. For example, a user may place the shareable profile link in a third-party biography section and direct viewers to a garage page that displays the user's vehicle lineup, modification history, featured builds, and associated links in a single destination. In some embodiments, access permissions, view analytics, and audience-specific content may be controlled through the external social media interface 116 or the user profile module 104.

The vendor network interface 118 may work in conjunction with the professional service matching system 136 to connect users directly with automotive professionals, parts suppliers, creators, or other businesses within the platform through business-specific garage pages. The vendor network interface 118 may present business profiles that include information such as an about section, supported services, reviews, posts, portfolio vehicles, galleries, product or inventory listings, and links to related businesses or external resources. Users may purchase automotive components, request installation quotes, follow businesses, schedule appointments, or review business-generated content through this interface. In addition, the vendor network interface 118 may support business-to-user and business-to-business collaborations tied to specific real-world vehicle builds, such that a business may be linked to work performed on a vehicle, installed parts, service records, media, or other build artifacts that remain associated with both the business profile and the vehicle garage. The vendor network interface 118 may further integrate with user-generated feedback, fitment or compatibility data, and user or vehicle preferences to improve vendor discovery, reliability, and relevance.

In some embodiments, the vendor network interface 118 may present business-specific storefronts, seller inventories, featured products, portfolio vehicles, promotional campaigns, or fulfillment options that are dynamically tailored according to user garage data and marketplace behavior. The vendor network interface 118 may surface recommended suppliers within search results or purchase flows based on exact fitment, predicted compatibility, reliability metrics, proximity, inventory availability, or purchase-likelihood scores. In addition, the vendor network interface 118 may track user interactions with products or sellers, including views, saves, watchlist additions, cart additions, and prior purchases, and may use these interactions to generate time-sensitive offers, bundle suggestions, or recommended seller results for users who demonstrate a threshold level of purchasing intent.

In some embodiments, the computing system 102 may support collaboration records associated with real-world vehicle builds rather than merely content collaborations. A collaboration record may associate a user vehicle record with one or more business profiles, other user profiles, or group entities that contributed parts, labor, tuning, design work, documentation, or validation to the vehicle build. The collaboration record may store contributor identifiers, component identifiers, service descriptions, dates, images, videos, dyno results, invoices, installation documents, or verification states. For example, when a tuning shop installs suspension components on a user's vehicle, the collaboration record may link the user's garage entry to the tuning shop's business garage profile, thereby allowing the user to preserve build provenance and allowing the business to showcase the completed work as part of its authenticated portfolio.

The social interaction module 120 may manage user interactions such as commenting on posts, sending private messages, following profiles, tagging other users or businesses, and establishing social or project-specific connections between platform participants. The social interaction module 120 may track these interactions and maintain a structured graph representing relationships among users, businesses, vehicles, groups, and modifications. In some embodiments, the social interaction module 120 may support collaboration workflows in which a user profile and a business profile jointly create, approve, or publish a shared build record for a real vehicle, the shared build record identifying one or more parties associated with the build, installed parts, services performed, dates, media, or permissions for reuse and display. In addition, the social interaction module 120 may store engagement metrics such as likes, reactions, endorsements, or shares and may integrate these metrics into content ranking, collaboration visibility, or recommendation engines. For example, the social interaction module 120 may identify trending builds, high-value collaborations, or highly engaged businesses and use these signals to improve discovery functions or feed generation.

The data-driven vehicle modification recommendation system 124 may be configured to analyze standardized vehicle data and produce personalized modification plans according to vehicle compatibility and user-defined objectives. In addition, the recommendation module may integrate with user profile module 104 and virtual garage manager 110 to tailor modification suggestions based on user-provided vehicle data, previous modifications, and community-validated modification results. Users may then share personalized recommendations via the content sharing interface 108.

In some embodiments, the data-driven vehicle modification recommendation system 124 may include an AI advisor subsystem configured to generate complete grouped modification packages for a specific vehicle rather than isolated part recommendations. The AI advisor subsystem may receive user inputs that include a selected vehicle, currently installed modifications, a selected driving purpose, a target budget or budget range, and optionally user-defined priority settings indicating relative emphasis on horsepower, torque, suspension performance, braking performance, handling characteristics, aesthetics, reliability, or performance-per-cost objectives. In addition, the AI advisor subsystem may generate or suggest a target budget based on vehicle valuation data, historical spending data associated with similar vehicles, or previously observed user spending patterns. The AI advisor subsystem may generate multiple package tiers, such as a lower-cost package, a target-budget package, and a premium package, and may output projected performance metrics, predicted horsepower and torque values, graphical performance curves relative to a baseline vehicle state, projected costs, compatibility information, and confidence indicators for each package. Users may compare, bookmark, edit, save, or associate these generated packages with vehicle records maintained by the virtual garage manager 110.

In some embodiments, the data-driven vehicle modification recommendation system 124 may include a data collection module, an analysis engine, and a recommendation module. The data collection module may gather information such as vehicle sensor readings, onboard diagnostic data, user driving patterns, vehicle specifications, modification history, etc. The analysis engine may evaluate the collected data against stored automotive data, historical modification outcomes, established vehicle performance metrics, etc. The recommendation module may identify suitable vehicle modifications based on the analysis results, user preferences, vehicle compatibility constraints stored within a standardized database, etc.

In some embodiments, the data-driven vehicle modification recommendation system 124 may collect vehicle-specific information such as total mileage, engine performance metrics, active diagnostic trouble codes, observed driving conditions, etc. The data-driven vehicle modification recommendation system 124 may also accept user-defined objectives such as improved fuel efficiency, enhanced off-road capability, increased horsepower, improved handling characteristics, etc. The analysis engine may process these data points and match identified vehicle conditions or user goals with available modification solutions. The recommendation module may present these matched modifications to the user interface along with associated details such as recommended components, expected performance benefits, projected costs, anticipated installation complexity, etc.

For example, the data-driven vehicle modification recommendation system 124 may detect elevated engine operating temperatures or frequent off-road driving patterns from the collected sensor data and driving history. The analysis engine may compare these detected conditions with known automotive conditions stored within the standardized modification database. In response to elevated engine temperatures, the recommendation module may identify compatible cooling system upgrades such as high-capacity radiators or improved air intake components. In response to detected frequent off-road driving, the recommendation module may recommend compatible suspension lift kits or enhanced shock absorbers suitable for rugged terrain. The recommendation module may rank these modification solutions based on effectiveness, vehicle compatibility, and user-defined criteria to provide prioritized and precise recommendations through the user interface.

In some embodiments, the data-driven vehicle modification recommendation system 124 may be configured to generate dynamic and personalized modification recommendations based on real-time vehicle data. For example, the data-driven vehicle modification recommendation system 124 may detect from collected sensor data that the vehicle frequently tows heavy trailers or cargo loads. In response, the recommendation module may identify suitable upgrades such as high-performance brake pads, reinforced suspension components, or enhanced transmission cooling systems from the standardized modification database. In another example, the data-driven vehicle modification recommendation system 124 may analyze user driving patterns and detect frequent short trips in urban environments. Based on this analysis, the recommendation module may recommend compatible upgrades such as engine oil catch cans or higher-capacity batteries with increased cold-cranking amperage ratings. The data-driven vehicle modification recommendation system 124 may combine vehicle-specific sensor data and user driving patterns to produce accurate, personalized, and effective modification recommendations.

In some embodiments, the data-driven vehicle modification recommendation system 124 may further include a smart package orchestration subsystem configured to generate grouped modification packages according to user budget, vehicle configuration, intended driving style, and user-defined priority weights. The smart package orchestration subsystem may receive a current vehicle state that includes installed modifications, sensor-derived performance data, vehicle specifications, and historical build information, and may coordinate multiple AI evaluations to generate a plurality of candidate grouped packages. For example, the smart package orchestration subsystem may generate a lower-cost package, a target-budget package, and a higher-performance package, each including multiple compatible parts together with projected horsepower, torque, reliability impacts, or installation considerations. In some embodiments, the smart package orchestration subsystem may also estimate a suggested budget based on vehicle value, comparable builds, user behavior, or historical package outcomes.

In some embodiments, the smart package orchestration subsystem may support post-generation package editing and package persistence. A user may accept, reject, bookmark, or modify a grouped package by substituting brands or components while the processing system recalculates projected performance metrics and compatibility constraints in response to the edits. The processing system may assign a confidence score to a grouped package based on source credibility, community validation, historical outcome consistency, or verified part provenance. Accepted grouped packages may be stored within the virtual garage manager 110 as smart collections associated with the user's vehicle, whether or not the grouped packages have been physically installed.

The onboard diagnostics and real-time sensor integration system 126 may analyze vehicle sensor data to detect operational conditions, maintenance requirements, modification opportunities, etc. In addition, the integrated sensor data may automatically update user profiles managed by virtual garage manager 110, and trigger event notifications or activity updates displayed through the activity tracking module 114, keeping community members informed of recent vehicle conditions or diagnostic alerts.

In some embodiments, the onboard diagnostics and real-time sensor integration system 126 may connect directly to vehicle onboard diagnostic ports such as an OBD-II port or CAN bus. This connection may provide access to diagnostic trouble codes or telemetry data (e.g., engine RPM, vehicle speed, coolant temperature, fuel pressure, etc.). In addition, the onboard diagnostics and real-time sensor integration system 126 may integrate data from built-in vehicle sensors such as tire pressure monitors or external aftermarket sensors such as accelerometers or environmental sensors. The onboard diagnostics and real-time sensor integration system 126 may process sensor readings, normalize the sensor values, timestamp the data, and combine multiple sensor inputs into a unified real-time dataset. The integrated data may be transmitted to other systems such as the data-driven vehicle modification recommendation system 124 or the XR-based visualization system 130 or may be presented directly to users through a user interface.

In some embodiments, the onboard diagnostics and real-time sensor integration system 126 may establish a data connection with vehicle electronic control units (ECUs). This data connection may use wired connectors or wireless adapters to access ECU data streams. Once connected, the onboard diagnostics and real-time sensor integration system 126 may continuously or periodically poll for diagnostic data (e.g., engine performance parameters, fluid temperatures, pressures, active fault codes, etc.). In addition, the onboard diagnostics and real-time sensor integration system 126 may retrieve additional external sensor data (e.g., from GPS devices providing speed or altitude measurements, gyroscopes indicating vehicle orientation, etc.). The onboard diagnostics and real-time sensor integration system 126 may convert raw sensor readings to standardized measurement units for consistency across multiple data sources. In addition, the onboard diagnostics and real-time sensor integration system 126 may filter irrelevant sensor fluctuations, remove noise, or detect events such as a rapid temperature rise or the appearance of a new diagnostic trouble code.

The onboard diagnostics and real-time sensor integration system 126 may provide consistent, reliable, and timely information about vehicle states to other system components. For example, when an ECU generates a diagnostic code indicating an engine ignition misfire, the onboard diagnostics and real-time sensor integration system 126 may immediately relay this information to the AI-based evaluation system 128 for detailed analysis or corrective action suggestions. In some embodiments, the onboard diagnostics and real-time sensor integration system 126 may transmit processed sensor data to other components or store sensor data for subsequent analyses. For example, the onboard diagnostics and real-time sensor integration system 126 may deliver integrated vehicle data to the data-driven vehicle modification recommendation system 124 to inform analysis and generate modification recommendations. In addition, the onboard diagnostics and real-time sensor integration system 126 may archive data over extended periods for use in predictive maintenance or long-term trend analysis.

The AI-based evaluation system 128 may process collected vehicle data with neural network models or retrieval-augmented generation methods to generate accurate modification recommendations. In addition, the AI-based evaluation system 128 may incorporate relevant modification guidance and diagnostic records from the community-based knowledge system 134 into its evaluations. Results may subsequently be displayed in personalized activity feeds through the activity tracking module 114, allowing users to share evaluation outcomes or seek further community advice.

In some embodiments, the AI-based evaluation system 128 and/or the data-driven vehicle modification recommendation system 124 may interface with the RAG system 119 to access a document-oriented repository of crowd-sourced vehicle-build records. The repository may store build-specific documents representing real vehicles and their associated modification histories, performance outcomes, community validation signals, and verified part information. The AI-based evaluation system 128 may use these build-specific documents as retrieved context when evaluating candidate modifications, estimating performance outcomes, or generating natural language explanations regarding why a given grouped modification package is suitable for a particular vehicle and user objective.

In some embodiments, the AI-based evaluation system 128 may include a neural network module, a knowledge database, and a retrieval module. The neural network module may analyze complex automotive data and generate detailed modification evaluations or diagnostics. In addition, the knowledge database may store comprehensive automotive information including vehicle component specifications, modification outcomes, historical maintenance records, troubleshooting procedures, and community-sourced automotive insights. The retrieval module may search the knowledge database for information related to specific queries or vehicle conditions and provide relevant retrieved data to the neural network module. The AI-based evaluation system 128 may combine the analytical capabilities of neural network models with contextually relevant retrieved data from the knowledge database and thereby produce informed and personalized evaluation results.

In some embodiments, the AI-based evaluation system 128 may receive data inputs from users or other system components including structured sensor data or user queries submitted through a user interface. For example, a user may submit a query such as “What may cause decreased fuel efficiency after installing an aftermarket air intake system?” or the onboard diagnostics and real-time sensor integration system 126 may provide sensor data indicating abnormal engine operating conditions. The retrieval module may search the knowledge database to identify similar historical cases involving decreased fuel efficiency, retrieve relevant technical guidance or community insights about aftermarket air intake installations, or obtain troubleshooting records for similar symptoms. In addition, the retrieval module may perform searches based on keywords, semantic embeddings, or contextual data matching to identify the most relevant automotive information.

In some embodiments, the AI-based evaluation system 128 may analyze the retrieved knowledge along with the user query or collected sensor data using the neural network module. The neural network module may include a LXM or a similar AI component trained specifically on automotive data. The neural network module may evaluate the retrieved information alongside current vehicle conditions or queries to produce accurate and contextually relevant outputs. For example, in response to the user query about decreased fuel efficiency following an air intake modification, the neural network module may analyze retrieved data indicating potential installation issues, sensor anomalies, or incorrect air-to-fuel ratios. Based on this analysis, the neural network module may generate an evaluation result suggesting verification of the air intake installation, inspection for leaks, or recalibration of fuel mixture parameters.

In some embodiments, the AI-based evaluation system 128 may deliver the neural network-generated evaluations or recommendations to other system components or directly to users through the user interface. For example, the AI-based evaluation system 128 may provide detailed written explanations or diagnostic assessments addressing user queries or sensor-detected conditions. In one scenario, if a user submits a query via a chat interface such as “Would installing a turbocharger harm my vehicle's engine longevity?”, the retrieval module may collect relevant manufacturer manuals and community discussions about turbocharger reliability impacts. In addition, the neural network module may analyze this information along with stored vehicle specifications or previous modification records. Based on the combined analysis, the AI-based evaluation system 128 may provide a detailed evaluation stating that a properly installed turbocharger may enhance performance but may increase engine stress, and may recommend supporting modifications such as upgraded cooling systems or reduced oil change intervals to manage additional engine load.

In another example, when the onboard diagnostics and real-time sensor integration system 126 detects abnormal engine vibrations accompanied by a specific diagnostic trouble code, the retrieval module may query the knowledge database for known causes and historical resolutions associated with the detected conditions. The neural network module may analyze these retrieved automotive records along with current sensor data to formulate a likely cause such as a misaligned driveshaft or compromised engine mounts. In addition, the AI-based evaluation system 128 may provide an explanatory diagnostic result with specific maintenance recommendations or corrective actions for addressing the detected conditions. By leveraging neural network analysis in conjunction with comprehensive, contextually relevant automotive information retrieved from the knowledge database, the AI-based evaluation system 128 may provide precise and personalized evaluations superior to those provided by static rule-based systems.

In some embodiments, the AI-based evaluation system 128 may further interface with a vehicle-document repository configured to store vehicle-centric build documents in a document database or similar non-relational data store optimized for retrieval-augmented generation operations. Each vehicle-centric build document may represent a particular vehicle or build state and may include year, make, model, trim, engine, installed modifications, user-reported outcomes, business collaboration records, performance metrics, fitment notes, reliability observations, and associated social engagement metrics. The AI-based evaluation system 128 may update these build documents as users add modifications, record performance changes, or interact with community content.

In some embodiments, the AI-based evaluation system 128 may retrieve vehicle-centric build documents using a combination of vehicle matching, semantic retrieval, and popularity-weighted ranking. For example, the AI-based evaluation system 128 may identify build documents associated with similar year, make, model, trim, or engine combinations, apply floor thresholds to exclude low-quality or insufficiently validated records, compute a weighted score based on views, likes, saves, modification-specific engagement, or other quality signals, and select a top set of build documents for context injection into a neural network model. The retrieved build documents may allow the AI-based evaluation system 128 to recommend modification combinations that reflect community-validated outcomes rather than only generic component data.

The XR-based visualization system 130 may visually demonstrate potential vehicle modifications and help users accurately preview and evaluate modifications before installation. In addition, XR-based modification previews may integrate directly with the content sharing interface 108, allowing users to publish modification visualizations to their user profiles or group discussions. Users may further distribute these XR previews externally via the external social media interface 116 to solicit broader feedback or showcase vehicle projects.

In some embodiments, the XR-based visualization system 130 may include an imaging device, a rendering engine, a 3D model database, and a display interface supporting augmented reality (AR) or virtual reality (VR). The imaging device may include smartphone cameras, tablet cameras, or dedicated XR headsets. The imaging device may capture real-time visual data of the vehicle and its surroundings. The rendering engine may overlay digital 3D models representing selected vehicle modifications onto the real-time visual data, aligned precisely with the vehicle's physical geometry. The 3D model database may store detailed and standardized models of various modification components including wheels, spoilers, body kits, or engine components. In addition, the 3D model database may contain reference models of base vehicles to assist accurate alignment and scaling of modifications. The display interface may visually present the combined real-time and digital elements to the user, allowing them to preview potential modifications directly on the captured view of their vehicle or in a fully virtual environment.

In some embodiments, the XR-based visualization system 130 may capture real-time images of a user's vehicle using an imaging device such as a smartphone camera. The XR-based visualization system 130 may detect the orientation, scale, and position of the vehicle by analyzing distinctive vehicle features or using predefined visual markers placed around the vehicle. In addition, the XR-based visualization system 130 may load a virtual representation of the user's vehicle in scenarios involving purely virtual reality environments. The user may select specific modifications to visualize by choosing items from a modification catalog displayed on the user interface. For example, the user may select upgraded alloy wheels, an aftermarket spoiler, or an alternative paint color to preview on the vehicle.

In response to user selections, the XR-based visualization system 130 may retrieve corresponding 3D models from the 3D model database. These digital models may accurately represent the selected vehicle modifications including their physical shape, dimensions, color, and material textures. For modifications such as paint colors, the XR-based visualization system 130 may apply specialized textures or shaders rather than separate 3D models. The rendering engine may precisely align and scale these modification models to match the geometry of the actual vehicle captured in real-time imagery. In virtual reality environments, the rendering engine may align and attach modification models directly to the virtual vehicle representation.

In some embodiments, the display interface may show the combined image of real-time vehicle imagery and digital modification overlays in real time. As the user changes position or moves the imaging device around the vehicle, the modification overlays may dynamically adjust to maintain accurate alignment and correct perspective relative to the physical vehicle. In virtual reality implementations, the user may freely navigate a virtual environment containing their vehicle and view modifications from multiple angles or positions. The XR-based visualization system 130 may permit user interactions including toggling between different modifications, adjusting modification parameters such as colors, sizes, or configurations, or switching between AR and VR visualization modes. The visualization system may update the displayed view immediately in response to each user interaction. In addition, the XR-based visualization system 130 may provide functionality for capturing screenshots or recording video segments of the augmented or virtual scenes for later reference.

For example, a user considering a body kit modification may point their smartphone camera at their vehicle to preview the kit components in augmented reality. The XR-based visualization system 130 may accurately overlay virtual models of a new spoiler, side skirts, or custom wheels onto the real-time view of the vehicle, allowing the user to examine the modifications from various positions around the car. In another scenario, the user may enter a virtual reality mode using an XR headset to explore a fully virtual garage environment. Within this environment, the user may interactively apply different modifications such as alternative paint schemes or performance exhaust systems to their vehicle model. The XR-based visualization system 130 may visually demonstrate each modification configuration instantly from any desired viewpoint, providing clear and accurate modification previews. By accurately illustrating how modifications would appear in real-world contexts, the XR-based visualization system 130 may support user decision-making processes and help users confidently plan vehicle modifications.

The interactive installation system with XR feedback 132 may provide augmented reality instructions and real-time error detection and guide users step-by-step through vehicle modifications. Successfully completed installations guided by the interactive installation system with XR feedback 132 may automatically appear in users' personalized activity feeds via the activity tracking module 114, highlighting completion status to other community members. Users may also document installation experiences within the community-based knowledge system 134, enriching collective community resources.

In some embodiments, the interactive installation system with XR feedback 132 may include an XR-capable device, an installation database, and a real-time tracking module. The XR-capable device may include smartphones, tablets, or XR headsets that visually display interactive guidance and instructions. The installation database may store standardized step-by-step installation instructions specific to each vehicle model and modification component. Instructions stored in the installation database may include textual descriptions, visual diagrams, or animated demonstrations of required installation actions. The XR-capable device may visually present these instructions and simultaneously capture user actions using integrated cameras or sensors. The real-time tracking module may apply computer vision algorithms to monitor user progress and detect installation errors or deviations from prescribed procedures in real time.

In some embodiments, the interactive installation system with XR feedback 132 may identify the required installation procedure based on user inputs or detected modification components. For example, if a user purchases a particular brake upgrade kit or selects a component through the system interface, the interactive installation system with XR feedback 132 may automatically retrieve corresponding installation instructions from the installation database. Alternatively, the user may scan an identification code or select a specific maintenance action, such as “replace brake pads,” to initiate the retrieval of the appropriate step-by-step guidance. The XR-capable device may visually display each step of the selected installation procedure directly overlaid onto the user's real-time view of the vehicle.

For each installation step, the interactive installation system with XR feedback 132 may display augmented reality markers, directional arrows, or highlighted outlines precisely indicating required actions on the vehicle. For example, the XR-capable device may visually indicate bolts to remove or vehicle panels to detach using clear visual cues overlaid onto the user's real-world view. In addition, concise textual instructions or symbolic icons such as “Remove bolts using 10 mm socket” may accompany the visual overlays to clarify required actions. As the user performs the indicated tasks, the real-time tracking module may continuously analyze the visual scene captured by the XR-capable device to confirm task completion. For instance, the real-time tracking module may visually confirm removal of specified bolts, proper alignment of new components, or correct reconnection of wires using computer vision algorithms. In some cases, the real-time tracking module may integrate data from additional sensors or smart tools, such as torque wrenches equipped with sensors to verify correct tightening of fasteners.

In some embodiments, the interactive installation system with XR feedback 132 may provide immediate visual or auditory feedback based on the tracking module's analysis. When a user successfully completes an installation step, the XR-capable device may visually indicate success by highlighting the completed task in green or displaying affirmative symbols such as checkmarks. If the tracking module detects incomplete actions or incorrect installations, the XR-capable device may visually alert users to these errors. For example, if the user leaves a necessary bolt in place, the interactive installation system with XR feedback 132 may display a highlighted indicator prompting the removal of that bolt before proceeding. Similarly, if a new component alignment appears incorrect, the XR-capable device may visually indicate proper alignment markers alongside an error warning, guiding the user to correct the issue immediately.

The interactive installation system with XR feedback 132 may sequentially guide the user through each step of the installation procedure. Users may advance through the steps using intuitive gestures or voice commands recognized by the XR-capable device. Each subsequent installation step may repeat the visual guidance, tracking, and feedback processes to ensure consistent accuracy. Upon completing the installation sequence, the interactive installation system with XR feedback 132 may perform a final verification check to confirm overall success. For instance, the XR-capable device may display a comprehensive checklist visually confirming that users tightened all fasteners, properly reattached connectors, or correctly positioned components. In addition, the interactive installation system with XR feedback 132 may prompt users to test installed components, such as starting the vehicle's engine or activating electrical systems, while monitoring sensor data to verify correct operation.

For example, during the installation of a new vehicle infotainment system, the interactive installation system with XR feedback 132 may visually highlight specific dashboard panels users must remove, clearly indicate hidden fastener locations, or display animated instructions showing the correct method to detach electrical connectors. If the real-time tracking module detects a missed electrical connection or improperly routed wiring, the XR-capable device may immediately display visual alerts prompting the user to correct the issue before proceeding. In another scenario, a user replacing vehicle spark plugs may receive visual XR guidance labeling each spark plug location on the engine, indicating a recommended removal and installation order, and providing immediate visual confirmation of each plug's correct seating. By providing real-time augmented reality feedback and detailed step-by-step guidance, the interactive installation system with XR feedback 132 may significantly reduce installation errors and allow non-expert users to confidently perform vehicle modifications.

The community-based knowledge system 134 may aggregate, categorize, and prioritize installation instructions and modification experiences contributed by vehicle owners, modification experts, and manufacturers. The community-based knowledge system 134 may provide users with accurate modification procedures validated by community feedback and expert review. In addition, user contributions stored within the community-based knowledge system 134 may directly appear in user profile activities or specific group feeds managed by group management subsystem 112. Notable user contributions or community-approved answers may also trigger updates in activity tracking module 114, highlighting valuable community knowledge to all members.

In some embodiments, the community-based knowledge system 134 may include a knowledge database, a user content submission interface, and a content curation module. The knowledge database may store diverse community-generated information, including modification installation guides, troubleshooting steps, user questions and answers, detailed modification reviews, and documented vehicle upgrade projects. The user content submission interface may permit vehicle owners or experts to submit new content, pose questions, answer existing inquiries, or share modification experiences. The content curation module may systematically organize submitted information, categorize content by modification type or vehicle model, apply quality controls, and highlight validated or community-endorsed recommendations.

In some embodiments, the community-based knowledge system 134 may collect user-generated content including specific vehicle modification questions, detailed instructional guides, or shared modification experiences. For example, a user may submit a detailed question such as “How do I reduce throttle lag on a 2012 Ford Mustang GT?” or share a comprehensive guide titled “Installing upgraded suspension components on a 2016 Jeep Wrangler.” Submitted content may include relevant metadata such as vehicle model, specific modification categories, contributor details, or associated images or videos. The community-based knowledge system 134 may store submitted content within the knowledge database and index this information to allow efficient searching and retrieval. Indexed information may be systematically organized according to modification types, vehicle makes and models, or content formats such as installation guides, troubleshooting articles, or performance improvement recommendations.

In some embodiments, the community-based knowledge system 134 may facilitate interactive engagement among users through responses, discussions, or feedback related to the submitted content. For example, a submitted question regarding throttle lag solutions may generate multiple community responses, each response addressing potential solutions such as electronic throttle controllers, ECU tuning, or air intake modifications. User-generated installation guides may include interactive comment sections where community members may provide feedback, ask clarifying questions, or suggest additional recommendations. The community-based knowledge system 134 may include a community rating or voting mechanism where users evaluate responses or submitted guides based on usefulness, accuracy, or practical outcomes. Highly-rated answers or validated installation instructions may rise prominently within the interface to emphasize reliable and beneficial contributions.

In some embodiments, the content curation module of the community-based knowledge system 134 may apply automated algorithms or human moderation to ensure information quality and accuracy within the knowledge database. For example, when multiple users mark a specific response as successfully resolving their issue, the curation module may automatically highlight this validated answer within the user interface. In addition, the curation module may flag and review content reported as inaccurate, inappropriate, or outdated, removing unreliable or irrelevant submissions. The community-based knowledge system 134 may periodically consolidate common questions or frequently encountered vehicle issues into comprehensive articles or linked canonical answers to streamline content organization and improve navigation.

The community-based knowledge system 134 may integrate directly with other system components to present community-validated knowledge precisely at the point of user need. For example, the AI-based evaluation system 128 may automatically reference community-validated guides or troubleshooting solutions when diagnosing a reported vehicle issue. The data-driven vehicle modification recommendation system 124 may indicate to users that recommended modifications frequently pair with additional upgrades according to community feedback. In addition, the user interface may provide a dedicated community search function or proactively display related community-generated content when users view specific modification components or encounter diagnostic trouble codes.

In some embodiments, the community-based knowledge system 134 may continually expand through ongoing user contributions and iterative feedback. For example, a user following a community-submitted installation guide may subsequently share a useful additional technique or clarify specific installation details based on their experience, enhancing the guide for future users. Over time, accumulated contributions may form an extensive, reliable, and dynamic knowledge resource including practical insights and user-driven expertise. For instance, a user noting a challenging hidden fastener during a front bumper installation on a particular vehicle model may share a warning or installation tip. Subsequent users reviewing the installation guide for that vehicle's bumper replacement may benefit from this shared community knowledge, avoiding potential installation errors. Similarly, vehicle owners seeking recommendations for aftermarket performance upgrades, such as cold air intake systems, may solicit and receive detailed responses from experienced community members who provide specific product endorsements, performance data, or personal installation outcomes. The community-based knowledge system 134 may harness collective user knowledge and real-world modification experiences to substantially enrich official guidance and AI-generated recommendations to provide comprehensive and highly practical resources for users and other subsystems.

The professional service matching system 136 may identify automotive service professionals suitable for specific vehicle modifications, maintenance tasks, or diagnostic services. The professional service matching system 136 may also offer direct booking, streamlined payment processing, and post-service support for vehicle owners. Following professional service engagements, user feedback and service outcomes may automatically appear within user profiles managed by user profile module 104. Users may further discuss professional experiences or vendor recommendations within groups facilitated by group management subsystem 112, supported by interactive features provided through social interaction module 120.

In some embodiments, the professional service matching system 136 may include a provider database, a matching engine, and a user interface module. The provider database may store detailed profiles of automotive professionals including certified mechanics, specialty automotive technicians, modification shops, and authorized service garages. Each profile may contain information such as professional certifications, areas of specialization, supported vehicle makes and models, available services, geographic locations, scheduling availability, and customer-generated reviews or ratings. The matching engine may analyze a user's specific service request and retrieve appropriate providers from the provider database based on service type, geographic proximity, professional expertise, and user-defined preferences. The user interface module may present identified service providers to the user, provide detailed provider profiles, facilitate appointment booking, process payments, and manage user-provider communications.

In some embodiments, the professional service matching system 136 may continuously update the provider database with new professionals, detailed service offerings, availability schedules, geographic service coverage, pricing structures, and user feedback. For example, the provider database may include specialized providers capable of performing engine tuning, body kit installations, transmission repairs, or electrical diagnostics for specific vehicle models or modifications. The professional service matching system 136 may collect customer-generated ratings and reviews to help evaluate service quality and performance history. These evaluations may be integrated into provider profiles and influence provider ranking or prioritization during matching processes.

In some embodiments, the professional service matching system 136 may accept detailed service requests from users through a structured input form or user interface. For example, a user may request professional assistance to install a specific aftermarket turbocharger kit on a 2018 vehicle model or diagnose a persistent suspension noise issue on a particular vehicle model. The user request may include necessary information such as vehicle details, precise modification requirements, diagnostic issues, preferred service timing, geographic constraints, or desired warranty conditions. The matching engine may analyze these service requests and search the provider database to identify appropriate service providers based on service capabilities, professional specialization, proximity to the user's location, scheduling availability, and user preferences.

In some embodiments, the matching engine of the professional service matching system 136 may prioritize identified providers based on specific matching criteria. For example, the matching engine may prioritize providers who have successfully completed similar modification installations or diagnostic services for other users with comparable vehicle models. The matching engine may also prioritize providers who offer desired warranty terms, have immediate scheduling availability, maintain high customer satisfaction ratings, or fall within a specified geographic radius. The professional service matching system 136 may present prioritized provider recommendations to the user through the user interface, highlighting relevant details such as provider name, distance from the user, specialized services offered, availability, cost estimates, and customer-generated reviews.

In some embodiments, the professional service matching system 136 may facilitate direct user-provider interactions including appointment scheduling, service quotations, or payment processing. For example, once a user selects a specific automotive professional from the recommended providers, the user interface module may enable direct appointment scheduling by interfacing with provider calendars or scheduling systems. In addition, the professional service matching system 136 may allow users to request detailed quotations from selected providers and facilitate integrated payment processing within the platform. Throughout the service engagement process, the professional service matching system 136 may provide real-time updates, service confirmation notices, provider communications, and appointment reminders directly to the user through the user interface.

In some embodiments, the professional service matching system 136 may collect user feedback following completed automotive services. For example, upon service completion, users may rate providers based on performance quality, customer service, installation accuracy, or repair outcomes. This collected feedback may automatically update provider profiles within the provider database and refine future matching accuracy. In addition, the professional service matching system 136 may update the user's vehicle records to indicate completed modifications, maintenance services, or diagnostic repairs, informing future modification recommendations or proactive maintenance alerts.

The professional service matching system 136 may streamline interactions between vehicle owners and automotive professionals, providing precise professional service recommendations tailored to user-specific modification or repair requirements. For example, when the data-driven vehicle modification recommendation system 124 suggests a specific performance exhaust system installation, but the vehicle owner prefers professional installation services, the professional service matching system 136 may quickly identify qualified local automotive shops with direct experience installing aftermarket exhaust systems on the user's vehicle model. The matching system may provide detailed provider information such as distance, customer ratings, prior installation experience, and direct booking capabilities. In another scenario, if the sound-based diagnostic system 142 detects a potential wheel bearing issue and the vehicle owner requests professional repair assistance, the professional service matching system 136 may present nearby automotive mechanics specializing in wheel bearing replacements along with detailed cost estimates, service timeframes, and appointment availability. The professional service matching system 136 may efficiently identify, recommend, and facilitate connections with qualified automotive professionals to allow vehicle owners to confidently execute recommended modifications or complex repairs with expert assistance.

The data normalization and schema mapping system 138 may standardize automotive data from diverse sources and may further generate and maintain a validated automotive brand and part knowledge base that supports accurate analysis across various platform components. Normalized vehicle and component data managed by the data normalization and schema mapping system 138 may integrate directly into virtual garages managed by virtual garage manager 110, recommendation outputs produced by data-driven vehicle modification recommendation system 124, marketplace outputs presented through marketplace system 137 or vendor network interface 118, and visualization outputs generated by XR-based visualization system 130. In some embodiments, the data normalization and schema mapping system 138 may store canonical brand records, canonical part records, source attribution data, validation state indicators, fitment metadata, performance metadata, reliability metadata, and vector embeddings that may be used by downstream recommendation, marketplace, authenticity, and learning systems.

In some embodiments, the data normalization and schema mapping system 138 may include a data ingestion module, a schema mapping engine, and a unified automotive data store. The data ingestion module may accept automotive data inputs from multiple external sources such as OEM databases, aftermarket component catalogs, onboard vehicle sensors, vehicle telemetry feeds, and external APIs. These data sources may each have different data formats or schema representations. For example, one automotive parts database may list vehicle models and years in separate fields, while another database may combine vehicle make, model, and year information into a single textual field. The schema mapping engine may apply predefined transformation rules or trained machine learning models to convert disparate incoming data formats into a common standardized schema. The unified automotive data store may store normalized data in structured records to support consistent data retrieval by other integrated systems including the data-driven vehicle modification recommendation system 124, AI-based evaluation system 128, or the XR-based visualization system 130.

In some embodiments, the data normalization and schema mapping system 138 may accept new automotive data from diverse external data sources and analyze incoming data to determine source-specific schema formats. For example, the data ingestion module may receive vehicle parts information from an aftermarket retailer's database or a real-time telemetry feed from a vehicle's embedded telematics system. Each incoming data set may use distinct data representations such as comma-separated values (CSV), extensible markup language (XML), JavaScript object notation (JSON), or proprietary API formats. The schema mapping engine may apply existing mapping rules to known data sources or infer mapping rules for new data sources using machine learning techniques. For instance, the schema mapping engine may recognize fields such as “vehicle_year” or “engine_temp” from incoming data and map these to standardized fields within the unified schema such as “ModelYear” or “EngineTemperature.” In cases where incoming data presents a completely new format, system administrators may define manual mapping rules or confirm suggested mappings from the machine learning model to finalize the schema alignment.

In some embodiments, the data normalization and schema mapping system 138 may further ingest user-submitted product links corresponding to aftermarket automotive components and convert webpage content associated with the product links into structured automotive modification records. For example, the data normalization and schema mapping system 138 may retrieve webpage content, remove non-substantive webpage elements such as advertisements, navigation elements, headers, footers, or code fragments, transform the remaining content into a language-model-ready representation, determine whether the webpage corresponds to a valid automotive part, resolve brand and part identities against the unified automotive data store and vector database, and create or update structured modification records associated with a user profile, a virtual garage entry, or a vehicle-specific modification history. In addition, the data normalization and schema mapping system 138 may cooperate with the AI-based evaluation system 128, marketplace system 137, and virtual garage manager 110 so that user-submitted product links may become verified parts, stored modifications, planned upgrades, or searchable marketplace-linked records within the platform.

In some embodiments, the schema mapping engine may transform incoming automotive data into a unified data format consistent across the entire system. This transformation may include renaming data fields, reorganizing data structure, and converting units of measurement. For example, if a data source provides tire pressure measurements in bar units and the standardized schema specifies tire pressure measurements in pounds per square inch (PSI), the schema mapping engine may automatically convert all tire pressure values to PSI. In addition, if an external automotive component database provides a list of compatible vehicles in a single unstructured text field, the schema mapping engine may split this text into structured fields representing vehicle make, model, and year. This transformation produces automotive data with uniform structure and measurement units, ensuring seamless integration across different platform systems.

In some embodiments, the data normalization and schema mapping system 138 may validate transformed automotive data prior to storage in the unified automotive data store. The schema mapping engine may verify completeness and correctness of all standardized data fields. For example, when transformed automotive data lacks certain mandatory fields defined by the standardized schema, the schema mapping engine may apply default values, log a validation warning, or flag the data for manual review by a system administrator. If incoming data contains an undefined or unrecognized data field, the schema mapping engine may temporarily exclude the field from ingestion until schema updates accommodate it. Following validation, the schema mapping engine may store the verified, normalized automotive data in the unified automotive data store.

In some embodiments, the data normalization and schema mapping system 138 may regularly update the unified automotive data store to reflect new or updated incoming data. For example, if an external data source updates pricing details for certain aftermarket automotive parts, the schema mapping engine may identify existing part records in the unified automotive data store and apply the updated price information accordingly. In cases where incoming automotive data describes entirely new vehicle models or new aftermarket components, the schema mapping engine may create new structured records in the unified automotive data store. This consistent updating process ensures the unified automotive data store maintains current and accurate data across diverse automotive sources.

In some embodiments, the unified automotive data store may provide standardized automotive data to integrated system components through consistent query interfaces. For example, the data-driven vehicle modification recommendation system 124 may query automotive data related to specific vehicle models, part compatibility details, or modification outcomes without handling source-specific data formats. Similarly, the AI-based evaluation system 128 may seamlessly retrieve engine performance metrics or diagnostic trouble codes from multiple vehicle models using uniform data structures and standardized measurement units. The data normalization and schema mapping system 138 thus eliminates potential errors or inconsistencies stemming from disparate source formats, facilitating reliable cross-system data analysis.

For example, the data normalization and schema mapping system 138 may integrate automotive component data from an official OEM database and a popular aftermarket retailer database. The OEM database may label a brake pad component for a 2020 sedan as “FrontPadLeft: AB-123,” while the aftermarket retailer may label a similar brake pad as “Brake Pad Front Left—2020 Sedan” with a distinct stock-keeping unit (SKU). The schema mapping engine may map both OEM and retailer component identifiers to a unified internal part identifier field with a standardized description, such as “Front Brake Pad, Left Side,” and associate this identifier explicitly with the corresponding vehicle make, model, and year within the unified automotive data store. In another example, vehicle telemetry data may represent engine load either as a percentage value or a numeric index. The schema mapping engine may convert numeric engine load indices into standardized percentage values before storage, allowing the AI-based evaluation system 128 to consistently analyze engine load metrics across multiple vehicle models.

In some embodiments, the data normalization and schema mapping system 138 may further maintain a validated automotive brand and parts knowledge base. The validated knowledge base may store canonical brand records and canonical part records together with aliases, abbreviated names, part numbers, source provenance, vector embeddings, validation states, and optional fitment metadata. The schema mapping engine may resolve incoming references to brands or parts from user submissions, scraped web data, retailer catalogs, manufacturer sources, or AI-generated recommendations and may determine whether the incoming reference maps to an existing canonical record, a new verified record, or a flagged record pending further review. The validated knowledge base may thereby reduce duplication, improve consistency across different data sources, and provide a reliable substrate for recommendation, marketplace, and visualization functions.

In some embodiments, the schema mapping engine may evaluate brand or part authenticity by combining exact matching, approximate string matching, vector-based similarity operations, source cross-referencing, and AI-assisted validation. For example, the schema mapping engine may first attempt exact or prefix-based matching to existing canonical brand records, then apply vector similarity measures or AI-assisted web validation to determine whether an unresolved brand corresponds to a legitimate automotive brand. A similar process may be applied to part records using names, part numbers, structured attributes, or semantic similarity measures. Records that satisfy validation criteria may be stored as verified records with associated embeddings, while unresolved or low-confidence records may be stored as user-specific or flagged records pending additional validation.

In some embodiments, the data normalization and schema mapping system 138 may include a link-based modification ingestion subsystem configured to create structured modification records from product links submitted by users. The link-based modification ingestion subsystem may receive a product URL, validate the URL, retrieve webpage content, and generate an extraction-ready representation of the webpage by removing or reducing nonessential webpage elements such as headers, footers, advertising content, or markup noise. The processing system may then apply an AI model to determine whether the webpage corresponds to a valid automotive part and, if so, to extract structured attributes, including brand, part name, part number, category, descriptive features, media links, or compatibility information. When the webpage does not correspond to a valid automotive part, the processing system may reject the submission and provide an explanatory reason.

In some embodiments, following structured extraction, the link-based modification ingestion subsystem may resolve the extracted brand and part against the validated automotive brand and parts knowledge base, present a preview to the user for confirmation, and then create or reuse brand records, part records, image records, and modification records associated with a user vehicle or collection. For example, when a submitted product URL corresponds to an aftermarket air intake, the processing system may verify or create a brand record, verify or create a canonical part record, retrieve or assign a representative image, insert a modification record linked to the user's vehicle, and optionally add the record to a smart collection or other vehicle-associated group. In some embodiments, the subsystem may preserve extracted brand or part data for future reuse, even when the user declines to immediately associate the modification with the vehicle.

The image-based authenticity verification system 140 may analyze visual automotive data to verify vehicle identity and detect vehicle modifications. Verification results generated by the image-based authenticity verification system 140 may automatically trigger community alerts or status updates through the activity tracking module 114. In addition, users may share verification results or authenticity warnings within their profiles or groups via the content sharing interface 108 to alert other community members to potential issues.

In some embodiments, the image-based authenticity verification system 140 may include an image capture module, an image analysis engine, and an authenticity reference database. The image capture module may acquire visual data of vehicle components, identification tags, labels, vehicle identification numbers (VINs), license plates, or modification details through devices such as user smartphones, tablets, or specialized cameras. The image analysis engine may apply computer vision algorithms or trained machine learning models to analyze acquired images and identify authenticity markers. The authenticity reference database may store verified automotive reference data including manufacturer-provided images of genuine vehicle components, officially registered VIN sequences, standardized license plate formats, legitimate branding patterns, and known authentic part characteristics such as material texture, font styles, security seals, or holograms. The image analysis engine may compare visual features extracted from the captured images against the verified reference data stored within the authenticity reference database to determine the authenticity or detect unauthorized vehicle modifications.

In some embodiments, the image-based authenticity verification system 140 may acquire detailed images of specific automotive components or identification features and guide the user through capturing appropriate visual data. For example, the image capture module may prompt the user to photograph a vehicle's VIN plate, license plate, or a particular automotive component from multiple specified angles. The image capture module may provide on-screen indicators highlighting areas to photograph clearly, such as embossed identification numbers, branding logos, security holograms, or unique part features. High-resolution images captured through user devices allow the system to identify detailed characteristics or discrepancies during the authenticity analysis.

In some embodiments, the image analysis engine may process captured visual data to extract identifying characteristics for authenticity verification. The image analysis engine may apply optical character recognition (OCR) algorithms to identify and transcribe visible characters such as VIN sequences, part numbers, serial codes, or license plate identifiers. In addition, the image analysis engine may apply pattern recognition techniques to detect physical attributes such as branding logos, security hologram placement, engraved identifiers, or geometric features specific to genuine automotive parts. For example, the image analysis engine may identify and measure dimensions of cooling fins on an automotive radiator, count connector pins on electronic sensors, or analyze embossed branding logos for correct positioning and font accuracy. These extracted visual features may form the basis of comparison against reference data stored in the authenticity reference database.

In some embodiments, the image analysis engine may compare extracted visual features from captured images against verified reference data within the authenticity reference database. For example, when a VIN number or serial code has been extracted from an image, the image analysis engine may verify that the extracted identifier matches an officially recognized sequence stored within the authenticity reference database. The image analysis engine may similarly compare branding logos, hologram placements, or detailed part geometry against manufacturer-provided reference images and specifications. Trained neural network classifiers may analyze extracted visual features and assess the similarity between captured images and known authentic examples within the authenticity reference database. Any substantial discrepancy, such as unrecognized serial numbers, missing security features, or branding inconsistencies, may indicate a potential authenticity issue or unauthorized modification.

In some embodiments, the image-based authenticity verification system 140 may determine authenticity results based on the degree of match between captured images and reference data. If captured images exhibit a high-confidence match to stored authenticity markers such as valid serial numbers, correct branding placements, accurate font styles, and security features, the image analysis engine may classify the automotive component or vehicle as authentic. Conversely, detected inconsistencies such as mismatched VIN sequences, incorrectly placed holograms, distorted logos, or unrecognized serial numbers may trigger authenticity warnings. In certain intermediate cases, the system may identify minor deviations and prompt further manual review or verification.

In some embodiments, the image-based authenticity verification system 140 may communicate authenticity verification results directly to users through a user interface. For example, the user interface may display messages such as “Verified Authentic” accompanied by visual confirmation indicators when authenticity matches closely. Conversely, in instances where authenticity verification reveals issues, the system may clearly indicate “Authenticity Not Confirmed” or similar warnings, accompanied by specific reasons for the alert, such as “Serial number unrecognized” or “Branding logo incorrect.” Providing detailed explanations helps users understand the verification results and informs decisions such as contacting manufacturers or avoiding potentially counterfeit components.

In some embodiments, the image-based authenticity verification system 140 may log verification attempts and outcomes to support ongoing analysis and enhancement of authenticity detection capabilities. For instance, if the image analysis engine detects a new type of counterfeit branding or packaging pattern, the system may store relevant visual examples for subsequent machine learning model updates. These continuous improvements enable the image-based authenticity verification system 140 to remain current with evolving counterfeit trends and further improve verification accuracy over time.

For example, a user may acquire an automotive airbag sensor component from a third-party seller and utilize the image-based authenticity verification system 140 to verify its legitimacy prior to installation. The user may photograph the sensor's barcode, branding logo, and embossed identification numbers through their device's camera. The image analysis engine may apply OCR to extract the barcode and serial code, comparing them against officially registered codes within the authenticity reference database. If the system finds no matching record of the barcode or identifies discrepancies in the embossed branding logo compared to verified examples, it may alert the user that the component potentially lacks authenticity. Conversely, another user may photograph a replacement spark plug including its serial number, packaging hologram sticker, and branding details. The image analysis engine may confirm the serial number matches manufacturer-provided records and detect no deviations in packaging security features, confirming the spark plug's authenticity. By accurately identifying subtle discrepancies or inconsistencies difficult for non-experts to detect visually, the image-based authenticity verification system 140 protects vehicle owners from counterfeit or unauthorized modifications and ensures reliability and safety for automotive upgrades.

The sound-based diagnostic system 142 analyzes acoustic data from vehicle engines using AI-driven pattern recognition. In addition, the sound-based diagnostic system 142 identifies mechanical issues and suggests corrective actions based on acoustic signatures. Diagnostic evaluations generated by the sound-based diagnostic system 142 may appear directly in user activity feeds managed by activity tracking module 114, allowing immediate community awareness of potential vehicle issues. Users may further discuss diagnostic results or corrective actions recommended by the system within groups or personal vehicle profiles, utilizing interactive communication features provided by social interaction module 120.

Some embodiments may include processing systems configured to standardize automotive data from multiple diverse formats. The processing system may accept structured, semi-structured, and unstructured data inputs from different automotive sources. In addition, the processing system may parse and convert the received data into a standardized intermediate representation. This intermediate representation may allow extraction and mapping of key automotive parameters into a consistent schema. The processing system may resolve missing data using statistical techniques or machine learning algorithms. In addition, the processing system may standardize measurement units and enforce consistent formatting for vehicle identifiers. After data normalization, the processing system may store structured data and provide access through standardized application programming interfaces (APIs). These APIs may support downstream analyses performed by AI models or recommendation systems. A centralized Universal Automotive Data Converter may perform these operations and thereby integrate heterogeneous automotive data inputs efficiently.

In some embodiments, the computing system 102 may provide a vehicle-centric community platform that supports multiple interoperable environment types, including enthusiast environments, business environments, and group environments. An enthusiast environment may be centered on a user garage and associated vehicle records. A business environment may be centered on a business garage and associated service, portfolio, or inventory records. A group environment may be centered on a persistent group space defined by a vehicle type, region, project category, or shared automotive interest. The processing system may allow these environment types to interact through common discovery, search, tagging, feed-generation, and permission frameworks, enabling users, businesses, and groups to share and act on vehicle-specific information within a unified in-platform ecosystem.

In some embodiments, a business garage may function as a persistent business-facing profile and content space within the platform. The business garage may store information such as business identity data, geographic coverage, supported services, supported vehicle categories, certifications, user reviews, featured posts, portfolio vehicles, galleries, business-generated media, and optional product or inventory references. The processing system may allow a business garage to present vehicle-specific content to users, including examples of prior work performed on similar vehicles, recommended services for a selected vehicle, or featured products associated with particular modification categories. In addition, the business garage may support following, messaging, sharing, and analytics functions that allow a business to monitor engagement with its content or target content to relevant users, vehicles, or groups.

In some embodiments, the processing system may generate and maintain collaboration records associated with real-world vehicle builds. A collaboration record may link a user profile, a business profile, and a specific vehicle record, and may store information such as services performed, installed components, modification dates, media captured before or after installation, linked documents, attributed contributors, or review status. The collaboration record may be created in response to an invitation workflow between the user and the business, in response to a completed transaction or service engagement, or in response to coordinated publication of a build by multiple parties. The processing system may enforce permissions defining which parties may edit, confirm, publish, or revoke portions of the collaboration record. Once confirmed, the collaboration record may remain associated with the user garage, the business garage, and any authorized group or feed views, thereby preserving attribution and build history across the platform.

In some embodiments, the processing system may generate a short link or garage publishing link that resolves to a unified page for a user garage, business garage, or specific vehicle. The unified page may present selected profile information, linked vehicles, modification summaries, media, collaborations, and external social links in a compact shareable format suitable for publication through other platforms, profile biographies, direct messages, or event signage. For example, the short link may resolve to a page that shows a user's current vehicles, notable modifications, selected performance information, and links to external accounts while maintaining the platform as the source of record for the underlying vehicle data. In this manner, the computing system may replace fragmented external profile descriptions with a single vehicle-centric entry point that remains dynamically updated as the corresponding garage or business record changes.

In some embodiments, the computing system may apply recommendation and discovery techniques across the enthusiast, business, and group environments. The processing system may recommend businesses to users based on vehicle compatibility, past collaborations, project type, or geographic proximity. The processing system may recommend users or builds to businesses based on relevant services, vehicle categories, or engagement patterns. The processing system may also recommend groups, events, or feeds based on vehicle data, modification history, collaborations, and social interactions. By using common vehicle-centric records and collaboration records across these environment types, the computing system may provide a unified community and business platform that supports learning, sharing, attribution, and vehicle-build coordination without requiring users to reconstruct vehicle history across multiple disconnected systems.

For example, a user may maintain a vehicle record in the virtual garage manager 110 for a modified sports car and may invite a tuning shop represented by a business garage to collaborate on the vehicle's build record after installation of a suspension kit and an exhaust system. The tuning shop may confirm the services performed, upload installation media, and associate the installed components with the build. The resulting collaboration record may appear in the user's garage, in the business garage portfolio, and in one or more relevant group feeds. The user may then publish a short link associated with the vehicle or garage through the external social media interface 116, allowing third parties to access a unified view of the vehicle, its modifications, and the credited business contributions without requiring manual reconstruction of the build history from multiple external sources.

In some embodiments, the business garage may further operate as a configurable storefront environment that exposes portfolio vehicles, featured services, business-generated posts, galleries, promotions, sponsored placements, user-specific product recommendations, or optional transaction interfaces. The processing system may tailor displayed business content based on user vehicle data, modification interests, watch lists, or prior interactions, and may provide analytics to the business regarding engagement, demand trends, vehicle-specific interest, or conversion activity associated with published content. In addition, the business garage may integrate with optional purchasing, cart, booking, or fulfillment workflows to support presentation of parts, services, or bundled offerings relevant to the user's vehicle while preserving the vehicle-centric structure of the platform.

FIG. 1D illustrates an extension of the community and vehicle-management architecture shown in FIG. 1C, in which the computing system 102 supports a vehicle-centric platform having multiple interoperable environment types. These environment types may include an enthusiast environment 154 centered on one or more user garages 164 and associated vehicle records, a business environment 156 centered on one or more business garages 162 and associated service, inventory, or portfolio records, and a group environment 158 centered on one or more persistent communities defined by vehicle type, region, project category, or shared automotive interest. The processing system may permit these environment types to share common identity, vehicle, content, recommendation, transaction, and permission frameworks while exposing different views, workflows, and access controls for different actor types. As such, the computing system 102 may maintain a unified in-platform ecosystem for vehicle-specific collaboration, commerce, and discovery while reducing fragmentation of build history and modification data across disconnected systems.

With reference to FIGS. 1A-1D, the user profile module 104 may manage multiple profile types within the vehicle-centric platform, including enthusiast profiles, business profiles, creator profiles, and administrative group profiles. Each profile may store identity data, geographic data, privacy settings, permissions, communication preferences, linked vehicles, followed vehicles, followed businesses, affiliated groups, and other relationship data. An enthusiast profile may emphasize owned vehicles, past vehicles, planned vehicles, modification preferences, intended driving styles, budget history, and project goals. A business profile may emphasize supported services, supported vehicle categories, certifications, locations, service areas, verified capabilities, external links, and business analytics. A group profile may emphasize membership controls, moderation policies, group-specific content, project threads, and coordinated events. The user profile module 104 may interface with the profiles database 106, the virtual garage manager 110, the vendor network interface 118, and the social interaction module 120 so that the platform may personalize discovery, collaboration, and publishing experiences according to the profile type and associated vehicle data.

In some embodiments, the virtual garage manager 110 may maintain one or more persistent vehicle records for a user profile. A vehicle record may store vehicle identity information, trim and option information, current modifications, planned modifications, historical modifications, maintenance events, performance measurements, media, documents, AI-generated packages, marketplace interactions, and other vehicle-centric data. The virtual garage manager 110 may organize these data into structured collections associated with a specific vehicle, such as an installed-parts collection, a service collection, a wish-list collection, a candidate-parts collection, a business-collaboration collection, or a smart-package collection generated by the data-driven vehicle modification recommendation system 124. The virtual garage manager 110 may further maintain one or more permissioned garage views for a vehicle, including a private owner view, a public enthusiast view, a collaboration view shared with one or more businesses, and a compact published view reachable through a generated short link. By maintaining persistent vehicle-specific collections and views, the virtual garage manager 110 may allow the platform to treat the vehicle rather than the post as the primary organizational unit.

In some embodiments, a business garage 162 may function as a persistent business-facing profile and content space within the platform. The business garage 162 may store business identity data, supported services, supported makes and vehicle categories, certifications, user reviews, portfolio vehicles, featured services, galleries, media, service packages, promotional campaigns, inventory references, and optional storefront or booking data. The business garage 162 may further associate prior work with actual vehicle records or collaboration records 160 so that the business may present authenticated examples of completed projects on real vehicles. In some embodiments, the processing system may tailor content shown in the business garage 162 according to a selected user vehicle, including by surfacing examples of similar builds, recommended services for the selected user vehicle, recommended products for the selected user vehicle, or promotions associated with a compatible modification category. The business garage 162 may also support following, messaging, analytics, and permission-controlled publishing functions, thereby allowing a business to use the platform not only as a social page but also as a vehicle-specific engagement and conversion interface.

In some embodiments, the computing system 102 may generate and maintain collaboration records 160 associated with real-world vehicle builds. A collaboration record 160 may link a user profile, a business profile, and a specific vehicle record, and may store services performed, installed components, contributed parts, tuning actions, dates, attributed contributors, media, invoices, installation documents, dyno charts, review states, and permissions. A collaboration record 160 may be created in response to an invitation workflow, in response to a completed service transaction, in response to a completed product purchase with associated installation, or in response to coordinated publication of a build by multiple participants. The processing system may enforce permissions that determine which parties may create, edit, confirm, publish, revoke, or annotate the collaboration record 160. Once confirmed, the collaboration record 160 may remain associated with the user garage 164, the business garage 162, and authorized feeds or group views so that the platform preserves build provenance and attribution across all participating environments. In this manner, the computing system 102 may support collaboration around actual vehicle builds rather than limiting the system to generic content collaboration.

In some embodiments, the external social media interface 116 and related publishing logic may generate a short link or other sharable publishing identifier that resolves to a unified page for a user garage 164, a business garage 162, or a specific vehicle. The unified page may present selected profile information, linked vehicles, modification summaries, collaboration records, media, business attributions, social links, and other vehicle-centric data in a compact sharable format suitable for external publication, direct messages, event signage, profile biographies, or other off-platform distribution. The short link may resolve to a dynamic page that remains synchronized with the canonical vehicle record or garage record within the platform, thereby allowing the user or business to publish an up-to-date vehicle-centric profile without manually duplicating information across multiple external systems. In some embodiments, the unified page may function as a vehicle-oriented landing page that replaces fragmented external profile descriptions with a single source-of-record entry point.

In some embodiments, the computing system 102 may apply recommendation, discovery, and ranking techniques across the enthusiast, business, and group environments shown in FIG. 1D. For example, the processing system may recommend businesses to a user based on a selected vehicle, past collaboration history, modification category, geographic proximity, fitment requirements, service compatibility, or social engagement data. The processing system may recommend users, builds, or groups to a business based on vehicle categories, service relevance, collaboration likelihood, demand signals, or engagement patterns. The processing system may further recommend feeds, events, or featured collaborations based on vehicle data, modification history, marketplace activity, and group participation. Because these environments share common vehicle-centric records, collaboration records, and recommendation signals, the computing system 102 may provide a unified platform for learning, sharing, attribution, business discovery, and project coordination without requiring users or businesses to reconstruct vehicle history from multiple disconnected services.

For example, a user may maintain a vehicle record in the virtual garage manager 110 for a modified sports car and may invite a suspension shop represented by a business garage 162 to collaborate on the vehicle's build after installation of a suspension kit and an exhaust system. The business may confirm the services performed, upload installation media, associate canonical part records with the vehicle, and attach supporting documents or performance results to the collaboration record. The confirmed collaboration record may then appear in the user's garage, in the business garage portfolio, and in one or more relevant group feeds. The user may further publish a short link associated with the vehicle or garage through the external social media interface 116 so that third parties may access a unified page showing the vehicle, its modifications, and the credited business contributions without manual reconstruction of the build history from multiple external pages.

In some embodiments, the business garage 162 may further operate as a configurable storefront environment. The storefront environment may expose portfolio vehicles, featured services, business-generated posts, galleries, promotions, sponsored placements, recommended products, and optional transaction interfaces such as booking, cart, or fulfillment interfaces. The processing system may tailor displayed storefront content according to selected vehicle data, modification interests, watch-list data, prior interactions, project stage, or purchase-likelihood signals. In addition, the processing system may provide the business with analytics on engagement, demand trends, vehicle-specific interest, conversion activity, and collaboration performance associated with published content. Thus, FIG. 1D may represent a vehicle-centric architecture in which business garages 162, user garages 164, collaboration records 160, and sharable profile pages 168 cooperate to unify social interaction, verified build attribution, business discovery, and vehicle-specific publishing within the computing system 102.

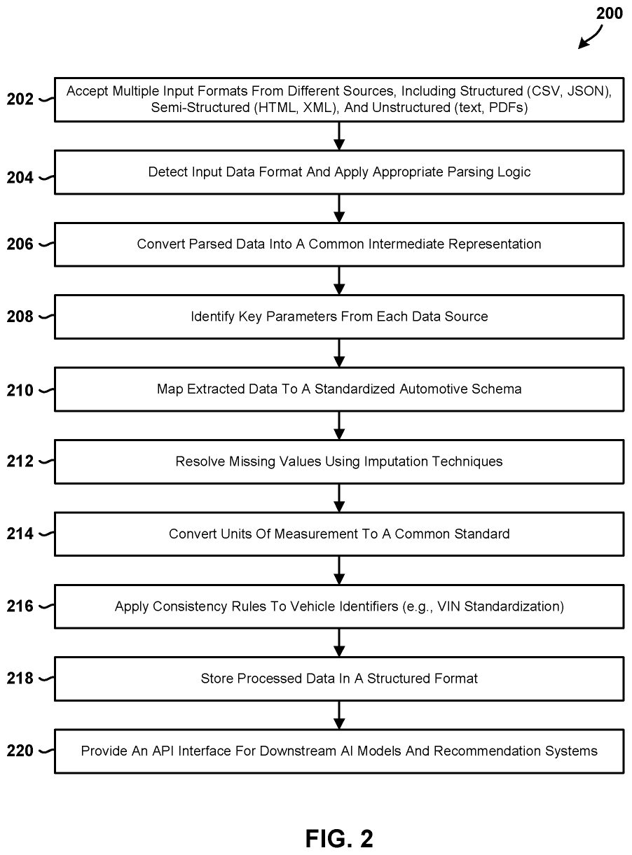

FIG. 2 is a process flow diagram illustrating a method 200 of standardizing automotive data from multiple diverse formats in accordance with some embodiments. Method 200 may be performed by a processing system within a computing device or multiple computing devices described in this application. The term “processing system” may collectively refer to any hardware components capable of performing method 200.

In block 202, the processing system may accept automotive data inputs from multiple sources in structured, semi-structured, or unstructured formats. For example, structured formats may include comma-separated values (CSV) files or JavaScript object notation (JSON) objects. Semi-structured formats may include extensible markup language (XML) files or hypertext markup language (HTML) documents. Unstructured formats may include plain text files, portable document format (PDF) documents, social media content, or user-generated posts from online forums. The processing system may accept automotive data from official manufacturer databases, third-party aftermarket product listings, and user-generated modification descriptions posted within community forums or social networks.

In block 204, the processing system may analyze each incoming automotive data input to determine its specific format. The processing system may then apply format-specific parsing procedures appropriate for correctly interpreting the data. For example, the processing system may identify incoming data as a CSV spreadsheet containing automotive parts data, a JSON object containing vehicle specifications, or a social media post containing embedded images of vehicle modifications. The processing system may then extract the relevant automotive data using specialized parsing logic associated with the identified data format.

In block 206, the processing system may convert parsed automotive data into a standardized intermediate representation. For example, textual descriptions from community forum posts, numeric sensor readings, or vehicle modification logs may become standardized structured data objects containing uniform parameters such as vehicle specifications, user identifiers, modification details, or social interaction references. This intermediate representation may provide uniformity and enable consistent downstream processing and analytics across disparate automotive data sources.

In block 208, the processing system may analyze standardized data objects to extract relevant automotive parameters. For example, the processing system may extract specific vehicle attributes, such as engine power ratings, suspension types, user-generated modification notes, or social engagement metrics from community interactions.

In block 210, the processing system may map extracted automotive parameters onto a standardized automotive schema. The standardized schema may define uniform categories and attributes that include vehicle specifications, sensor telemetry data, user profile information, and community-based modification recommendations. For example, engine performance metrics from official manufacturer files, user modification notes from online community forums, and real-time telemetry data from vehicles may become aligned consistently under defined schema categories. This mapping process may unify automotive data from diverse sources and formats.

In block 212, the processing system may perform imputation methods to resolve incomplete automotive data fields within the standardized data objects. For example, when a user-generated content post describes a modification without specifying a manufacturer or component brand, the processing system may infer missing information using statistical or machine learning algorithms based on previously recorded community modification entries or verified aftermarket component databases.

In block 214, the processing system may convert automotive data parameters to uniform units of measurement. For example, the processing system may convert automotive speed data from miles per hour (mph) to kilometers per hour (km/h) and weight measurements from pounds (lbs) to kilograms (kg) to maintain uniformity between user-submitted data and manufacturer-provided specifications. This conversion process may ensure consistent data comparisons and analyses.

In block 216, the processing system may apply standardization rules to vehicle identifiers to improve data accuracy and consistency. For example, the processing system may standardize vehicle identification numbers (VINs), model names, or user-generated references to vehicles within community-generated content. The processing system may apply logic to match and validate community references to provide accurate linking between user-submitted modification discussions or social interactions and official vehicle records.

In block 218, the processing system may store standardized automotive data within structured databases or file systems optimized for rapid data retrieval. For example, automotive parameters and user-generated social content may be organized within a structured database schema that supports efficient query execution. Stored data may subsequently support AI-based recommendation generation, predictive analytics, or integration of social community feedback into vehicle modification recommendations.

In block 220, the processing system may provide standardized APIs to downstream AI models or vehicle modification recommendation systems. For example, these APIs may present standardized queries or retrieval methods for accessing automotive data and user-generated content. AI-based recommendation systems may use these APIs to access integrated automotive specifications and community-generated modification data to produce personalized vehicle upgrade suggestions or augmented reality visualization experiences.

In some embodiments, a centralized Universal Automotive Data Converter may execute method 200. The Universal Automotive Data Converter may ingest automotive data from manufacturer-provided databases, community forum content, real-time vehicle telemetry streams, and social network data. In addition, the Universal Automotive Data Converter may perform the data acceptance, parsing, intermediate representation, parameter extraction, schema mapping, unit conversion, identifier standardization, and data storage processes as described above in blocks 202 through 218. This centralized component may uniformly prepare automotive data and social network-generated content for AI-based analysis and personalized recommendation generation.

In some embodiments, the processing system may implement RAG methods for enhanced data retrieval and recommendation generation using vehicle-specific build documents in addition to general automotive data objects. Rather than relying only on isolated component records, forum posts, or generic historical outcomes, the processing system may maintain build documents representing real vehicles and associated modification histories. A build document may include year, make, model, trim, engine, drivetrain, vehicle identification number, installed modifications, removed modifications, planned modifications, performance measurements, fitment outcomes, maintenance history, community feedback, user-specific notes, or verified brand and part identifiers. The processing system may store such build documents in a document-oriented repository, a hybrid data store, or another structured data environment, and may further generate vector embeddings for the build documents or selected sub-portions thereof.

In some embodiments, the processing system may associate each build document with one or more popularity or quality metrics. Such metrics may be based on user views, likes, saves, shares, comments, reactions, modification-specific likes, verified installation outcomes, dyno uploads, measured performance confirmations, source credibility, verified part usage, recency, or combinations thereof. The processing system may use weighted scoring techniques to generate a popularity score, a quality score, a trust score, or a composite score for each build document. The weighted scoring techniques may prioritize verified outcomes or higher-confidence sources over less reliable sources and may optionally apply recency decay or thresholding to reduce the influence of stale or low-confidence records.

In response to receiving a user query or recommendation request, the processing system may identify build documents associated with vehicles that match or approximately match the user's vehicle and objective. For example, the processing system may retrieve build documents based on year, make, model, trim, engine, drivetrain, installed modification state, intended driving style, or performance objective. The processing system may then rank retrieved build documents according to semantic relevance and the popularity or quality metrics associated with the build documents. In some embodiments, the processing system may apply a minimum threshold to exclude low-confidence or low-engagement build documents and may select a top-ranked subset of build documents for further evaluation.

The processing system may retrieve metadata associated with the selected build documents, format the selected build documents and metadata as structured context for a neural network model or LXM, and generate vehicle modification recommendations informed by recurring, community-validated modification combinations. For example, when multiple top-ranked build documents associated with similar vehicles include a common exhaust system, intake system, suspension configuration, or tuning sequence, the processing system may increase the relevance of that combination when generating a grouped modification package for a new user having a similar vehicle and a similar objective. In addition, the processing system may record subsequent user selections, implementation outcomes, and updated engagement metrics to refine build-document scoring, ranking, and retrieval over time.

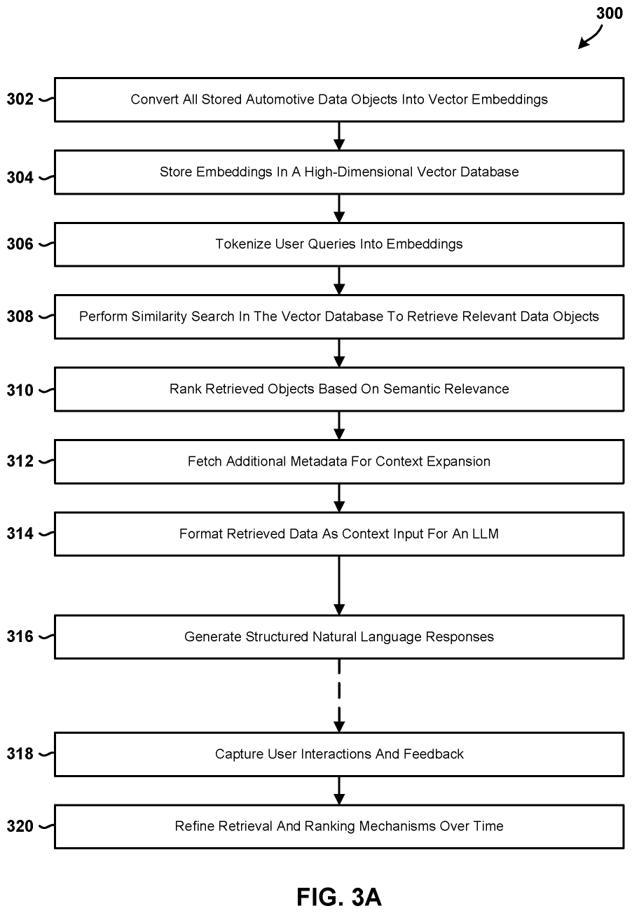

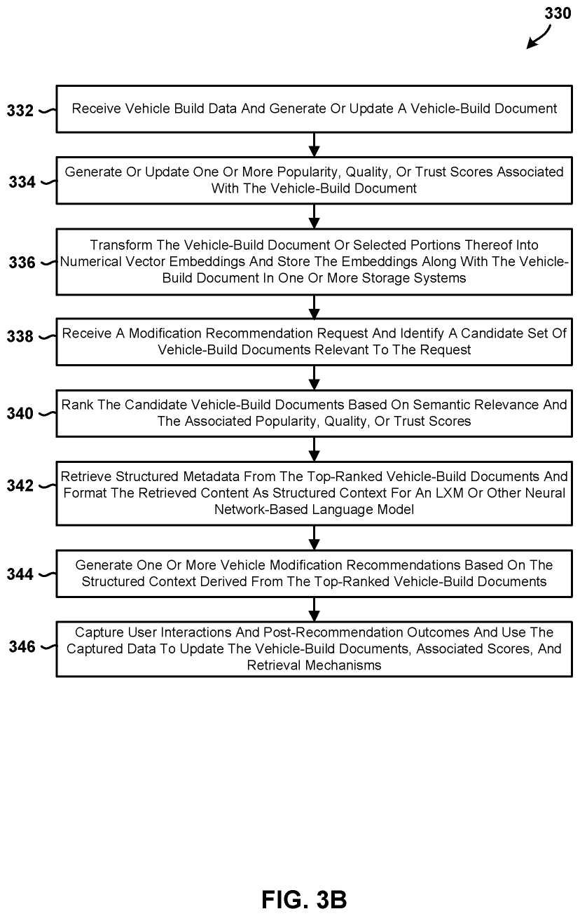

FIG. 3A is a process flow diagram illustrating a method 300 of RAG-based automotive data retrieval in accordance with some embodiments. Method 300 may be performed in a computing device by a processing system encompassing one or more components or subsystems discussed in this application. In order to encompass the alternative configurations enabled in various embodiments, the hardware implementing any or all of the method is referred to herein as a “processing system.”

In block 302, the processing system may transform automotive data objects stored within the unified automotive data store into numerical vector embeddings. For example, the processing system may apply trained machine learning models to convert textual and numerical automotive parameters, including vehicle specifications, modification details, performance metrics, user-generated content, and community feedback, into high-dimensional numerical vectors. These embeddings may represent automotive information consistently and efficiently.

In block 304, the processing system may store generated automotive vector embeddings in a high-dimensional vector database optimized for efficient similarity searching and rapid data retrieval. For example, the processing system may store embeddings within specialized database systems structured for managing large quantities of multidimensional numerical vectors. Such vector databases may support rapid retrieval of similar automotive data objects in response to queries.

In block 306, the processing system may tokenize and convert user-generated queries into numerical query embeddings for semantic matching against stored automotive embeddings. For example, when a user submits a natural language query regarding suitable vehicle modifications, the processing system may translate this textual query into a corresponding numerical embedding compatible with stored vector embeddings representing automotive data objects.

In block 308, the processing system may execute similarity searches within the vector database to identify automotive data embeddings most similar to the query embedding. For example, the processing system may apply algorithms such as approximate nearest neighbor searches to efficiently locate automotive data objects with embeddings mathematically similar to the query embedding.

In block 310, the processing system may rank retrieved automotive data objects according to semantic relevance to prioritize the most contextually appropriate results. For example, the processing system may apply additional scoring techniques to rank automotive data objects based on both mathematical similarity and contextual relevance relative to user-submitted queries. Higher-ranked automotive data objects may represent data most relevant to the query context.

In block 312, the processing system may retrieve supplemental metadata associated with highly-ranked automotive data objects to expand contextual information available for generating responses. For example, the processing system may obtain vehicle specifications, historical performance data, prior modification outcomes, or community reviews linked to top-ranked automotive data embeddings. Expanded contextual information may improve the comprehensiveness of the data used to generate user responses.

In block 314, the processing system may format ranked and contextually expanded automotive data as structured context input compatible with neural network-based language models (e.g., LXMs, etc.). For example, the processing system may structure retrieved automotive data and metadata into formats efficiently processed by LXMs, enabling effective generation of natural language responses or detailed recommendations.

In block 316, the processing system may generate structured natural language responses or modification recommendations based on context input provided to the LXM. For example, the processing system may utilize LXMs to convert structured automotive data into readable, informative explanations, diagnostic recommendations, or detailed vehicle modification suggestions responsive to user queries.

In block 318, the processing system may record user interactions and feedback relating to generated responses or recommendations. For example, the processing system may capture user actions such as selection or acceptance of specific recommended modifications or positive reactions to generated diagnostic explanations. Captured interaction data may inform system adjustments to improve response quality over time.

In block 320, the processing system may refine similarity search algorithms, ranking procedures, and data retrieval methods based on captured user feedback. For example, user interactions indicating favorable outcomes or acceptance of generated recommendations may guide adjustments to similarity search parameters or ranking algorithms, progressively enhancing the accuracy and relevance of retrieved automotive data and generated recommendations.

In some embodiments, the processing system may implement document-based, popularity-weighted retrieval augmented generation to improve vehicle modification recommendations using crowd-sourced vehicle build data. In these embodiments, the processing system may create and maintain a build document for individual vehicles or vehicle configurations and may use these build documents as a primary or supplemental source of context for recommendation generation. Each build document may represent a specific vehicle and may include structured and unstructured information regarding the vehicle's configuration, installed modifications, removed modifications, planned modifications, measured or estimated performance outcomes, source confidence, and community validation signals. By retrieving and ranking such build documents, the processing system may identify modification combinations that have already demonstrated compatibility or popularity among similar vehicles and may use this information to generate more accurate and more relevant grouped modification recommendations.

In some embodiments, the processing system may maintain the build documents in a document-oriented repository and may also store associated embeddings in the vector database. A build document may be created when a user first registers a vehicle, imports a vehicle profile, or enters vehicle-identifying information. The build document may thereafter be updated whenever the user adds or removes a modification, uploads a dyno result, records a maintenance event, accepts an AI-generated grouped modification package, verifies an installation outcome, uploads media associated with the vehicle, or otherwise interacts with the platform in a manner that changes the vehicle's modification state. In this manner, the build document may operate as a continuously updated representation of the vehicle's current and historical build state.

In some embodiments, each build document may include one or more popularity or trust metrics that are updated over time. The processing system may derive these metrics from user engagement and from validation signals. For example, the processing system may increase a popularity or trust score for a build document when the vehicle receives repeated views, likes, saves, follows, shares, comments, or positive reactions, when installed modifications receive favorable ratings, when uploaded performance outcomes align with predicted outcomes, or when verified parts are confirmed to fit and perform as expected. Conversely, the processing system may reduce a trust score when associated parts are flagged as invalid, when fitment failures are recorded, when performance claims are contradicted by measured data, or when the document originates from lower-confidence or unverified sources. The processing system may store such metrics as metadata fields associated with the build document and may update the metrics whenever new interaction or validation data become available.

FIG. 3B is a process flow diagram illustrating a method 330 of document-based, popularity-weighted retrieval augmented generation for vehicle build recommendations in accordance with some embodiments. Method 330 may be performed in a computing device by a processing system encompassing one or more components or subsystems discussed in this application. In order to encompass the alternative configurations enabled in various embodiments, the hardware implementing any or all of the method is referred to herein as a “processing system.”

In block 332, the processing system may receive vehicle build data and generate or update a vehicle-build document. For example, the processing system may receive vehicle-identifying information such as year, make, model, trim, engine, drivetrain, vehicle identification number, current modifications, prior modifications, maintenance records, dyno results, user-uploaded media, or AI-generated grouped modification-package records. The processing system may organize these data within a single build document corresponding to the vehicle or vehicle configuration. In some embodiments, separate sub-documents may be created for current configuration data, historical configuration data, performance data, or community engagement data while remaining logically linked to a common vehicle-build record.

In block 334, the processing system may generate or update one or more popularity, quality, or trust scores associated with the vehicle-build document. For example, the processing system may apply weighted scoring rules to combine signals such as vehicle views, likes, saves, shares, comments, positive reactions, modification-specific reactions, measured performance confirmations, verified installation outcomes, verified part usage, source confidence, and recency. In some embodiments, the processing system may produce a composite score representing an overall confidence level in the usefulness of the vehicle-build document for downstream recommendation generation.

In block 336, the processing system may transform the vehicle-build document or selected portions thereof into numerical vector embeddings and store the embeddings along with the vehicle-build document in one or more storage systems. For example, the processing system may embed a full build document, embedded summaries of the build document, or component-level portions such as installed-modification lists, performance summaries, or fitment notes. The processing system may store the embeddings in the vector database and may store the build document itself in a document-oriented repository, thereby enabling fast retrieval of both semantically relevant vehicle-build records and structured metadata associated with those records.

In block 338, the processing system may receive a modification recommendation request and identify a candidate set of vehicle-build documents relevant to the request. For example, the request may be based on a user's vehicle and a desired objective such as track performance, off-road performance, drag-strip performance, improved handling, improved braking, improved fuel efficiency, or a balanced build under a specified budget. The processing system may identify candidate vehicle-build documents by filtering according to one or more vehicle parameters, such as year, make, model, trim, engine, drivetrain, existing modifications, or intended use conditions, and by performing similarity searches against embeddings derived from the request and from the candidate vehicle-build documents.

In block 340, the processing system may rank the candidate vehicle-build documents based on semantic relevance and the associated popularity, quality, or trust scores. For example, the processing system may first eliminate documents that fall below a minimum score threshold and then select a top-ranked subset of documents, such as a top-N group of build documents, for downstream context generation. In some embodiments, the top-ranked subset may be selected using a weighted combination of semantic similarity and popularity metrics so that the system favors both relevant and community-validated build documents.

In block 342, the processing system may retrieve structured metadata from the top-ranked vehicle-build documents and format the retrieved content as structured context for an LXM or other neural network-based language model. For example, the processing system may format recurring part combinations, verified brand identifiers, verified part identifiers, fitment notes, measured performance outcomes, budget information, installation history, or community commentary in a structured representation suitable for language-model inference. The processing system may thereby provide the model with context specific not only to automotive knowledge generally, but also to vehicles and build combinations that have already been observed among similar vehicle configurations.

In block 344, the processing system may generate one or more vehicle modification recommendations based on the structured context derived from the top-ranked vehicle-build documents. For example, the processing system may generate a grouped modification package optimized according to the user's objective, a popularity-weighted grouped modification package derived from repeatedly occurring combinations among retrieved build documents, or both. In some embodiments, the processing system may generate accompanying performance predictions, confidence scores, explanations regarding community validation, or trade-off descriptions indicating why one grouped modification package is favored over another.

In block 346, the processing system may capture user interactions and post-recommendation outcomes and use the captured data to update the vehicle-build documents, associated scores, and retrieval mechanisms. For example, when a user accepts a recommended grouped modification package, rejects a recommendation, records actual installed parts, uploads performance results, or receives engagement from other users, the processing system may update the corresponding build document and may refine score calculations, ranking parameters, and embedding-generation techniques. In some embodiments, the processing system may further use accumulated build documents and observed outcomes to train or fine-tune a proprietary language model, recommendation model, or other AI model specialized for automotive modification-package generation.

The embodiments may improve the accuracy and relevance of automotive modification recommendations by combining semantic retrieval with crowd-validated vehicle build intelligence. Rather than relying only on generic parts data or isolated community posts, the processing system may leverage continuously updated vehicle-build documents representing real-world modification histories and outcomes. This approach may reduce guesswork, improve recommendation consistency, and increase confidence that grouped modification packages reflect both compatibility constraints and demonstrated popularity or success among similar vehicles.

In some embodiments, the processing system may apply XR-based visualization techniques to assist users with evaluating potential vehicle modifications and installation processes. The processing system may capture visual representations of vehicles using imaging devices such as smartphones, tablets, or dedicated XR headsets. Image recognition algorithms executed by the processing system may accurately determine vehicle make, model, and current installed modifications. In response to identified vehicles, the processing system may retrieve three-dimensional (3D) computer-aided design (CAD) models representing potential modifications from standardized databases. Spatial mapping algorithms may precisely align retrieved 3D CAD modification models onto captured vehicle images to provide accurate, real-time visual previews. Users may interactively manipulate virtual modification placements, verify compatibility against vehicle specifications, and visually assess modifications prior to physical implementation. In addition, the processing system may display step-by-step augmented reality installation instructions and provide real-time feedback regarding installation accuracy through XR interfaces. The processing system may enhance recommendation accuracy and visualization precision by incorporating hierarchical classification methods, historical installation compatibility data, and adaptive visualization algorithms. In some embodiments, XR-based visualization methods may utilize edge computing resources to maintain responsive visual experiences independent of network availability. Further, the processing system may support augmented reality marketplaces that facilitate real-time identification of suitable vehicle modifications, modification visualization, and purchase transactions during automotive events.

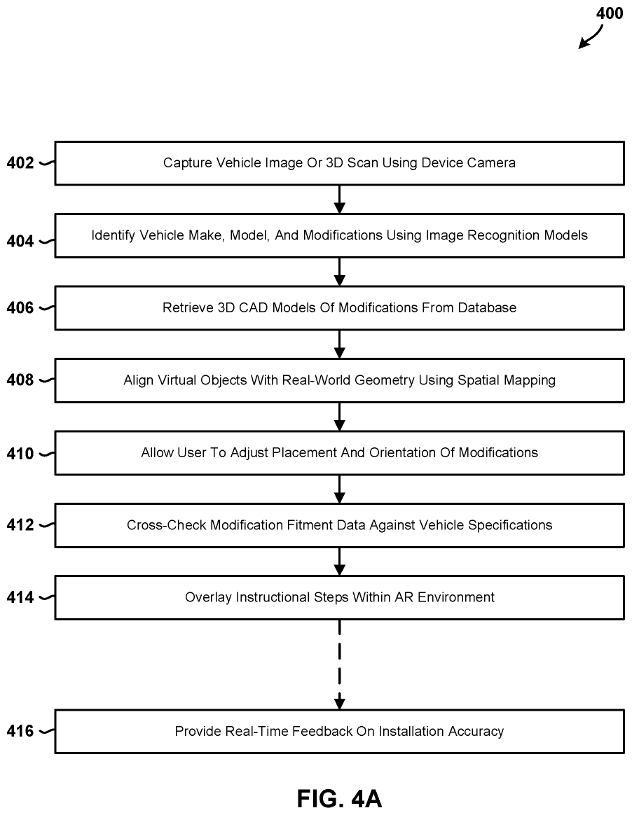

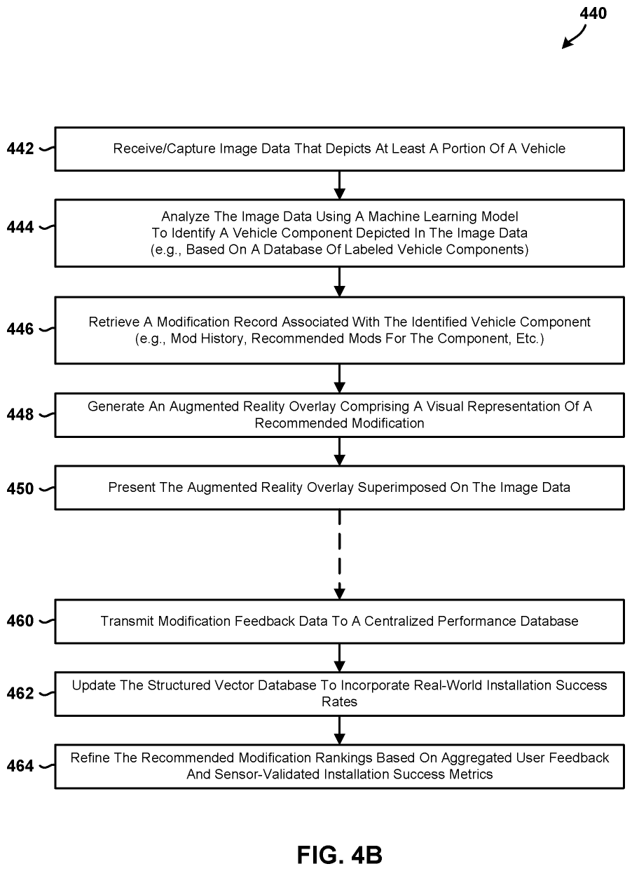

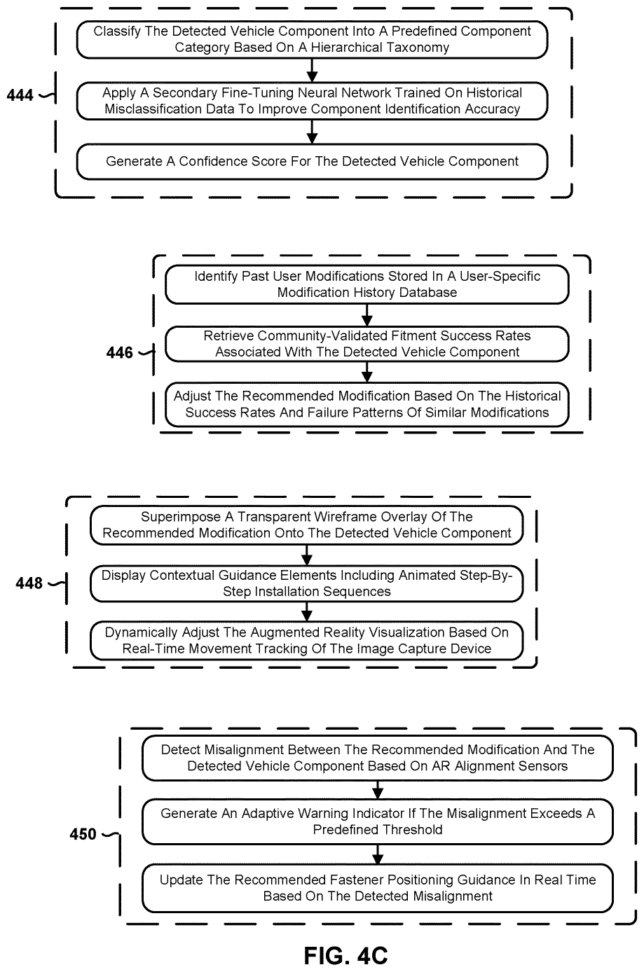

FIG. 4A is a process flow diagram illustrating a method 400 of XR-based modification visualization in accordance with some embodiments. Method 400 may be performed in a computing device by a processing system encompassing one or more components or subsystems discussed in this application. In order to encompass the alternative configurations enabled in various embodiments, the hardware implementing any or all of the method is referred to herein as a “processing system.”

In block 402, the processing system may capture a vehicle image or 3D scan using a device camera. For example, the processing system may utilize a smartphone camera or dedicated scanning device to obtain a visual representation of the vehicle. This operation may provide the foundation for subsequent XR visualizations and component recognition.

In block 404, the processing system may identify the vehicle make, model, and modifications using image recognition models. For example, the processing system may apply machine learning algorithms trained on extensive datasets of vehicle images to accurately classify the vehicle and detect any existing modifications. This identification process may enable the system to tailor recommendations based on the specific vehicle configuration.

In block 406, the processing system may retrieve 3D CAD models of modifications from a database. For example, the processing system may access a comprehensive library of digital representations for various aftermarket parts and modifications. These 3D models may serve as the basis for XR overlays and visualization of potential modifications.

In block 408, the processing system may align virtual objects with real-world geometry using spatial mapping. For example, the processing system may utilize computer vision techniques to analyze the captured image or 3D scan and determine the precise positioning of vehicle components. This alignment may ensure that XR visualizations appear correctly positioned relative to the actual vehicle.

In block 410, the processing system may allow a user to adjust the placement and orientation of modifications. For example, the processing system may provide interactive controls within the XR interface for users to fine-tune the position of virtual parts. This user interaction may enhance the accuracy and relevance of the modification visualization.

In block 412, the processing system may cross-check modification fitment data against vehicle specifications. For example, the processing system may compare the dimensions and compatibility requirements of the selected modifications with the known specifications of the identified vehicle. This verification process may help prevent incompatible or potentially unsafe modification suggestions.

In block 414, the processing system may overlay instructional steps within the XR environment. For example, the processing system may display step-by-step guidance for installing the selected modifications, with visual cues superimposed on the relevant vehicle components. This XR-based instruction may simplify the installation process for users.

In block 416, the processing system may provide real-time feedback on installation accuracy. For example, the processing system may use computer vision algorithms to analyze the user's progress during installation and offer immediate guidance or corrections. This feedback mechanism may help ensure proper installation of modifications.

FIGS. 4B and 4C are process flow diagrams illustrating a method 440 of XR-based modification visualization in accordance with some embodiments. Method 440 may be performed in a computing device by a processing system encompassing one or more components or subsystems discussed in this application. In order to encompass the alternative configurations enabled in various embodiments, the hardware implementing any or all of the method is referred to herein as a “processing system.”

In block 442, the processing system may receive or capture image data depicting at least a portion of a vehicle. For example, the processing system may accept input from a mobile device camera or a dedicated XR headset. This image capture may initiate the XR-based modification visualization process.

In block 444, the processing system may analyze the image data using a machine learning model to identify a vehicle component depicted in the image data. For example, the processing system may employ a deep neural network trained on a database of labeled vehicle components to accurately classify and locate specific parts within the image. This component recognition may form the basis for targeted modification recommendations. With reference to FIG. 4C, in some embodiments the processing system may classify the detected vehicle component into a predefined component category based on a hierarchical taxonomy, apply a secondary fine-tuning neural network trained on historical misclassification data to improve component identification accuracy, and generate a confidence score for the detected vehicle component in block 444.

In block 446, the processing system may retrieve a modification record associated with the identified vehicle component. For example, the processing system may access a database containing modification history and recommended modifications for the specific component. This retrieval process may provide context-aware suggestions based on the vehicle's current configuration. With reference to FIG. 4C, in some embodiments the processing system may identify past user modifications stored in a user-specific modification history database, retrieve community-validated fitment success rates associated with the detected vehicle component, and adjust the recommended modification based on the historical success rates and failure patterns of similar modifications in block 446.

In block 448, the processing system may generate an augmented reality overlay including a visual representation of a recommended modification. For example, the processing system may create a 3D visualization of an aftermarket part superimposed on the identified vehicle component. This XR overlay may allow users to preview modifications before making purchase or installation decisions. With reference to FIG. 4C, in some embodiments the processing system may superimpose a transparent wireframe overlay of the recommended modification onto the detected vehicle component, display contextual guidance elements including animated step-by-step installation sequences, and dynamically adjust the augmented reality visualization based on real-time movement tracking of the image capture device in block 448.

In block 450, the processing system may present the augmented reality overlay superimposed on the image data. For example, the processing system may display the virtual modification on a mobile device screen or XR headset, accurately aligned with the real-world vehicle image. This presentation may provide users with an immersive and interactive modification preview experience. With reference to FIG. 4C, in some embodiments the processing system may detect misalignment between the recommended modification and the detected vehicle component based on XR alignment sensors, generate an adaptive warning indicator if the misalignment exceeds a predefined threshold, and update the recommended fastener positioning guidance in real time based on the detected misalignment in block 450.

In some embodiments, the processing system may incorporate edge computing for real-time XR-based component recognition. For example, the processing system may utilize on-device neural processing units to perform initial image analysis and component identification without relying on cloud-based services. This edge computing approach may reduce latency and enable responsive XR visualizations, even in areas with limited network connectivity.

In addition, the processing system may implement an augmented reality marketplace that allows users to scan modifications at events and receive purchase information. For example, the processing system may enable users to point their device camera at modified vehicles at car shows or enthusiast gatherings. The system may recognize the modifications, provide information about compatibility with the user's vehicle, and offer direct purchase options through integrated e-commerce functionality.

The augmented reality-based modification visualization process may combine user input, industry data, and AI processing to generate tailored modification recommendations. By leveraging advanced computer vision techniques, 3D modeling, and machine learning algorithms, the system may provide users with an intuitive and informative tool for exploring potential vehicle modifications.

In some embodiments, the processing system may generate vehicle modification kits tailored to specific user-defined performance goals, vehicle characteristics, and preferences. The processing system may initially collect and analyze detailed vehicle specifications, desired performance improvements, and user-imposed constraints such as budget or brand preferences. Using this baseline, the processing system may query databases to identify suitable aftermarket components that meet vehicle compatibility requirements. These components may undergo performance impact analysis and compatibility assessment using machine learning algorithms to produce ranked modification options. The processing system may group compatible components into optimized modification kits designed to maximize performance improvements within specified constraints. Validation of these kits may occur through comparisons with historical performance data from similar configurations, ensuring realistic and achievable outcomes. Finally, the system may visually display recommended kits along with their projected performance metrics, providing direct purchase options via an integrated marketplace, thus streamlining the modification selection and acquisition process for users.

In block 460, the processing system may transmit modification feedback data to a centralized performance database. In block 462, the processing system may update the structured vector database to incorporate real-world installation success rates. In block 464, the processing system may refine the recommended modification rankings based on aggregated user feedback and sensor-validated installation success metrics.

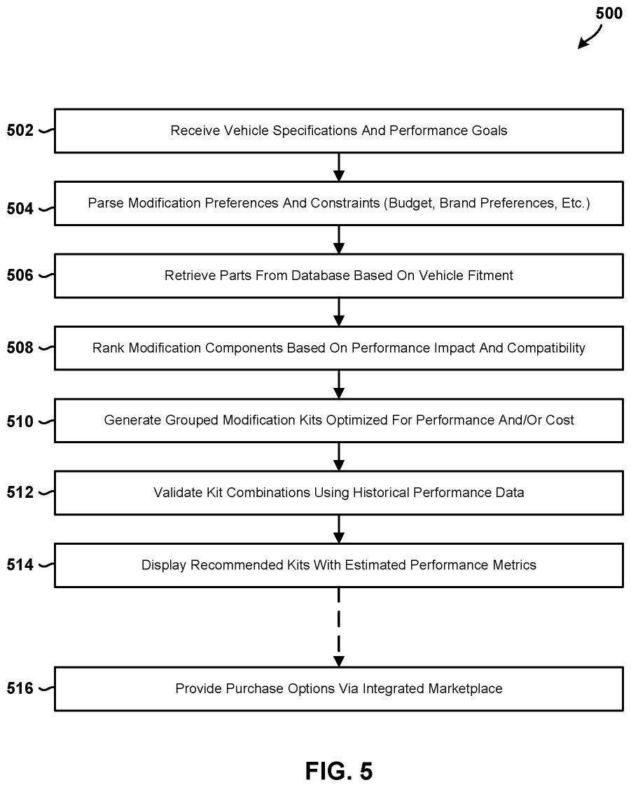

FIG. 5 is a process flow diagram illustrating a method 500 of modification kit generation in accordance with some embodiments. Method 500 may be performed in a computing device by a processing system encompassing one or more components or subsystems discussed in this application. In order to encompass the alternative configurations enabled in various embodiments, the hardware implementing any or all of the method is referred to herein as a “processing system.”

In block 502, the processing system may receive vehicle specifications and performance goals. For example, the processing system may collect data on the vehicle's make, model, year, current modifications, and desired performance metrics. This information may establish a baseline for generating appropriate modification recommendations.

In block 504, the processing system may parse modification preferences and constraints. For example, the processing system may analyze user inputs regarding budget limitations, preferred brands, and specific performance targets. This parsing may help tailor the recommendations to the user's specific needs and preferences.

In block 506, the processing system may retrieve parts from a database based on vehicle fitment. For example, the processing system may access a comprehensive catalog of aftermarket components compatible with the specified vehicle model. This retrieval may ensure that only suitable parts are considered for the modification kit.

In block 508, the processing system may rank modification components based on performance impact and compatibility. For example, the processing system may use machine learning algorithms to evaluate how each potential modification may affect vehicle performance metrics such as horsepower, torque, or fuel efficiency. This ranking may prioritize modifications that offer the most significant improvements while maintaining compatibility with the vehicle's existing systems.

In block 510, the processing system may generate grouped modification kits and optimize for performance and/or cost. For example, the processing system may create combinations of compatible parts that work together to achieve the desired performance goals within the specified budget constraints. This grouping may provide users with comprehensive upgrade packages rather than individual components.

In block 512, the processing system may validate kit combinations using historical performance data. For example, the processing system may compare the proposed modification kits against a database of real-world performance outcomes from similar vehicle configurations. This validation may help ensure that the recommended kits have a high likelihood of achieving the expected performance improvements.

In block 514, the processing system may display recommended kits with estimated performance metrics. For example, the processing system may generate a visual representation of each modification kit, including 3D models of the components and projected performance gains. This display may allow users to compare different options and make informed decisions about which modifications to pursue.

In block 516, the processing system may provide purchase options via an integrated marketplace. For example, the processing system may offer direct links to purchase the recommended modification kits from verified suppliers or dealerships. This integration may streamline the process of acquiring and implementing the chosen modifications.

The XR-based modification kit generation process may combine user input, industry data, and AI processing to create tailored recommendations. By leveraging advanced algorithms and comprehensive databases, the system may provide users with optimized modification packages that balance performance improvements, compatibility, and budget considerations.

In some embodiments, the processing system may provide interactive guidance to assist users in the installation of vehicle modifications. The processing system may first recognize and identify the specific modification intended by the user. Upon identification, the processing system may access and combine manufacturer-provided installation guidelines with insights from user-generated experiences. The system may generate a three-dimensional augmented reality visualization of the modification within the user's real-world environment to illustrate proper positioning and orientation. Visual indicators may highlight critical attachment points and required tools for each installation step. Throughout the installation, the processing system may monitor real-time progress using object recognition and computer vision techniques, providing continuous visual and audio instructions. If installation errors such as misalignments or incorrect orientations are detected, the processing system may immediately suggest corrective actions. This interactive approach may enable precise and efficient vehicle modification installations through comprehensive, real-time support and detailed instructional feedback.

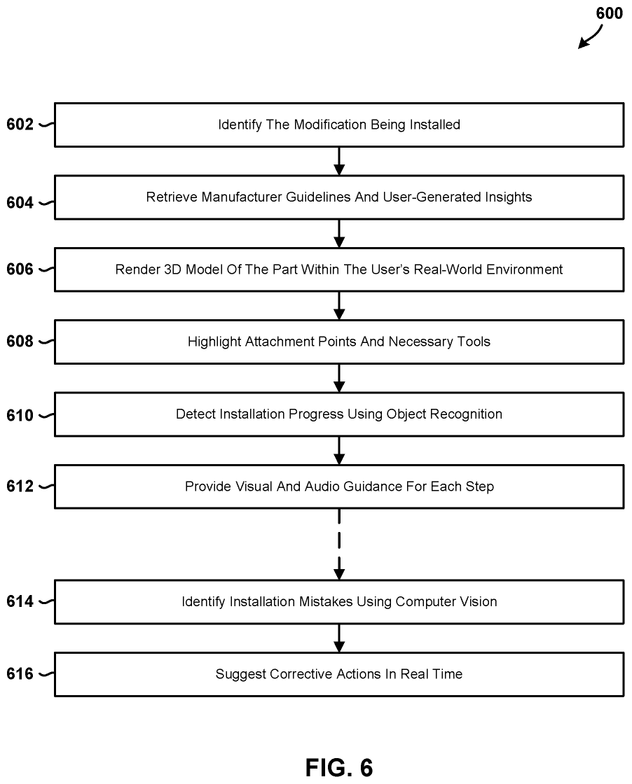

FIG. 6 is a process flow diagram illustrating a method 600 of interactive installation guidance in accordance with some embodiments. Method 600 may be performed in a computing device by a processing system encompassing one or more components or subsystems discussed in this application. In order to encompass the alternative configurations enabled in various embodiments, the hardware implementing any or all of the method is referred to herein as a “processing system.”

In block 602, the processing system may identify the modification being installed. For example, the processing system may recognize a specific aftermarket part or component that the user intends to add to the vehicle. This identification may allow the system to retrieve relevant installation information for the particular modification.

In block 604, the processing system may retrieve manufacturer guidelines and user-generated insights related to the modification. For example, the processing system may access a database containing official installation instructions from the part manufacturer as well as tips and experiences shared by other users who have performed similar modifications. This combination of official and community-sourced information may provide a comprehensive guide for the installation process.

In block 606, the processing system may render a 3D model of the part within the user's real-world environment. For example, the processing system may generate a virtual representation of the modification and superimpose it onto a live camera feed of the vehicle. This augmented reality visualization may help users understand how the part should be positioned and oriented during installation.

In block 608, the processing system may highlight attachment points and necessary tools. For example, the processing system may overlay visual indicators on the 3D model to show where the part should be connected to the vehicle and display icons representing the specific tools required for each step. This guidance may help users prepare for the installation and reduce the likelihood of errors.

In block 610, the processing system may detect installation progress using object recognition. For example, the processing system may analyze the live camera feed to identify which steps of the installation have been completed and which parts have been successfully attached. This real-time monitoring may allow the system to provide timely and relevant instructions throughout the process.

In block 612, the processing system may provide visual and audio guidance for each installation step. For example, the processing system may display animated 3D instructions showing the exact motions required to install a part, accompanied by voice prompts explaining the procedure. This multi-modal guidance may cater to different learning styles and enhance user comprehension.

In block 614, the processing system may utilize computer vision to identify any installation mistakes. For example, the processing system may compare the current state of the installation with the expected configuration at each step, detecting misalignments, incorrect part orientations, or missing components. This error detection may help prevent potential issues caused by improper installation.

In block 616, the processing system may suggest corrective actions in real time if any mistakes are detected. For example, the processing system may provide specific instructions on how to adjust a misaligned part or highlight areas that require attention. This immediate feedback may allow users to rectify errors promptly, ensuring a successful and safe installation.

The interactive installation guidance system may combine manufacturer guidelines, user-generated insights, and real-time computer vision analysis to provide comprehensive support for vehicle modifications. By leveraging 3D visualization, augmented reality, and AI-powered error detection, the system may offer a user-friendly and effective tool for guiding users through complex installation procedures.

In some embodiments, the processing system may implement a learning system to generate crowdsourced installation knowledge for vehicle modifications. The processing system may aggregate data from diverse sources, including manufacturer installation manuals, automotive forums, and user-submitted feedback. After collection, the processing system may organize and categorize the aggregated information according to specific modification types and corresponding vehicle models. The processing system may rank this information by reliability, prioritizing official manufacturer documentation over forum-based content. Machine learning algorithms may analyze the aggregated data to detect inconsistencies or conflicting recommendations, resolving discrepancies to enhance accuracy. The processing system may regularly update installation documentation by incorporating new guidelines, user experiences, and best practices, and it may implement version control to maintain transparency of changes over time. This community-driven knowledge base may thus provide comprehensive, accurate, and continuously refined installation guidance, combining official sources with practical, user-based insights to support informed vehicle modification projects.

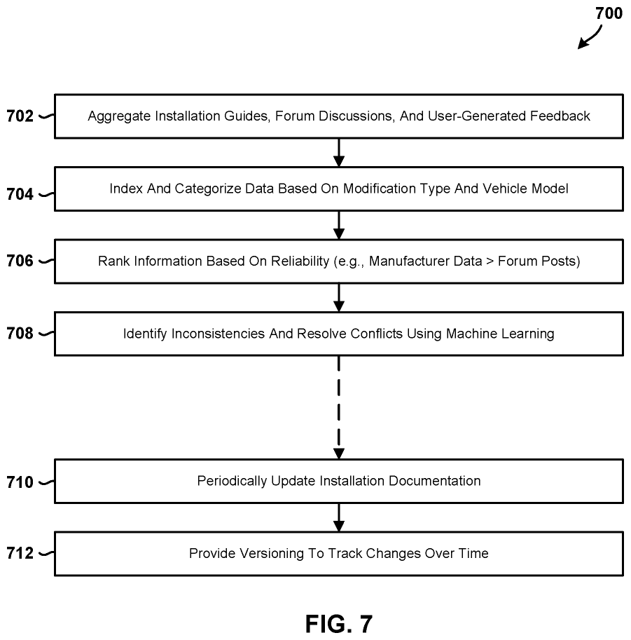

FIG. 7 is a process flow diagram illustrating a method 700 of using a learning system for crowdsourced installation knowledge in accordance with some embodiments. Method 700 may be performed in a computing device by a processing system encompassing one or more components or subsystems discussed in this application. In order to encompass the alternative configurations enabled in various embodiments, the hardware implementing any or all of the method is referred to herein as a “processing system.”

In block 702, the processing system may aggregate installation guides, forum discussions, and user-generated feedback. For example, the processing system may collect data from various sources such as manufacturer manuals, online automotive forums, and user reviews of modification installations. This aggregation may provide a comprehensive pool of information for the Mod Pro learning system.

In block 704, the processing system may index and categorize the collected data based on modification type and vehicle model. For example, the processing system may use natural language processing techniques to classify information into categories such as engine modifications, suspension upgrades, or interior customizations. This categorization may facilitate efficient retrieval and analysis of relevant information for specific modification queries.

In block 706, the processing system may rank the information based on reliability, with manufacturer data given higher priority than forum posts. For example, the processing system may assign higher weights to official installation guides and technical specifications from part manufacturers compared to user-generated content from online forums. This ranking may help prioritize more authoritative sources of information when generating recommendations.

In block 708, the processing system may employ machine learning to identify inconsistencies and resolve conflicts in the aggregated information. For example, the processing system may use natural language processing algorithms to detect contradictory instructions or conflicting recommendations across different sources. This conflict resolution may help ensure the accuracy and consistency of the installation guidance provided to users.

In block 710, the processing system may periodically update the installation documentation with new information. For example, the processing system may continuously monitor and incorporate newly published manufacturer guidelines, recent user experiences, and emerging best practices for vehicle modifications. This regular updating may help maintain the relevance and accuracy of the installation guidance over time.

In block 712, the processing system may implement versioning to track changes to the documentation over time. For example, the processing system may maintain a history of revisions for each installation guide, allowing users to access previous versions or view the evolution of recommended procedures. This versioning may provide transparency and allow users to understand how installation methods have changed or improved.

The Mod Pro learning system for crowdsourced installation knowledge may combine user-generated content, manufacturer guidelines, and machine learning techniques to create a comprehensive and dynamic resource for vehicle modification installations. By aggregating diverse sources of information, applying intelligent categorization and ranking, and continuously refining the knowledge base, the system may provide users with up-to-date and reliable guidance for their modification projects.

In addition, the community-driven aspect of the Mod Pro learning system may allow for the incorporation of real-world experiences and practical insights that may not be captured in official documentation. This collaborative approach may enhance the overall quality and applicability of the installation guidance provided to users.

In some embodiments, the processing system may implement a community matching process to connect vehicle owners based on their automotive interests, modification experiences, and geographic locations. The processing system may extract user-specific data such as vehicle type, modification history, and driving preferences. Using clustering algorithms, the processing system may group users who have similar modification patterns or preferences and who reside near one another. The processing system may identify active automotive communities, including online forums, social media groups, and local clubs, that match these grouped interests. In addition, the system may suggest driving groups and automotive events tailored to the user's vehicle modifications and driving style. Machine learning algorithms may refine these community suggestions continuously based on user interaction and feedback, enhancing recommendation accuracy over time. The community matching functionality may also integrate with modification recommendation systems, leveraging insights from community interactions to deliver personalized, informed modification suggestions aligned with prevailing community trends and experiences.

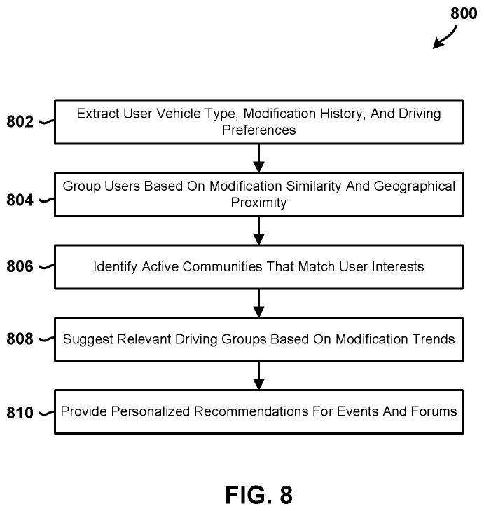

FIG. 8 is a process flow diagram illustrating a method 800 of community matching in accordance with some embodiments. Method 800 may be performed in a computing device by a processing system encompassing one or more components or subsystems discussed in this application. In order to encompass the alternative configurations enabled in various embodiments, the hardware implementing any or all of the method is referred to herein as a “processing system.”

In block 802, the processing system may extract user vehicle type, modification history, and driving preferences. For example, the processing system may retrieve data from a user profile database containing information about the make, model, and year of the user's vehicle, any modifications previously applied, and recorded driving habits or preferences. This extraction may provide a comprehensive profile of the user's automotive interests and current vehicle configuration.

In block 804, the processing system may group users based on modification similarity and geographical proximity. For example, the processing system may use clustering algorithms to identify users who have applied similar modifications to their vehicles or who have expressed interest in comparable upgrades. The processing system may also consider the users'geographic locations to facilitate potential in-person interactions. This grouping may enable the system to connect users with shared automotive interests who may be able to meet and share experiences.

In block 806, the processing system may identify active communities that match user interests. For example, the processing system may analyze online forums, social media groups, and local car clubs to find communities that align with the user's vehicle type, modification preferences, and driving style. This identification may help users discover relevant groups where they may exchange information and advice about vehicle modifications.

In block 808, the processing system may suggest relevant driving groups based on modification trends. For example, the processing system may analyze the modifications popular among different driving communities, such as off-road enthusiasts or track day participants, and recommend groups that align with the user's current or planned modifications. This suggestion may help users connect with communities that share their specific automotive interests and goals.

In block 810, the processing system may provide personalized recommendations for events and forums. For example, the processing system may use the user's vehicle profile, modification history, and identified interests to suggest local car meets, online discussion threads, or automotive events that may be particularly relevant. This personalization may help users discover opportunities to engage with like-minded enthusiasts and learn more about potential modifications for their vehicles.

In addition, the community matching process may incorporate machine learning algorithms to continuously refine its recommendations. For example, the processing system may analyze user engagement with suggested communities and events, adjusting future recommendations based on observed patterns of interest and participation. This adaptive approach may improve the relevance and effectiveness of the community matching over time.

The community matching process may also integrate with the modification recommendation system to provide a more comprehensive user experience. For example, the processing system may use insights gained from community interactions to inform and refine modification suggestions, taking into account popular trends and user-reported outcomes within specific automotive communities.

In some embodiments, the processing system may provide professional automotive service recommendations and integration with user-requested modifications or maintenance tasks. The processing system may analyze user-submitted service requests and categorize these requests by specific service types such as performance tuning, body work, or electrical repairs. Based on these categories, the processing system may identify and retrieve a curated list of qualified local automotive service providers. In addition, the processing system may rank service providers using customer reviews and provider engagement metrics, offering users informed choices. Integrated booking and secure payment functionalities may streamline scheduling and financial transactions. The processing system may also track service progress, provide follow-up support, and gather user feedback to refine future service recommendations. Machine learning algorithms may further enhance recommendation accuracy over time by continuously evaluating user preferences, service outcomes, and provider performance data. Integration with vehicle modification recommendations may enable a comprehensive, user-friendly approach to automotive enhancement and maintenance.

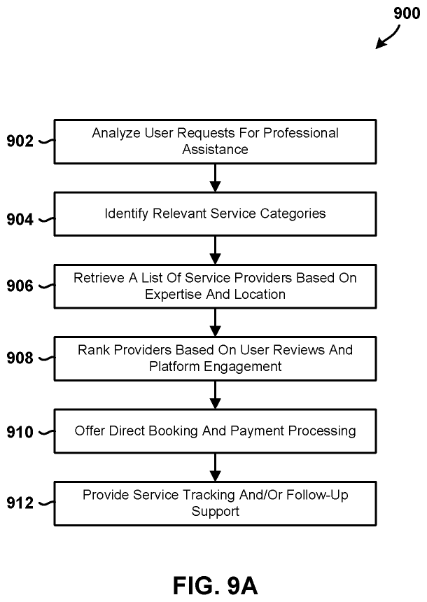

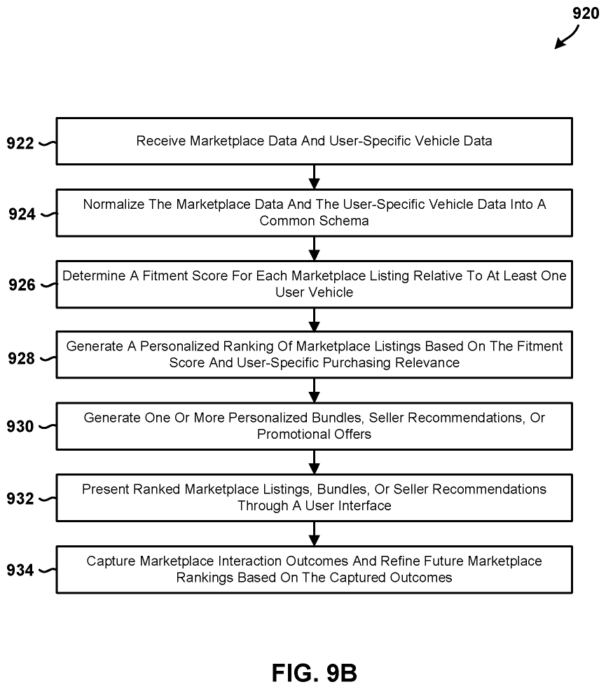

FIG. 9A is a process flow diagram illustrating a method 900 of professional service recommendation and integration in accordance with some embodiments. Method 900 may be performed in a computing device by a processing system encompassing one or more components or subsystems discussed in this application. In order to encompass the alternative configurations enabled in various embodiments, the hardware implementing any or all of the method is referred to herein as a “processing system.”

In block 902, the processing system may analyze user requests for professional assistance. For example, the processing system may examine user queries related to vehicle modifications, repairs, or maintenance to determine the specific type of automotive service required.

In block 904, the processing system may identify relevant service categories based on the analyzed requests. For example, the processing system may classify the user's needs into categories such as performance tuning, body work, or electrical system repairs. This categorization may help narrow down the pool of potential service providers.

In block 906, the processing system may retrieve a list of service providers based on expertise and location parameters. For example, the processing system may access a database of automotive professionals, filtering results based on their specializations and proximity to the user's location. This retrieval process may ensure that recommended providers have the necessary skills and are conveniently located for the user.

In block 908, the processing system may rank providers according to user reviews and their level of platform engagement. For example, the processing system may analyze feedback from previous customers and consider factors such as the provider's responsiveness and activity within the system. This ranking may help users make informed decisions when selecting a service provider.

In block 910, the processing system may offer direct booking capabilities and payment processing functionality. For example, the processing system may integrate with service providers'scheduling systems to allow users to book appointments directly through the platform. The processing system may also facilitate secure payment transactions between users and service providers.

In block 912, the processing system may provide service tracking and/or follow-up support. For example, the processing system may send notifications to users about upcoming appointments, track the progress of ongoing services, and solicit feedback after service completion. This tracking and support may enhance the user experience and contribute to the continuous improvement of the recommendation system.

In addition, the professional service recommendation and integration system may incorporate machine learning algorithms to refine its recommendations over time. For example, the processing system may analyze patterns in user preferences, service outcomes, and provider performance to improve the accuracy of future recommendations.

The system may also integrate with the vehicle modification recommendation process to provide a comprehensive solution for users. For example, when recommending modifications, the processing system may suggest nearby professionals who specialize in installing or tuning the recommended components.

In some embodiments, the processing system may perform comprehensive data normalization and integration to generate accurate insights for vehicle modifications. The processing system may accept diverse automotive data from multiple sources, including census records, DMV databases, manufacturer specifications, and user-generated content. Upon receiving the data, the processing system may categorize and standardize it into a uniform schema, facilitating effective analysis and retrieval. In addition, the processing system may label critical parameters for compatibility assessments and store the standardized data within a scalable database architecture to support efficient queries. User interactions, such as feedback on modifications or reported compatibility experiences, may be continuously integrated to refine the accuracy and relevance of the system's insights. The processing system may further enhance its capabilities through machine learning techniques, particularly for extracting meaningful information from unstructured textual sources. Robust validation processes may ensure data reliability, while privacy-preserving methods such as anonymization and access controls may safeguard sensitive user information, thereby maintaining compliance with data protection standards.

In some embodiments, the processing system may implement a fitment-aware marketplace and personalized commerce system configured to recommend, rank, and present marketplace opportunities for automotive parts, modification kits, vehicles, and related services using vehicle-specific fitment data and user-specific behavioral data. The processing system may receive marketplace listings from businesses or individual users and may compare listing characteristics against one or more vehicle profiles stored for a user. Based on this comparison, the processing system may identify listings that are directly compatible, listings that are compatible when combined with one or more supporting modifications, or listings that are incompatible with the user's vehicle configuration. The processing system may then present ranked marketplace results, personalized bundles, and recommended sellers through a user interface.

In some embodiments, the fitment-aware marketplace and personalized commerce system may include a marketplace listing database, a fitment engine, a personalization engine, a bundle generation engine, and a transaction interface. The marketplace listing database may store structured records describing listed vehicles, parts, kits, services, seller information, inventory status, pricing data, promotional data, shipping or fulfillment data, and optional authenticity or verification information. The fitment engine may compare listing data against vehicle specifications and modification records stored in the virtual garage manager 110 or profiles database 106. The personalization engine may evaluate user-specific parameters including budget, location, saved searches, watchlists, prior purchases, followed users or businesses, liked content, group participation, historical engagement, or predicted goals. The bundle generation engine may combine multiple compatible listings into tailored bundles or suggested carts, and the transaction interface may support purchase, offer submission, seller messaging, booking, reservation, or save-for-later functions.

In some embodiments, the processing system may receive user-specific marketplace inputs from multiple integrated platform components. For example, the processing system may obtain vehicle-specific information from the virtual garage manager 110, social interaction information from the social interaction module 120, activity patterns from the activity tracking module 114, business data from the vendor network interface 118, and recommendation or compatibility information from the data-driven vehicle modification recommendation system 124 or AI-based evaluation system 128. User-specific marketplace inputs may include make, model, year, trim, engine type, drivetrain, wheel or tire configuration, installed modifications, desired future modifications, historical performance goals, preferred brands, spending behavior, desired geographic radius, delivery preferences, saved items, wishlists, price thresholds, and purchase readiness indicators. By aggregating these signals, the processing system may generate marketplace outputs that are tailored to both the user and the specific vehicle.

In some embodiments, the processing system may normalize marketplace listing data using the data normalization and schema mapping system 138 before fitment analysis occurs. For example, the processing system may receive marketplace listings from businesses, individual users, external seller feeds, or partner catalogs, each of which may represent automotive data differently. The processing system may standardize listing titles, vehicle compatibility data, part descriptions, categories, pricing formats, shipping options, or seller attributes into a common schema. In addition, the processing system may label listing attributes according to fitment-relevant fields such as supported vehicle years, engine variants, transmission types, body styles, component categories, and installation dependencies. This standardized marketplace schema may allow the fitment engine to evaluate marketplace listings consistently across user-generated and business-generated listings.

In some embodiments, the fitment engine may determine a fitment score for each marketplace listing relative to a selected vehicle. The fitment score may be based on direct compatibility between listing attributes and vehicle specifications, compatibility between the listing and currently installed modifications, community-validated fitment success rates, or compatibility rules derived from manufacturer data, historical modification records, or verified part relationships. The fitment engine may classify listings into categories such as exact fit, likely fit, conditional fit, or incompatible. Conditional fit may include scenarios in which a listed component fits only when used with a particular bracket, adapter, software calibration, wheel offset, tire size, or supporting performance component. The user interface may visually distinguish these categories so that users understand whether a listing fits immediately or requires additional modifications.

In some embodiments, the personalization engine may rank marketplace listings not only according to fitment, but also according to user-specific purchasing relevance. For example, the personalization engine may evaluate signals such as how frequently the user viewed similar products, whether the user added related items to a watchlist or cart, whether the user recently viewed performance packages for the same vehicle, or whether the user follows specific brands, sellers, tuners, or communities associated with the listing. The personalization engine may also evaluate broader preference signals such as user budget, prior purchase ranges, desired outcome categories, or social engagement with similar builds. Based on these signals, the processing system may produce a purchase-likelihood score or a readiness-to-purchase score and may use that score to prioritize listings, promotions, or seller recommendations.

In some embodiments, the bundle generation engine may generate personalized bundles, recommended carts, or staged upgrade paths using compatible marketplace listings. For example, when a user searches for an intake upgrade, the processing system may identify additional compatible components such as a tune, charge pipe, or supporting sensor component that are frequently purchased together for the same year-make-model-trim-engine combination. The bundle generation engine may optimize these bundles according to one or more objectives such as performance-per-dollar, total budget, reliability, aesthetics, community popularity, availability, or shipping efficiency. In addition, the bundle generation engine may select bundle components from a single seller or from multiple sellers depending on inventory availability, pricing, promotion timing, or user preferences. The resulting bundles may be presented as recommended carts, staged build paths, or package alternatives.

In some embodiments, the processing system may generate personalized deals or supplier recommendations based on business inventory conditions and user behavior. For example, the processing system may receive data indicating that a business has over-inventory of a particular component, is promoting a time-limited discount, or seeks to push a product category to users who match a defined vehicle profile. The processing system may compare that business condition data to users who have matching vehicles, demonstrated interest in related parts, or added similar items to a watchlist. If a user's vehicle profile, budget range, and purchasing signals satisfy a threshold match, the processing system may generate a personalized deal, highlight a recommended supplier within marketplace search results, or push a targeted commerce recommendation through a feed, notification, or garage interface. In this manner, the processing system may create hyper-user-specific buying opportunities without requiring the user to manually search all compatible inventory.

In some embodiments, the fitment-aware marketplace may support both parts listings and vehicle listings. For parts listings, the processing system may compare component data against a selected user vehicle and may filter results according to fitment, brand preference, price, seller reliability, or modification plan. For vehicle listings, the processing system may compare the listed vehicle against the user's stated interests, desired future vehicles, modification preferences, or target performance range. For example, a user who follows track-focused builds for a particular vehicle platform may receive recommended modified vehicle listings that align with those preferences. In addition, the processing system may identify installed modifications disclosed in the vehicle listing and may associate those modifications with corresponding marketplace or garage records to improve listing clarity and relevance.

In some embodiments, the processing system may integrate marketplace outputs with other system components to improve trust and actionability. For example, the processing system may invoke the image-based authenticity verification system 140 to validate a listed vehicle or part, may invoke the data-driven vehicle modification recommendation system 124 to recommend complementary components, or may invoke the professional service matching system 136 to identify installation providers for a selected listing. In another example, the processing system may use community-generated feedback, seller reviews, interaction metrics, or build popularity metrics to refine seller rankings, listing rankings, or bundle rankings. By integrating fitment analysis, commerce data, and social or technical platform data, the processing system may provide a marketplace experience that is more accurate and useful than generic automotive marketplace systems.

For example, a user who stores a 2020 Ford Mustang GT in the virtual garage and has previously added a cold air intake, cat-back exhaust, and drag-oriented tire preferences may search for a supercharger kit within the marketplace. The processing system may retrieve marketplace listings from multiple businesses and individual sellers, normalize the listing data, and compare each listing against the user's specific engine configuration, currently installed components, and budget range. The fitment engine may classify certain kits as exact fit, others as conditional fit because they require upgraded injectors or fuel pumps, and still others as incompatible. The personalization engine may then rank the exact-fit or conditional-fit kits according to the user's budget, purchase behavior, community popularity, or watched brands. The bundle generation engine may propose a recommended cart that includes the supercharger kit, required injectors, and a compatible tune, and may present one or more recommended sellers based on inventory availability and historical seller reliability.

In another example, a user who follows off-road communities and maintains a modified Jeep Wrangler within the virtual garage may receive marketplace suggestions for suspension components, wheels, or armor packages. The processing system may determine that a seller has a limited-time promotion on compatible rock sliders and a matching skid plate kit and may further determine that the user recently saved related items to a watchlist and engaged with posts discussing trail protection. Based on this combination of vehicle fitment, community engagement, and purchase-likelihood signals, the processing system may generate a personalized bundle recommendation and present the bundle in a user feed, watchlist alert, or vehicle-specific marketplace view. By combining real vehicle data, user-specific intent signals, and seller inventory conditions, the processing system may create marketplace recommendations that are uniquely tailored to the individual user and vehicle.

FIG. 9B is a process flow diagram illustrating a method 920 of fitment-aware marketplace recommendation and personalized commerce generation in accordance with some embodiments. Method 920 may be performed in a computing device by a processing system encompassing one or more components or subsystems discussed in this application. In order to encompass the alternative configurations enabled in various embodiments, the hardware implementing any or all of the method is referred to herein as a “processing system.”

In block 922, the processing system may receive marketplace data and user-specific vehicle data. For example, the processing system may receive marketplace listings for parts, kits, vehicles, or services from businesses or individual users and may also obtain vehicle profiles, installed modifications, planned modifications, budgets, watchlists, or purchase-related interaction data associated with a user account. This combined input may provide the basis for vehicle-specific marketplace analysis.

In block 924, the processing system may normalize the marketplace data and the user-specific vehicle data into a common schema. For example, the processing system may standardize listing titles, compatibility fields, prices, seller attributes, inventory metadata, and vehicle configuration data so that disparate sources may be compared consistently. This normalization may improve the reliability of fitment analysis and ranking.

In block 926, the processing system may determine a fitment score for each marketplace listing relative to at least one user vehicle. For example, the processing system may compare listing compatibility data against the user vehicle's make, model, year, trim, engine, drivetrain, installed components, and supporting modification requirements. The fitment score may indicate exact fit, conditional fit, likely fit, or incompatibility.

In block 928, the processing system may generate a personalized ranking of marketplace listings based on the fitment score and user-specific purchasing relevance. For example, the processing system may weigh budget range, watchlist behavior, prior purchases, followed brands, seller reliability, community popularity, or geographic preferences to prioritize listings that are both compatible and likely to be relevant to the user.

In block 930, the processing system may generate one or more personalized bundles, seller recommendations, or promotional offers. For example, the processing system may identify multiple compatible parts that satisfy a user's vehicle goals, combine the parts into a recommended cart, or highlight a preferred seller based on price, availability, or historical fulfillment quality. In some embodiments, the processing system may incorporate seller promotion data or over-inventory data when generating these recommendations.

In block 932, the processing system may present ranked marketplace listings, bundles, or seller recommendations through a user interface. For example, the processing system may display a vehicle-specific marketplace view that highlights exact-fit listings, recommends complementary parts, identifies conditionally compatible items, and allows the user to save, watch, message a seller, submit an offer, or add items to a cart.

In block 934, the processing system may capture marketplace interaction outcomes and refine future marketplace rankings based on the captured outcomes. For example, the processing system may record user views, saves, watchlist additions, cart additions, purchases, seller messages, and post-purchase outcomes including confirmed fitment or installation success. These outcomes may then be used to refine fitment scoring, seller ranking, bundle generation, or purchase-likelihood predictions over time.

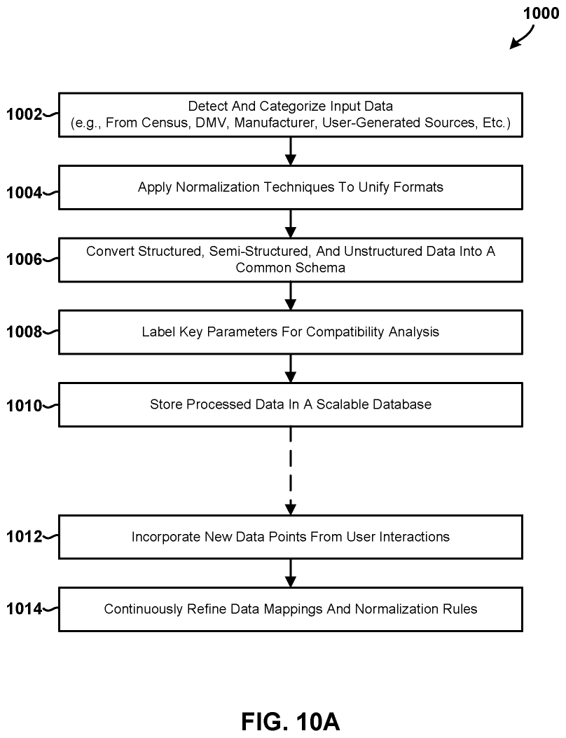

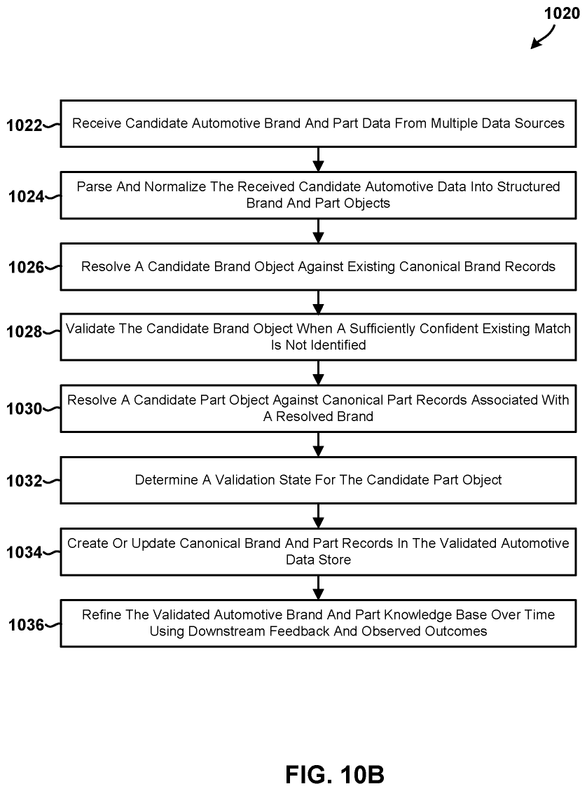

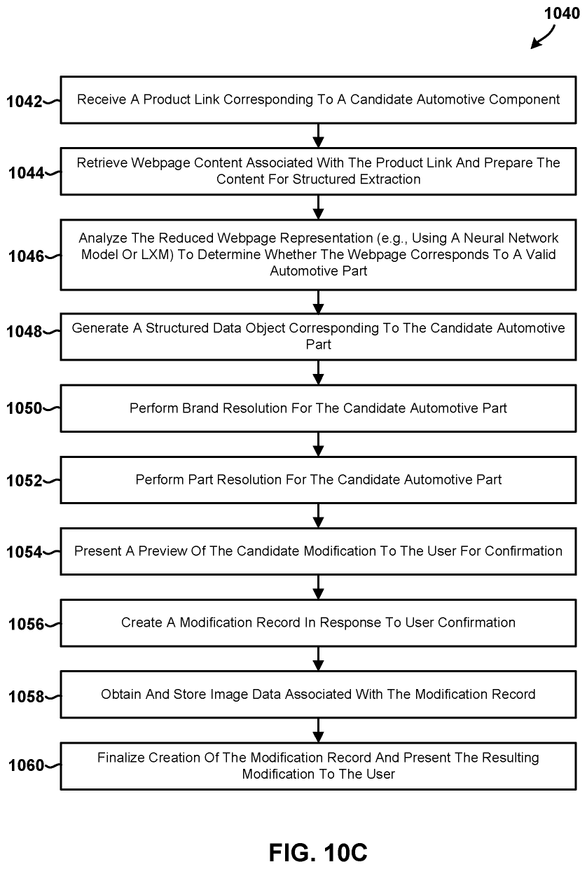

FIG. 10A is a process flow diagram illustrating a method 1000 of data normalization and integration for vehicle modification insights in accordance with some embodiments. Method 1000 may be performed in a computing device by a processing system encompassing one or more components or subsystems discussed in this application. In order to encompass the alternative configurations enabled in various embodiments, the hardware implementing any or all of the method is referred to herein as a “processing system.”

In block 1002, the processing system may detect and categorize input data from various sources such as census, DMV, manufacturer, and user-generated sources. For example, the processing system may identify different data formats including structured databases, semi-structured XML files, and unstructured text documents from diverse automotive-related sources. This detection and categorization may allow the system to handle a wide range of data inputs effectively.

In block 1004, the processing system may apply normalization techniques to unify the formats of the collected data. For example, the processing system may convert all numerical values to a standard unit of measurement or standardize date formats across different data sources. This normalization may ensure consistency in data representation for subsequent processing steps.

In block 1006, the processing system may convert structured, semi-structured, and unstructured data into a common schema. For example, the processing system may transform data from various formats into a unified database structure with predefined fields for vehicle specifications, modification details, and performance metrics. This conversion may facilitate easier data analysis and retrieval.

In block 1008, the processing system may label key parameters for compatibility analysis. For example, the processing system may tag specific data fields such as engine specifications, suspension types, or ECU versions that may be relevant for determining modification compatibility. This labeling may enable more efficient filtering and matching of compatible modifications.

In block 1010, the processing system may store the processed data in a scalable database. For example, the processing system may utilize a distributed database system capable of handling large volumes of automotive data and supporting rapid query processing. This storage solution may allow for efficient data retrieval and analysis as the system scales.

In block 1012, the processing system may incorporate new data points from user interactions into the system. For example, the processing system may update the database with information about successful modifications, user feedback on performance improvements, or newly discovered compatibility issues. This continuous data incorporation may help keep the system's knowledge base current and relevant.

In block 1014, the processing system may continuously refine data mappings and normalization rules. For example, the processing system may adjust data transformation algorithms based on newly encountered data formats or update classification rules to improve accuracy in categorizing modification types. This ongoing refinement may enhance the system's ability to process and interpret diverse automotive data over time.

In addition, the data normalization and integration system may employ machine learning techniques to improve its data processing capabilities. For example, the processing system may use natural language processing algorithms to extract relevant information from unstructured text sources such as user forums or technical manuals. This AI-driven approach may enhance the system's ability to derive insights from complex and varied data sources.

The system may also implement data validation mechanisms to ensure the quality and reliability of the processed information. For example, the processing system may cross-reference data points from multiple sources to identify and resolve inconsistencies or errors in vehicle specifications or modification details. This validation process may help maintain the integrity of the system's knowledge base and improve the accuracy of modification recommendations.

Further, the data normalization and integration system may incorporate privacy-preserving techniques to protect sensitive user information. For example, the processing system may apply data anonymization methods or implement access controls to ensure that personal vehicle data may not be linked back to individual users. This privacy-focused approach may help build user trust and comply with data protection regulations.

In some embodiments, the data normalization and schema mapping system 138 may generate and maintain a validated automotive brand and part knowledge base that represents automotive brands and components as canonical records rather than isolated user entries. The processing system may receive candidate automotive data from multiple sources, including manufacturer data, aftermarket catalogs, distributor records, retailer databases, user-submitted records, marketplace content, extracted webpage content, and external APIs. The processing system may normalize candidate data into structured brand and part objects containing attributes such as brand name, part name, part number, product description, category, fitment statements, source URL, source identifiers, images, and related metadata. By storing canonical records instead of independent duplicates, the processing system may improve downstream compatibility analysis, AI recommendation accuracy, marketplace matching, and long-term reliability tracking.

In some embodiments, the data normalization and schema mapping system 138 may include a source ingestion module, a schema mapping engine, a brand resolution engine, a part resolution engine, a validation engine, a vector embedding module, and a verified automotive data store. The source ingestion module may accept automotive data inputs from original equipment manufacturer (OEM) databases, aftermarket supplier catalogs, scraped product databases, retailer product pages, distributor inventories, user-generated vehicle histories, and other external data sources. The schema mapping engine may transform incoming data into standardized candidate brand and candidate part objects. The brand resolution engine may determine whether a candidate brand corresponds to an existing canonical brand record. The part resolution engine may determine whether a candidate part corresponds to an existing canonical part record associated with a canonical brand. The validation engine may assign validation states, confidence values, or review indicators to the resulting records. The vector embedding module may generate embeddings for brand names, part numbers, part descriptions, fitment phrases, and related metadata to support semantic search and duplicate detection. The verified automotive data store may maintain the validated automotive brand and part knowledge base and expose it to downstream systems.

In some embodiments, the processing system may resolve candidate brand objects against existing canonical brand records using multiple matching operations. For example, the processing system may attempt exact text matching, normalized text matching, case-insensitive matching, prefix matching, reverse prefix matching, abbreviation matching, semantic similarity matching using vector embeddings, or combinations thereof. If the processing system does not identify an existing canonical brand record above a confidence threshold, the validation engine may perform supplementary validation using external sources such as manufacturer websites, distributor catalogs, authoritative automotive data sources, or LXM-generated research outputs. The processing system may thereby determine whether the candidate brand corresponds to a real automotive brand, whether the candidate brand should be linked to an existing canonical brand record, or whether a new canonical brand record should be created.

In some embodiments, the processing system may assign a validation state to each brand record. For example, the validation state may identify a brand as verified, provisionally verified, flagged for review, rejected, or user-limited. A verified brand record may satisfy a threshold level of source agreement or authoritative-source confirmation. A provisionally verified brand record may correspond to a likely automotive brand for which limited confirmation data exists. A flagged record may remain visible for additional review but may be prevented from being promoted to a global recommendation set until additional evidence is collected. A rejected brand record may correspond to non-automotive products, unreliable sources, or irreconcilable conflicting data. A user-limited record may remain associated with a specific user or vehicle history without being exposed as a globally verified catalog entry.

In some embodiments, after resolving or creating a brand record, the processing system may resolve candidate part objects against canonical part records associated with the resolved brand record. For example, the processing system may compare a candidate part against existing canonical part records using exact-name matching, normalized part-number matching, stock-keeping unit matching, manufacturer-code matching, semantic-similarity analysis of product descriptions, vector-similarity analysis, and fitment-metadata comparison. The processing system may assign greater weight to part-number matches, manufacturer-sourced data, or multi-source agreement than to user-generated free text. If an existing canonical part record satisfies a similarity threshold, the processing system may link the candidate part object to that existing canonical part record. Otherwise, the processing system may create a new canonical part record and associate the new record with the resolved brand record.

In some embodiments, each canonical part record may include fields corresponding to a brand identifier, part number, normalized part name, category, structured product description, fitment data, source URLs, source-confidence values, validation state, image references, and one or more vector embeddings. The processing system may generate embeddings from textual and numeric data fields associated with the part record, thereby enabling semantic search, duplicate detection, compatibility ranking, and relevance ranking by downstream systems. For example, a candidate part identified as “Front Brake Pad Left—2020 Sedan” from one source and “FrontPadLeft: AB-123” from another source may be resolved to a single canonical part record through a combination of part-number matching, source weighting, and vector similarity analysis.

In some embodiments, the processing system may maintain both globally verified records and non-global records. For example, when a candidate part does not satisfy a threshold level of confidence for promotion into the verified automotive data store, the processing system may create a flagged part record, a pending-review record, or a user-limited part record. The user-limited part record may remain associated with a particular user, vehicle history, or proposed modification package without being promoted to a globally recommended part set. In this manner, the processing system may preserve potentially useful automotive data while protecting the integrity of the validated automotive brand and part knowledge base.

In some embodiments, the processing system may refine validation outcomes over time based on observed usage and outcomes. For example, when users install a part on a vehicle, confirm successful fitment, upload supporting documentation, submit dyno or performance results, or report reliability outcomes, the processing system may update fitment metadata, source-confidence values, and performance or reliability metadata associated with the corresponding canonical part record. Conversely, if multiple users report incompatibility, counterfeit characteristics, or failed installations, the processing system may lower the validation confidence, adjust fitment rules, flag the record for review, or demote the part from default recommendation sets. In this way, the validated automotive brand and part knowledge base may continuously improve through a combination of authoritative-source data, community outcomes, and machine-learning-assisted review.

In some embodiments, the validated automotive brand and part knowledge base may be provided to downstream systems through standardized query interfaces. For example, the data-driven vehicle modification recommendation system 124 may query verified part records when constructing candidate modification sets, the marketplace system 137 or vendor network interface 118 may filter recommendations according to verified brands or parts, the XR-based visualization system 130 may retrieve canonical part images or models tied to verified records, and the image-based authenticity verification system 140 may compare detected branding or part geometry against validated catalog records. By centralizing brand and part validation in system 138, the processing system may improve recommendation integrity, reduce duplicate catalog entries, and provide a more reliable source of automotive truth across the platform.

FIG. 10B is a process flow diagram illustrating a method 1020 of generating and maintaining a validated automotive brand and part knowledge base in accordance with some embodiments. Method 1020 may be performed in a computing device by a processing system encompassing one or more components or subsystems discussed in this application. In order to encompass the alternative configurations enabled in various embodiments, the hardware implementing any or all of the method is referred to herein as a “processing system.”

In block 1022, the processing system may receive candidate automotive brand and part data from multiple data sources. For example, the processing system may ingest product data from manufacturer catalogs, retailer listings, distributor inventories, marketplace entries, scraped product pages, user-submitted records, or other automotive data sources. The received candidate data may include brand names, part names, part numbers, fitment statements, product descriptions, images, pricing metadata, and source identifiers.

In block 1024, the processing system may parse and normalize the received candidate automotive data into structured brand and part objects. For example, the processing system may extract text from webpages or catalog records, standardize measurement units, normalize capitalization and punctuation, isolate fitment fields, and map source-specific attributes into a common automotive schema. This normalization may produce candidate objects suitable for downstream brand and part resolution.

In block 1026, the processing system may resolve a candidate brand object against existing canonical brand records. For example, the processing system may compare the candidate brand using exact matching, case-insensitive matching, prefix matching, reverse prefix matching, abbreviation matching, or vector-similarity matching against previously stored canonical brand records. If a matching canonical brand record satisfies a confidence threshold, the processing system may associate the candidate brand object with that canonical brand record.

In block 1028, the processing system may validate the candidate brand object when a sufficiently confident existing match is not identified. For example, the processing system may access external automotive sources, manufacturer websites, or other authoritative sources to determine whether the candidate brand corresponds to a real automotive brand. The processing system may then assign a validation state such as verified, provisionally verified, flagged for review, rejected, or user-limited, and may create a new canonical brand record if validation satisfies a threshold condition.

In block 1030, the processing system may resolve a candidate part object against canonical part records associated with a resolved brand. For example, the processing system may compare the candidate part against existing canonical part records using exact name matching, part-number matching, stock-keeping unit matching, vector similarity matching, semantic similarity analysis of product descriptions, or combinations thereof. If the candidate part satisfies a matching threshold, the processing system may associate the candidate part object with the corresponding canonical part record. Otherwise, the processing system may prepare to create a new canonical part record.

In block 1032, the processing system may determine a validation state for the candidate part object. For example, the processing system may assign the candidate part object a verified state when authoritative source data or high-confidence matching supports global publication, a provisionally verified state when limited but positive evidence is available, a flagged state when conflicting information exists, a rejected state when the candidate object appears non-automotive or unreliable, or a user-limited state when the candidate part may be preserved for a user-specific workflow without promotion to a global verified catalog.

In block 1034, the processing system may create or update canonical brand and part records in the validated automotive data store. For example, the processing system may create a new canonical part record associated with a canonical brand record, store structured metadata fields, generate vector embeddings, store source-confidence values, link image references, and preserve fitment metadata for subsequent retrieval. In another example, if the candidate part object corresponds to an existing canonical part record, the processing system may update the existing record with new source data, additional fitment evidence, or revised confidence values.

In block 1036, the processing system may refine the validated automotive brand and part knowledge base over time using downstream feedback and observed outcomes. For example, the processing system may update canonical brand and part records based on user-confirmed installations, compatibility confirmations, performance outcomes, reported counterfeit indicators, or reliability feedback. The processing system may also expose the resulting validated records through standardized query interfaces to recommendation engines, marketplace systems, XR visualization systems, and authenticity verification systems. This refinement process may improve the completeness, reliability, and long-term usefulness of the validated automotive brand and part knowledge base.

For example, the processing system may receive a candidate part listing from an aftermarket retailer that identifies a product as “Flow FX Direct Fit Cat-Back Exhaust” associated with a known automotive brand and a specific vehicle application. The processing system may normalize the incoming data, confirm that the brand corresponds to an existing canonical brand record, compare the part number and description against existing canonical part records, and determine that the candidate part does not exactly match any existing record. The processing system may then create a new canonical part record, generate a vector embedding for the part description, store associated fitment metadata, and mark the record as verified or provisionally verified based on source-confidence values. In another example, if a user submits a candidate part associated with an unrecognized brand and incomplete fitment data, the processing system may create a flagged or user-limited record pending additional validation rather than immediately exposing the record as a globally verified part. In this manner, the processing system may maintain both catalog integrity and forward expansion of the automotive knowledge base.

In some embodiments, the processing system may ingest a user-submitted product webpage link and automatically generate a structured modification record from the webpage. The processing system may determine whether the linked webpage corresponds to an automotive part, normalize extracted information into a standardized schema, resolve extracted brand and part information against stored automotive records, and create or update a modification record associated with a user, a vehicle, or a garage collection. This link-based ingestion process may reduce manual data entry, improve data consistency across user garages 164, and increase the quantity of validated aftermarket component records available to other platform systems.

FIG. 10C is a process flow diagram illustrating a method 1040 of link-based modification ingestion and structured modification record creation in accordance with some embodiments. Method 1040 may be performed in a computing device by a processing system encompassing one or more components or subsystems discussed in this application. In order to encompass the alternative configurations enabled in various embodiments, the hardware implementing any or all of the method is referred to herein as a “processing system.”

In block 1042, the processing system may receive a product link corresponding to a candidate automotive component. For example, a user may paste a uniform resource locator (URL) for an aftermarket exhaust component, intake component, suspension component, wheel, body component, or other vehicle-related product into a user interface. The processing system may validate the syntax or structure of the URL, confirm that the URL corresponds to a reachable network location, normalize the URL into a canonical format, and reject malformed or unsupported links before downstream processing. In some embodiments, the processing system may perform client-side validation, server-side validation, or both.

In block 1044, the processing system may retrieve webpage content associated with the product link and prepare the content for structured extraction. For example, the processing system may fetch the webpage, render dynamically loaded content if necessary, extract textual and metadata content, and remove irrelevant webpage elements such as advertisements, scripts, style data, repetitive navigation content, or footer content. The processing system may thereby generate a reduced webpage representation that preserves product-relevant information while reducing noise presented to downstream parsing components.

In block 1046, the processing system may analyze the reduced webpage representation using a neural network model or LXM to determine whether the webpage corresponds to a valid automotive part. For example, the processing system may provide the extracted content to a language model trained or prompted to identify product name, brand, category, automotive relevance, and other attributes. If the model determines that the webpage does not correspond to an automotive component, the processing system may reject the requested ingestion and provide a reason for the rejection through the user interface. If the model determines that the webpage corresponds to an automotive component, the processing system may proceed to generate a structured data object for further database resolution.

In block 1048, the processing system may generate a structured data object corresponding to the candidate automotive part. For example, the structured data object may include one or more of a product title, normalized brand name, manufacturer part number, category, subcategory, descriptive text, price data, seller or source identifier, source URL, image URL, fitment text, performance-related attributes, installation-related attributes, and confidence values associated with extracted fields. The processing system may map these extracted values into the standardized automotive schema used by the unified automotive data store, thereby producing a normalized candidate part representation suitable for database matching and later use by recommendation, garage, marketplace, or AI systems.

In block 1050, the processing system may perform brand resolution for the candidate automotive part. For example, the processing system may compare the extracted brand name against stored brand records using case-insensitive exact matching, normalized prefix matching, reverse-prefix matching, embedding similarity analysis, or combinations thereof. When no sufficiently reliable match is found, the processing system may invoke additional validation logic to determine whether the extracted brand corresponds to a real automotive brand. This additional validation logic may include one or more of web-based validation, marketplace-source validation, manufacturer-site validation, or AI-based reasoning over the extracted content and external automotive data. When the brand is verified, the processing system may create a new brand record and a corresponding vector embedding. When the brand cannot be verified with sufficient confidence, the processing system may reject the candidate record or mark the brand as unverified for later review.

In block 1052, the processing system may perform part resolution for the candidate automotive part. For example, the processing system may compare the extracted part information against stored part records using exact-name matching, manufacturer part-number matching, semantic similarity matching in the vector database, source-URL comparison, or combinations thereof. If the processing system identifies a sufficiently reliable existing part record, the processing system may associate the candidate modification with the existing part record. If the processing system does not identify a sufficiently reliable match, the processing system may create a new part record and a corresponding vector embedding. In some embodiments, if the part cannot yet be fully verified, the processing system may create a user-specific or flagged part record that is distinguishable from a globally verified part record until additional validation occurs.

In some embodiments, the processing system may persist validated or partially validated brand and part information even when final modification creation is not completed by the user. For example, the processing system may save a newly created brand record, part record, or vector embedding after extraction and resolution so that later ingestion operations may benefit from the newly structured data, even if the user later cancels creation of the final modification record. This persistence may progressively improve the completeness and quality of the automotive data store over time.

In block 1054, the processing system may present a preview of the candidate modification to the user for confirmation. For example, the processing system may generate a preview card or other interface element showing one or more of the resolved brand, part name, product image, description, part number, fitment notes, source information, or confidence indicators. The user may confirm that the candidate modification corresponds to the intended product or may cancel the operation if the previewed result is inaccurate. This confirmation stage may reduce erroneous modification creation and improve the quality of user vehicle records.

In block 1056, the processing system may create a modification record in response to user confirmation. For example, the processing system may either associate the modification record with an existing part record identified during part resolution or create the modification record using a newly created part record. The modification record may be associated with a user account, a specific vehicle, a virtual garage entry, a modification history record, or a vehicle-specific collection of installed or planned modifications. In some embodiments, the modification record may indicate whether the part is installed, planned, user-submitted, verified, or pending further validation.

In block 1058, the processing system may obtain and store image data associated with the modification record. For example, when an image URL or other image source is available, the processing system may download the image, convert the image into a standardized format, store the image in remote object storage, create an associated image record, and link the image record to the modification record. In some embodiments, if no image URL is directly available from the webpage, the processing system may attempt to identify a representative image associated with the part from additional structured sources or search-based image retrieval processes.

In block 1060, the processing system may finalize creation of the modification record and present the resulting modification to the user. For example, the processing system may assign the modification record to a vehicle-specific collection, revalidate cached results, update one or more search indexes, refresh garage displays, and present a modification detail view through the user interface. The resulting record may thereafter be used by the virtual garage manager 110, marketplace system 137, data-driven vehicle modification recommendation system 124, or AI-based evaluation system 128 as part of later recommendation, fitment, visualization, or transaction workflows.

In some embodiments, the entry point for structured modification creation may extend beyond direct product links and may support natural-language part ingestion. For example, the processing system may receive a free-form text description, clipboard text, a part number, a product identifier, a barcode, a QR code, or another textual or machine-readable input corresponding to a candidate automotive component. The processing system may parse the input into one or more candidate brand, part-number, category, fitment, and descriptive fields and may then attempt staged validation using multiple data sources in a defined hierarchy.

In some embodiments, the staged validation hierarchy may first query a verified automotive brand and parts knowledge base, then query a scraped automotive parts data store or other secondary product repository, and then, when a sufficiently confident match is not identified, invoke web-based validation, marketplace-source validation, manufacturer-site validation, or AI-based reasoning to determine whether the input corresponds to a valid automotive part. The processing system may then associate the input with an existing canonical part record, create a new verified or provisionally verified part record, create a flagged or user-limited part record pending additional review, or reject the input as non-automotive or unreliable. In this manner, the processing system may progressively validate free-form automotive part requests and expand the automotive knowledge base even when the entry point is not a structured product link.

In some embodiments, natural-language-ingested parts may be persisted in the same manner as link-ingested parts so that later workflows may benefit from the resulting structured data. For example, the processing system may generate vector embeddings for candidate brand names, part numbers, fitment phrases, and descriptions derived from the natural-language input and may store the resulting data together with source-confidence values, validation states, and optional user-limited visibility controls. The resulting structured records may thereafter be reused by the data-driven vehicle modification recommendation system 124, the marketplace system 137, the virtual garage manager 110, and the AI-based evaluation system 128 for recommendation generation, compatibility analysis, structured package generation, or later confirmation by businesses, users, or community outcomes.

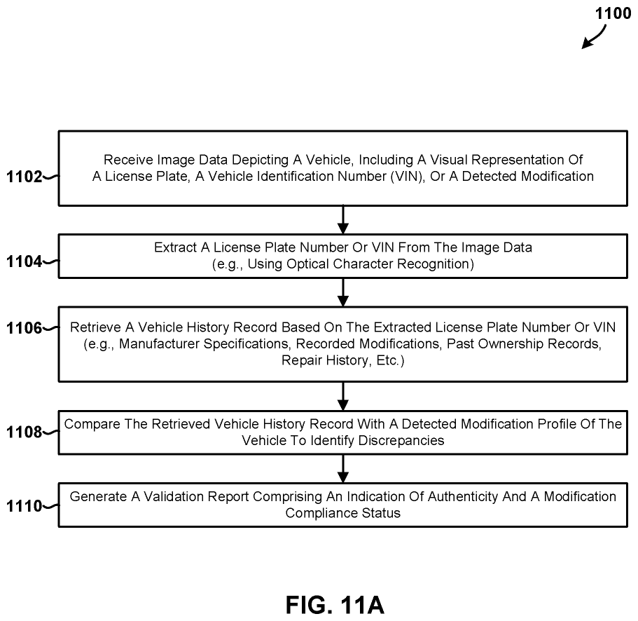

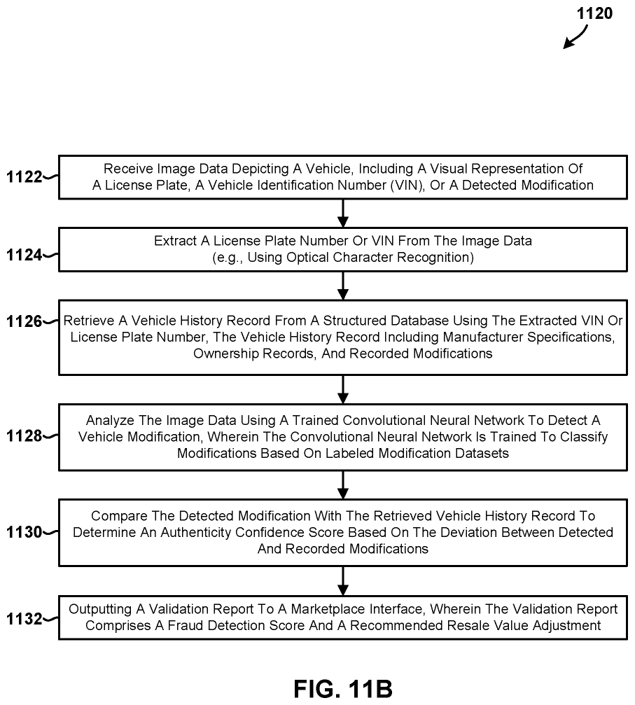

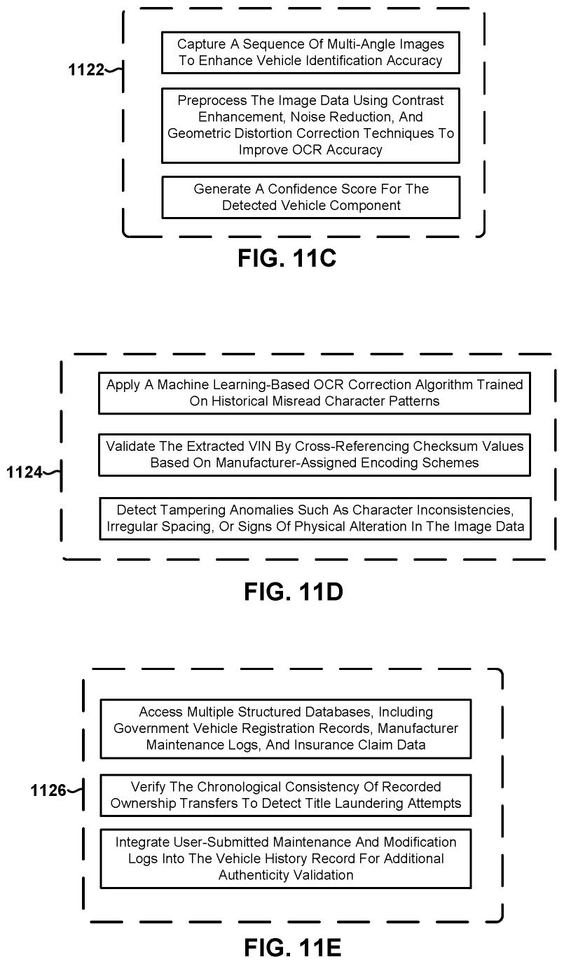

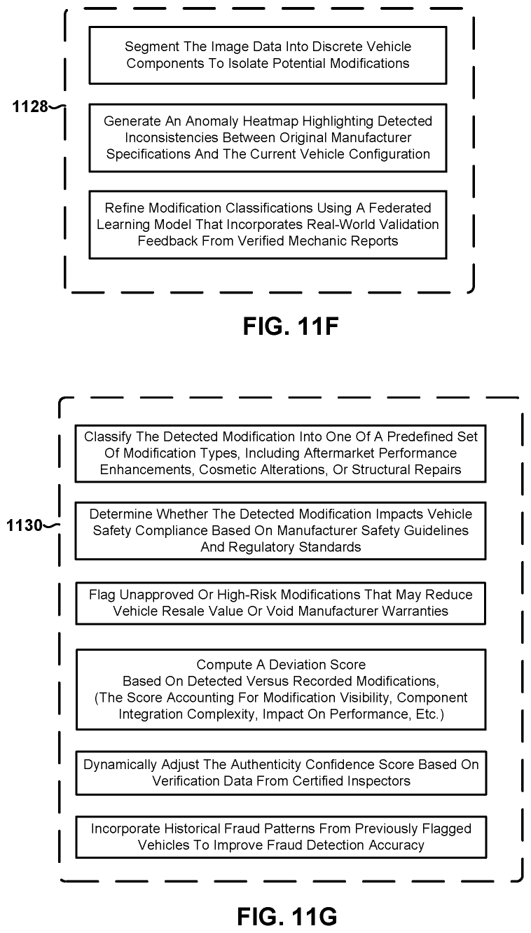

FIGS. 11A-11G are process flow diagrams illustrating methods 1100 of validating vehicle authenticity and detecting fraudulent modifications in accordance with some embodiments. Method 1100 may be performed in a computing device by a processing system encompassing one or more components or subsystems discussed in this application. In order to encompass the alternative configurations enabled in various embodiments, the hardware implementing any or all of the method is referred to herein as a “processing system.”

In block 1102, the processing system may receive image data depicting a vehicle. For example, the processing system may obtain digital photographs or video frames showing various angles of the vehicle, including visual representations of a license plate, a vehicle identification number (VIN), or detected modifications. This image data may serve as the starting point for the vehicle authenticity validation process.

In block 1104, the processing system may extract a license plate number or VIN from the image data using optical character recognition (OCR). For example, the processing system may apply specialized OCR algorithms designed to recognize and interpret alphanumeric characters on license plates or VIN labels. This extraction may allow the system to uniquely identify the vehicle for further validation.

In block 1106, the processing system may retrieve a vehicle history record based on the extracted identifier. For example, the processing system may query a database containing comprehensive vehicle information, including manufacturer specifications, recorded modifications, past ownership records, and repair history. This retrieval may provide a baseline of known information about the vehicle for comparison purposes.

In block 1108, the processing system may compare the retrieved vehicle history record with a detected modification profile of the vehicle. For example, the processing system may analyze the image data to identify visible modifications such as aftermarket wheels, body kits, or non-standard paint jobs, and compare these observations with the modifications listed in the vehicle history record. This comparison may help identify any discrepancies between the documented and observed state of the vehicle.

In block 1110, the processing system may generate a validation report indicating discrepancies between the vehicle history record and the detected modification profile. For example, the processing system may create a detailed document highlighting any unauthorized modifications, mismatches in vehicle specifications, or other anomalies that may affect the vehicle's authenticity or value. This report may provide users with valuable information for making informed decisions about vehicle purchases or evaluations.

In block 1122, the processing system may receive image data depicting a vehicle, including a visual representation of a license plate, vehicle identification number (VIN), or a detected modification. For example, the processing system may accept high-resolution photographs or video streams captured by users or professional inspectors using mobile devices or specialized cameras. This image data may form the basis for subsequent analysis and validation processes.

In block 1124, the processing system may extract a license plate number or VIN from the image data using optical character recognition. For example, the processing system may employ advanced OCR algorithms optimized for automotive identifiers, capable of accurately reading characters even in challenging lighting conditions or on partially obscured plates. This extraction may provide a reliable unique identifier for the vehicle under inspection.

In block 1126, the processing system may retrieve a vehicle history record from a structured database using the extracted VIN or license plate number. For example, the processing system may access a comprehensive automotive database containing detailed records of vehicle specifications, ownership history, and documented modifications from manufacturers, dealerships, and regulatory agencies. This retrieval may establish a verified baseline of information about the vehicle's history and configuration.

In block 1128, the processing system may analyze the image data using a trained convolutional neural network to detect vehicle modifications. For example, the processing system may apply a deep learning model specifically trained on a diverse dataset of vehicle modifications, capable of identifying subtle alterations to body panels, engine components, or interior features. This analysis may reveal modifications that may not be immediately apparent to the human eye or documented in official records.

In block 1130, the processing system may compare the detected modification with the retrieved vehicle history record to determine an authenticity confidence score. For example, the processing system may use a sophisticated algorithm that weighs the significance of each detected modification against the documented history, considering factors such as the age of the vehicle, the nature of the modifications, and their potential impact on performance or safety. This scoring may provide a quantitative measure of the vehicle's authenticity and the extent of undocumented modifications.

In block 1132, the processing system may output a validation report to a marketplace interface. For example, the processing system may generate a comprehensive document detailing the authenticity confidence score, identified modifications, and any discrepancies between the observed and documented vehicle state. This report may include a fraud detection score indicating the likelihood of intentional misrepresentation, as well as a recommended resale value adjustment based on the impact of detected modifications. The marketplace interface may present this information in a user-friendly format, allowing potential buyers or sellers to make informed decisions about the vehicle's value and authenticity.

In addition, the processing system may implement advanced image preprocessing techniques to enhance the quality and reliability of the input data. For example, the processing system may apply noise reduction algorithms, contrast enhancement, and geometric distortion correction to improve the accuracy of subsequent OCR and modification detection processes. This preprocessing may help ensure consistent performance across various image capture conditions and device types.

The processing system may also employ a multi-stage verification process for extracted vehicle identifiers. For example, the processing system may cross-reference the OCR results against known VIN formats and checksums to validate the accuracy of the extracted information. In cases where the initial extraction may be uncertain, the processing system may prompt users for manual verification or request additional images to improve confidence in the vehicle's identity.

Further, the processing system may utilize a federated learning approach to continuously improve its modification detection capabilities while preserving user privacy. For example, the processing system may update its convolutional neural network models based on aggregated insights from multiple validation sessions without centralizing sensitive vehicle data. This approach may allow the system to adapt to new modification trends and improve detection accuracy over time while maintaining robust data protection measures.

In some embodiments, the processing system may validate vehicle authenticity and detect fraudulent modifications by leveraging advanced image analysis and machine learning techniques. The processing system may initially obtain visual data depicting a vehicle, including identifiers such as a license plate or VIN. Using specialized optical character recognition (OCR), the processing system may extract these identifiers to access comprehensive vehicle history records. The system may employ trained convolutional neural networks to analyze the visual data and detect both documented and undocumented modifications. By comparing detected modifications against historical records, the processing system may generate quantitative authenticity confidence scores and detailed validation reports. These reports may highlight discrepancies, potential unauthorized alterations, and recommended adjustments to vehicle value. In addition, advanced image preprocessing, multi-stage identifier verification, and privacy-preserving federated learning may continuously enhance accuracy, reliability, and adaptability in identifying fraudulent modifications and ensuring vehicle authenticity.

In some embodiments, the processing system may diagnose vehicle performance issues by analyzing sound data captured from a vehicle's engine using advanced artificial intelligence techniques. The processing system may initially collect audio recordings from strategically positioned microphones to create a detailed acoustic profile. A trained deep learning model may analyze these recordings, detecting specific sound patterns associated with mechanical anomalies by comparing captured sounds against established reference profiles. The processing system may further segment and normalize the audio data, employing temporal neural networks to identify progressive mechanical degradation. Environmental adjustments, such as temperature or altitude, may be factored into the analysis to improve accuracy. Based on the detected acoustic anomalies, the system may retrieve corrective actions from structured databases and generate comprehensive diagnostic reports indicating recommended solutions and failure probabilities. Continuous refinement through feedback and adaptive learning methods may further enhance the system's diagnostic accuracy and reliability.

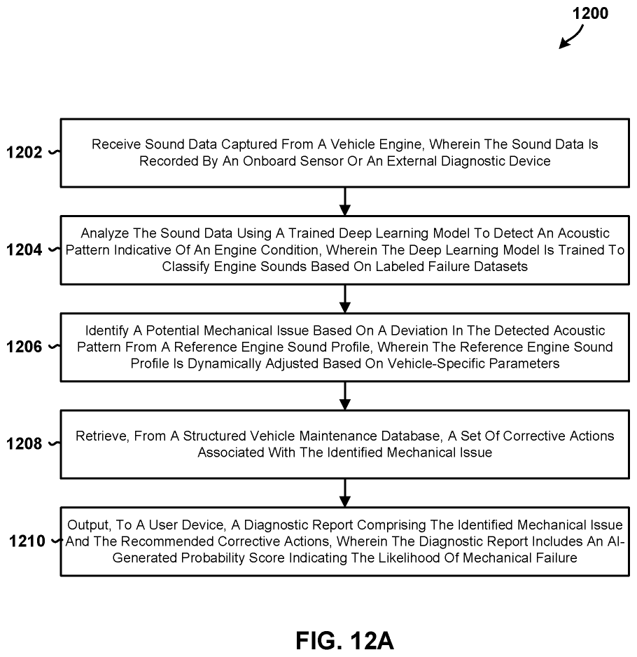

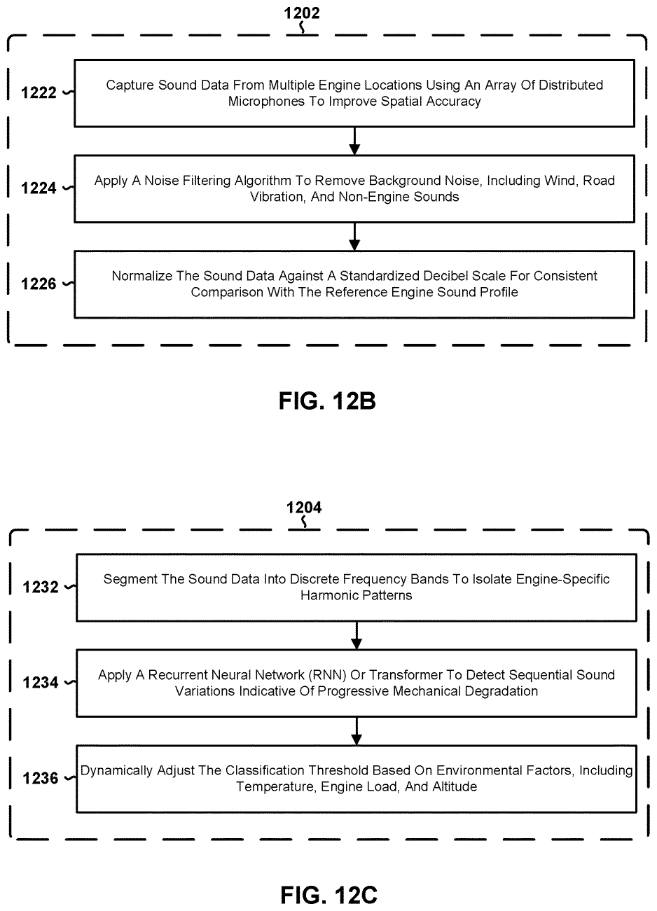

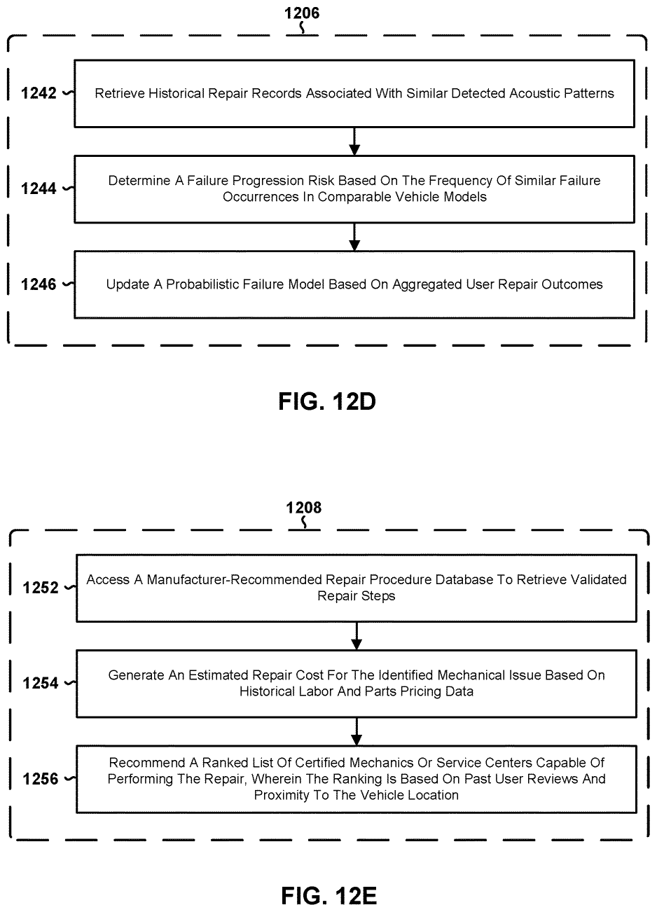

FIGS. 12A-12E are process flow diagrams illustrating methods 1200 of diagnosing vehicle performance issues based on sound analysis in accordance with some embodiments. Method 1200 may be performed in a computing device by a processing system encompassing one or more components or subsystems discussed in this application. In order to encompass the alternative configurations enabled in various embodiments, the hardware implementing any or all of the method is referred to herein as a “processing system.”

In block 1202, the processing system may receive sound data captured from a vehicle engine. For example, the processing system may collect audio recordings from an onboard sensor or an external diagnostic device placed near the engine compartment. This sound data may contain valuable information about the engine's operational state and potential mechanical issues.

In block 1204, the processing system may analyze the sound data using a trained deep learning model to detect acoustic patterns indicative of engine conditions. For example, the processing system may apply a convolutional neural network trained on a large dataset of labeled engine sounds to identify specific audio signatures associated with various engine states and potential problems. This analysis may allow the system to recognize subtle auditory cues that may indicate developing mechanical issues.

In block 1206, the processing system may identify potential mechanical issues by comparing deviations in the detected acoustic pattern from a reference engine sound profile. For example, the processing system may maintain a database of normal engine sound profiles for various vehicle makes and models, and use these as baselines for comparison. The reference engine sound profile may be dynamically adjusted based on vehicle-specific parameters such as age, mileage, and known modifications. This comparison may help pinpoint anomalies that may require attention or further investigation.

In block 1208, the processing system may retrieve a set of corrective actions associated with the identified mechanical issue from a structured vehicle maintenance database. For example, the processing system may access a comprehensive repository of repair procedures, part replacement recommendations, and maintenance schedules tailored to specific engine problems. This retrieval may provide users with actionable information to address the detected issues.

In block 1210, the processing system may output a diagnostic report to a user device. For example, the processing system may generate a detailed document containing the identified mechanical issue, recommended corrective actions, and an AI-generated probability score indicating the likelihood of mechanical failure. This report may be displayed on a smartphone app or sent via email, providing users with clear and actionable information about their vehicle's condition.

The method for processing engine sound data may include additional operations to enhance the accuracy and reliability of the diagnostic process. In block 1222, the processing system may capture sound data from multiple engine locations using an array of distributed microphones to improve spatial accuracy. For example, the processing system may utilize a network of small, strategically placed microphones around the engine compartment to capture a more comprehensive acoustic profile. This multi-point data collection may help isolate and identify the specific source of unusual engine sounds.

In block 1224, the processing system may apply a noise filtering algorithm to remove background noise, including wind, road vibration, and non-engine sounds. For example, the processing system may use adaptive noise cancellation techniques to isolate the engine sounds from ambient environmental noise. This filtering may improve the signal-to-noise ratio of the captured audio data, allowing for more accurate analysis of engine-specific acoustic patterns.

In block 1226, the processing system may normalize the sound data against a standardized decibel scale for consistent comparison with a reference engine sound profile. For example, the processing system may calibrate the captured audio to a common intensity scale, accounting for variations in microphone sensitivity and placement. This normalization may ensure that sound comparisons are made on a level playing field, regardless of the specific recording conditions or equipment used.

In block 1232, the processing system may segment the sound data into discrete frequency bands to isolate engine-specific harmonic patterns. For example, the processing system may apply Fourier transform techniques to break down the complex engine sound into its constituent frequencies. This segmentation may allow for more detailed analysis of specific engine components or systems that may be exhibiting unusual acoustic signatures.

In block 1234, the processing system may apply a recurrent neural network (RNN) or transformer to detect sequential sound variations indicative of progressive mechanical degradation. For example, the processing system may use long short-term memory (LSTM) networks to analyze patterns in the engine sound over time, identifying gradual changes that may signal developing issues. This temporal analysis may help predict potential failures before they become critical.

In block 1236, the processing system may dynamically adjust the classification threshold based on environmental factors, including temperature, engine load, and altitude. For example, the processing system may incorporate sensor data on ambient conditions and engine operating parameters to fine-tune the acoustic analysis. This adaptive approach may account for normal variations in engine sound due to external factors, reducing false positives and improving diagnostic accuracy.

The hybrid AI processing pipeline that combines LXMs, XR, and sensor fusion may enhance the overall diagnostic and recommendation process. For example, the processing system may use LXMs to interpret the acoustic analysis results and generate natural language explanations of detected issues. XR capabilities may be integrated to provide visual overlays of engine components corresponding to identified sound anomalies, helping users or mechanics locate potential problem areas. Sensor fusion techniques may combine the sound data with other vehicle telemetry, such as vibration patterns or exhaust emissions, to provide a more comprehensive diagnostic picture.

In addition, the sound-based diagnostics using AI to detect engine anomalies may be further refined through continuous learning. For example, the processing system may update its acoustic models based on feedback from mechanics and confirmed diagnoses, improving the system's ability to accurately identify and classify engine issues over time. This adaptive learning approach may allow the diagnostic system to stay current with new engine technologies and emerging failure modes.

Some embodiments may include systems and methods that assist vehicle owners with customizing, maintaining, and selling their vehicles by using AI and XR. Traditionally, vehicle modifications and maintenance depend on professional mechanics, trial-and-error processes, or advice from various online forums, which may vary in reliability. To address these issues, the described systems first collect detailed vehicle information. This information may include engine performance data, historical vehicle records, and details of previous modifications. In addition, the systems may gather data directly from vehicle sensors, images or descriptions provided by the user, manufacturer records, and government databases.

In some embodiments, the systems organize the collected data into structured records and apply AI analysis methods that identify potential improvements or necessary adjustments. For example, the systems may determine whether certain parts require replacement or adjustments, such as engine tuning, may improve vehicle performance. In addition, the systems visually present these recommendations through augmented reality displays on compatible devices, such as smartphones or tablets. The XR displays illustrate suggested upgrades or repairs directly on the user's vehicle, clearly guiding users through each step of the modification or maintenance process.

In addition, some embodiments may support users interested in selling or purchasing vehicles. In these embodiments, the systems verify and validate the accuracy of vehicle conditions. The systems compare actual vehicle states against historical records or stored images to detect inconsistencies or confirm the authenticity of vehicle components. The systems may estimate accurate market values for vehicles based on validated data. Over time, the systems refine recommendations, marketplace evaluations, and pricing guidance by continuously learning from previous user experiences, community feedback, and professional mechanic input. These improvements help make the entire process of vehicle customization, maintenance, and sales more transparent, efficient, and reliable.

In some embodiments, the processing system may generate a modified-vehicle valuation metric for a vehicle having one or more installed or planned modifications. The modified-vehicle valuation metric may be based on a base vehicle value obtained from one or more external valuation sources and a modification-specific adjustment generated from structured vehicle and modification data maintained within the platform. By way of example, the modification-specific adjustment may be based on one or more of measured or predicted performance impact, verified part value, depreciation of installed components, brand quality, verified versus unverified installation status, do-it-yourself versus professional installation, documented business collaboration records, user-uploaded installation documents, reliability history, community popularity, community trust, and compatibility or fitment confidence. The processing system may thereby quantify value contributed by modifications in a more structured manner than systems that treat modifications as having no value or only anecdotal value.

In some embodiments, the processing system may generate a vehicle-specific modified-vehicle score and may further generate a broader modified-vehicle price index derived from aggregated transaction data, valuation outcomes, community feedback, and verified build data across multiple vehicles. For example, the processing system may generate a score indicating whether a modified vehicle is under-valued, fairly valued, or over-valued relative to comparable modified vehicles having similar platforms, build quality, and performance characteristics. The score or index may be presented to users, businesses, dealers, wholesalers, or marketplace participants as valuation guidance during listing, offer generation, negotiation, or transaction review. In this manner, the processing system may create a structured market framework for modified vehicles using validated modification records, verified installation provenance, and crowd-informed performance and popularity signals.

Some embodiments may include processing systems and computing devices that generate vehicle modification recommendations based on user preferences, performance goals, vehicle characteristics, and related factors or conditions. Some embodiments may include a processing system that receives user-provided data and industry data, analyzes this combined dataset with AI, and produces personalized modification recommendations. The recommendations may include information structures that indicate projected performance improvements, safety impacts, or compatibility constraints. Some embodiments may include a processing system that refines recommendations over time by integrating user feedback and outcomes observed from completed modifications.

Some embodiments may include a processing system that recommends modifications by analyzing real-time vehicle data. The processing system may collect sensor measurements from onboard diagnostic tools and integrate real-time vehicle data with vehicle specifications. The processing system may generate vehicle performance profiles and identify modifications that address performance issues or user-defined goals. The processing system may present these recommendations with projected impacts to assist vehicle owners in making informed decisions.

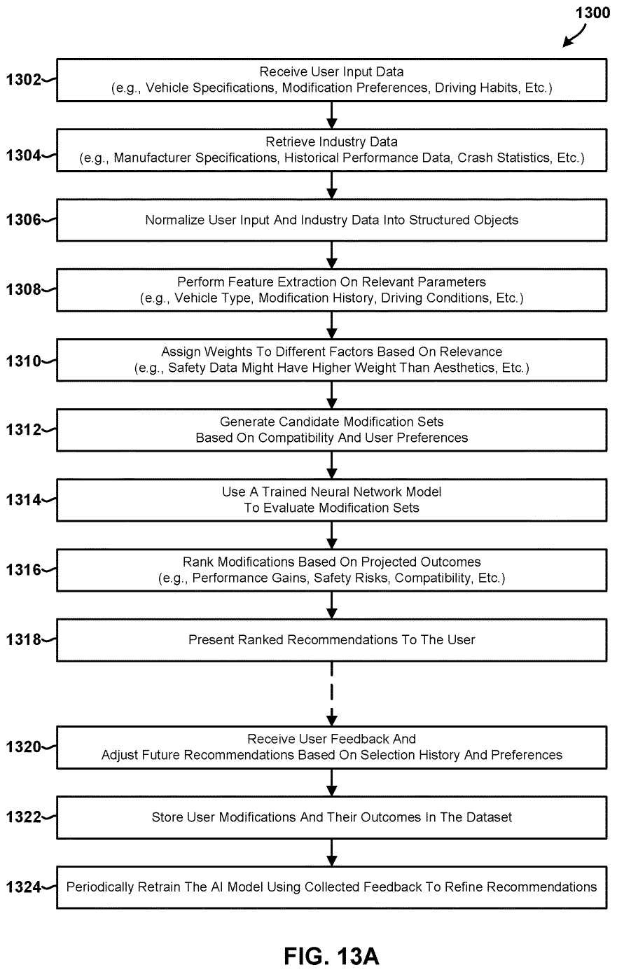

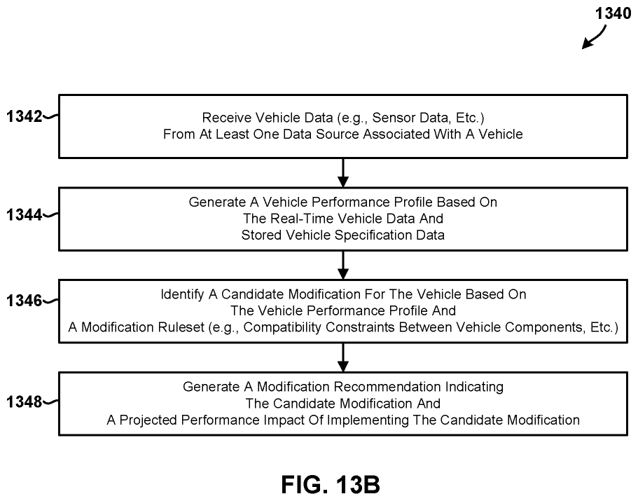

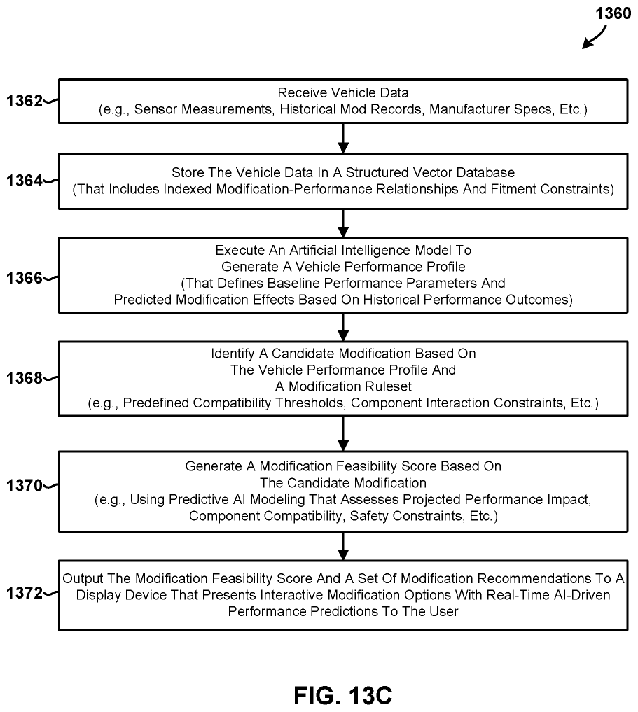

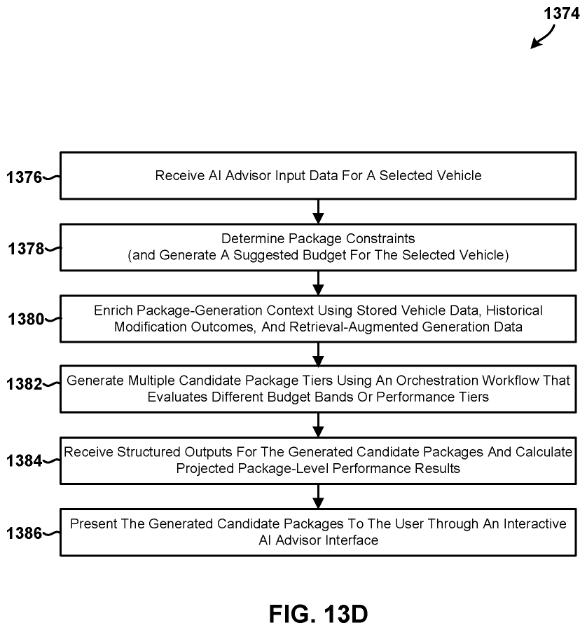

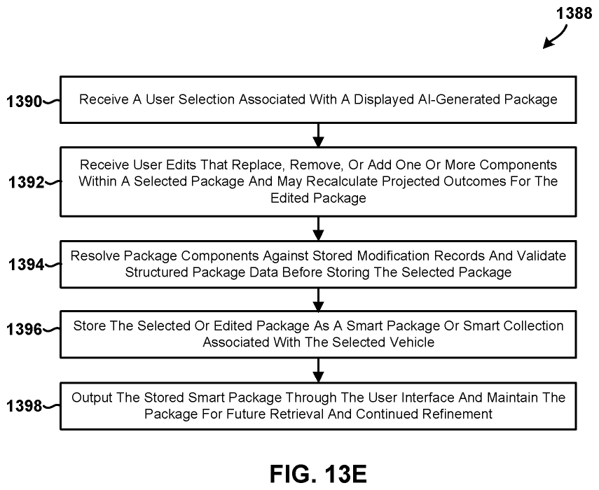

FIG. 13A is a process flow diagram illustrating a method 1300 for generating vehicle modification recommendations in some embodiments. Method 1300 may be performed by a processing system implemented in one or more computing devices described in this application. The processing system may include hardware components that perform the disclosed methods.

In block 1302, the processing system may receive user input data or obtain data about the vehicle and the user's intended modifications. Collected data may include the vehicle's make, model, year, current modifications, specifications, performance measurements, modification preferences, or driving habits. The processing system may use this data to establish a baseline for generating modification recommendations that reflect user preferences and specific vehicle attributes. For example, a user who owns a 2018 Ford Mustang and wants increased horsepower for track performance may enter details about an upgraded exhaust system and performance air intake. The processing system may use that baseline to suggest additional modifications, such as a turbocharger or ECU tuning, that suit the user's performance objectives.

In block 1304, the processing system may access external industry databases to retrieve supplemental vehicle information. The retrieved data may include original equipment manufacturer (OEM) specifications, historical performance results, aftermarket parts compatibility data, or crash statistics. The processing system may reference this external data to confirm that recommended modifications align with compatibility requirements, safety considerations, and user performance targets. For example, a user seeking to install a high-performance brake kit may benefit from checks against manufacturer guidelines and historical data to confirm compatibility. The system may also retrieve safety records for the brake kit across varied driving conditions.

In block 1306, the processing system may transform user input and industry data into a structured format. This transformation may standardize data from diverse sources and improve the accuracy of subsequent analysis. For example, manufacturer specifications may follow one format, while user-uploaded details may follow another. The processing system may convert both into a common format and compare a user's modification preferences against industry standards to generate accurate recommendations.

In block 1308, the processing system may perform feature extraction on the standardized data. The extracted features may include vehicle type, modification history, engine specifications, suspension type, or typical driving conditions. The processing system may rely on these features to guide AI-based analysis of vehicle performance and modification effectiveness. For example, a Jeep Wrangler owner who drives off-road may benefit from skid plates and all-terrain tires, while a Honda Civic driver in city environments may prefer a cold air intake or sport suspension.

In block 1310, the processing system may assign relevance weights to extracted features. The weights may place greater emphasis on safety factors than aesthetic considerations. This weighting may guide the processing system toward balanced modifications that reflect user preferences, performance enhancements, and safety considerations. A user seeking higher top speed may see an engine tuning recommendation, yet the processing system may highlight brake upgrades if the current brakes remain inadequate for higher speeds.

In block 1312, the processing system may generate candidate modification sets that reflect user preferences and compatibility constraints. These sets may include parts or tuning adjustments known to offer compatible performance gains. The processing system may later evaluate each set. A user who seeks better acceleration may receive multiple sets, such as lightweight wheels, high-performance tires, and an upgraded exhaust system. The user may also see options in different price ranges.

In some embodiments, generation of the candidate modification sets in block 1312 may include first invoking the document-based retrieval process described with reference to FIG. 3B. For example, the processing system may retrieve top-ranked vehicle-build documents associated with vehicles matching the user's year, make, model, trim, engine, drivetrain, and objective, and may use the retrieved build documents as contextual input when generating grouped modification packages. In some embodiments, the processing system may generate a first grouped modification package optimized according to platform-defined objectives and a second grouped modification package weighted according to popularity or trust metrics derived from the retrieved vehicle-build documents. The processing system may then present one or both grouped modification packages together with projected performance impacts, confidence values, or explanations indicating that one or more modifications recur across similar vehicles in the retrieved build documents.

In block 1314, the processing system may apply a trained neural network model to evaluate the candidate sets. The model may assess projected impacts on vehicle performance, user satisfaction, and safety factors. This step may yield quantitative results that indicate suitability. A user who considers an engine remap alongside an upgraded turbocharger may benefit from an AI-based analysis of past installations to estimate horsepower gains and highlight the need for a stronger cooling system if necessary.

In block 1316, the processing system may rank the evaluated candidate sets according to projected outcomes. The ranking may consider horsepower increases, fuel efficiency changes, compatibility with existing components, or vehicle handling impacts. The resulting ranked list may help users identify desirable modifications. A user who wants improved acceleration may see a suggestion to pursue a lightweight flywheel and high-performance tires before cosmetic changes.

In block 1318, the processing system may present ranked recommendations to the user as multiple grouped modification packages associated with different cost and performance levels. For example, the processing system may present a lower-cost package, a target-budget package, and a higher-performance package, each including a grouped parts list, projected performance metrics, estimated costs, and explanatory trade-offs. In some embodiments, the user interface may present predicted horsepower and torque values, graphical performance curves relative to a stock baseline or current vehicle state, and a confidence indicator associated with each package. This grouped presentation may allow users to compare complete upgrade paths rather than reviewing isolated components individually.

In block 1320, the processing system may collect user feedback on displayed recommendations. The processing system may track which modifications users accept or decline. The processing system may integrate feedback into subsequent recommendation processes to enhance accuracy and relevance. A user who consistently selects aesthetic changes instead of performance upgrades may prompt the system to place greater emphasis on cosmetic modifications in future recommendations.

In block 1322, the processing system may document implemented modifications and actual performance outcomes. This documentation may capture real-world impacts of chosen modifications. The processing system may incorporate these outcomes into a growing dataset that refines future recommendations. Multiple users who report that a certain coilover brand improves handling on a given model may elevate that coilover brand in future recommendations for similar vehicles.

In block 1324, the processing system may periodically retrain the neural network with updated data reflecting new market offerings or changing user tastes. This retraining may sustain recommendation accuracy. As new parts enter the market or older trends fade, the system may adjust its recommendations to reflect feedback and preserve relevance.

Some embodiments may include processing systems that recommend vehicle modifications by conducting comprehensive data analysis. The processing system may collect sensor measurements, historical modification records, or manufacturer-provided specifications and organize them in a structured database. The processing system may also use AI-based models to create performance profiles from the data. The processing system may evaluate candidate modifications against compatibility or safety considerations and present clear, data-backed findings. In some embodiments, the processing system may apply advanced AI techniques, such as RAG, to further increase the relevance and accuracy of recommendations.

FIG. 13B is a process flow diagram illustrating another method 1340 for generating vehicle modification recommendations based on comprehensive data analysis in some embodiments. Method 1340 may be performed by a processing system in one or more computing devices disclosed in this application. The term “processing system” may reference hardware components that perform these methods.

In block 1342, the processing system may collect real-time vehicle data from at least one data source. The data may include sensor measurements from onboard diagnostic tools and may capture engine performance, fuel consumption, or emissions. Real-time data may provide insight into current operational conditions. A driver who installs a high-performance cold air intake may rely on sensor data to reveal airflow, fuel consumption, or engine efficiency changes. The processing system may evaluate whether the intake delivers intended gains or if an ECU remap may augment results.

In block 1344, the processing system may merge real-time sensor data with previously stored vehicle specifications to form a comprehensive performance profile. This profile may highlight areas for improvement. A driver who upgrades the exhaust system may compare airflow and fuel delivery metrics with factory specifications. If airflow has increased without a proportional fuel adjustment, the processing system may suggest a larger fuel injector or an ECU remap.

In block 1346, the processing system may identify candidate modifications by applying a modification ruleset to the performance profile. The ruleset may define compatibility constraints and performance thresholds. If a driver installs a turbocharger without upgrading supporting components, the processing system may recommend a larger intercooler or high-flow injectors to maintain safe operation. By checking existing upgrades, the system may propose additional modifications that boost performance while retaining reliability.

In block 1348, the processing system may generate recommendations derived from these candidate modifications. Each recommendation may indicate projected improvements, compatibility, and potential trade-offs. A driver considering a high-performance suspension may see an estimate of improved handling and braking, along with comfort trade-offs or potential complementary upgrades (such as performance tires).

Some embodiments may include processing systems that offer vehicle modification suggestions based on large data sets. A structured vector database may store sensor readings, modification histories, and OEM specifications. AI models may analyze this data to form detailed performance profiles, while the processing system evaluates compatibility, safety, and performance impacts. The system may assign a feasibility score to each proposed modification. The system may present interactive recommendations that list expected outcomes and help users compare options. The system may also use retrieval-augmented generation methods for contextually accurate suggestions.

FIG. 13C illustrates another method 1360 for generating AI-based vehicle modification recommendations in some embodiments. Method 1360 may occur within one or more computing devices in a processing system that performs the disclosed operations.

In block 1362, the processing system may collect comprehensive vehicle data from multiple sources, such as sensor readings, historical modification records, and OEM specifications. This data may form the basis for accurate analyses. A driver who seeks improved suspension handling may prompt the system to gather real-time suspension data, confirm any preexisting aftermarket parts, and reference baseline manufacturer settings to generate well-informed suggestions.

In some embodiments, the processing system may continuously monitor suspension response using accelerometers, ride height measures, or wheel alignment angles. The processing system may compare the data with an ideal performance profile derived from manufacturer specs and past user modifications. Trends in modification records may reveal which suspension setups have produced measurable improvements for similar vehicles.

In block 1364, the processing system may store vehicle data in a structured vector database that indexes relationships between modifications and outcomes. This storage format may accelerate retrieval, data comparison, and analysis. A user who requests improved fuel efficiency may benefit from an instant search for recorded improvements linked to upgrades such as better fuel injectors or aerodynamic changes. The system may retrieve proven outcomes instead of relying on theory.

In some embodiments, the system may save modification data as multi-dimensional vectors reflecting parameters such as horsepower, torque, and emissions. A similarity search may find relevant matches when a user inquires about efficiency upgrades, while metadata indexing may filter results by engine size or drivetrain type.

In block 1366, the processing system may execute an AI model to form detailed performance profiles. The AI model may incorporate vehicle specifications, historical modification results, and real-time sensor measurements. These profiles may assist with predicting modification effectiveness. A user who weighs adding a turbocharger may review how similar vehicles fared after adding the same turbo. The system may forecast likely horsepower gains or supporting part requirements.

In some embodiments, a combination of supervised and reinforcement learning may drive these predictions. A supervised model may correlate engine specs or turbo size with power gains, while reinforcement learning may refine predictions based on feedback from users who performed these upgrades under varied conditions.

In block 1368, the processing system may identify candidate modifications by referencing performance profiles and predefined rulesets. These rulesets may define constraints, safety considerations, and part compatibility. If an exhaust system restricts airflow, the system may suggest a higher-flow exhaust. If the user has installed a particular catalytic converter, the system may confirm that the proposed exhaust remains compatible.

In some embodiments, the system may rely on a constraint-based optimization model that cross-checks manufacturer tolerances and aftermarket modification standards to prevent unexpected performance losses or mechanical issues.

In block 1370, the processing system may calculate a feasibility score for each candidate. The score may reflect projected performance gains, compatibility, or safety considerations. A user who considers larger wheels to improve traction may see a feasibility score that factors in suspension type, steering geometry, and wheel well space. The system may note potential clearance issues or supporting modifications.

In some embodiments, the processing system may rely on a weighted scoring algorithm that ranks modifications by overall impact on acceleration, braking efficiency, or ride stability. The final feasibility score may appear in the user interface, highlighting trade-offs or any additional components that assist with compatibility.

In block 1372, the processing system may output feasibility scores and grouped package recommendations through an interactive AI advisor interface. The interface may present multiple candidate packages, predicted performance outputs, projected costs, and package confidence indicators, and may allow the user to bookmark packages, review prior package-generation history, or edit a selected package by swapping one or more parts or brands. In response to user edits, the processing system may recalculate projected performance metrics, update package costs, and revise displayed trade-offs in real time. In some embodiments, the user may further add a selected package to a vehicle record as a structured smart package or smart collection for later retrieval, sharing, purchasing, or installation planning.

In some embodiments, the interactive display may incorporate simulation models that depict predicted outcomes for selected modifications. A user weighing an ECU remap may see a torque curve or a 0-60 mph time estimate. The system may also filter by cost, performance improvements, or reliability ratings to produce a tailored plan.

In some embodiments, the processing system may incorporate RAG models and vector database capabilities to respond to user queries about modifications. The processing system may convert the user's query into a vector representation and perform a similarity search in the vector database. The retrieved data may feed into an LXM, producing context-sensitive and accurate recommendations. This retrieval-based approach may improve the precision and relevance of outputs to deliver robust modification recommendations.

In some embodiments, the processing system may implement an AI advisor configured to generate multiple grouped modification packages for a specific vehicle based on a selected driving purpose, a target budget, currently installed vehicle modifications, and user-selected performance priorities. Unlike systems that recommend isolated parts one at a time, the AI advisor may generate complete and internally compatible package sets at multiple spend levels and may estimate projected performance outcomes relative to a baseline vehicle configuration. In addition, the AI advisor may present structured package results to the user for comparison, editing, bookmarking, and association with a vehicle record. The AI advisor may further generate a package confidence indicator derived from credibility values assigned to information sources, fitment data, historical outcomes, community-validated records, and/or model confidence measures used in generating each package.

In some embodiments, an AI-generated package may be stored as a “smart package” or “smart collection” associated with a user vehicle profile. A smart package or smart collection may include a grouped set of modification records, brand identifiers, part identifiers, cost information, projected performance metrics, and metadata indicating whether the package has been bookmarked, planned, recommended, added to a vehicle history, or fully installed on the vehicle. This structured package representation may support later retrieval, editing, comparison, sharing, visualization, purchasing, or further AI-driven analysis.

FIG. 13D is a process flow diagram illustrating a method 1374 for generating multiple AI-orchestrated vehicle modification packages in some embodiments. Method 1374 may be performed by a processing system implemented in one or more computing devices described in this application. The processing system may include hardware components that perform the disclosed methods.

In block 1376, the processing system may receive AI advisor input data for a selected vehicle. The received input data may include the vehicle's year, make, model, trim, engine configuration, currently installed modifications, and one or more user-selected planning inputs such as driving purpose, budget, desired performance outcome, or user-defined weighting preferences. For example, the user may indicate that the vehicle is intended primarily for street use, track use, towing, or off-road use. In addition, the user may specify that acceleration, braking, suspension performance, handling, reliability, or horsepower-per-dollar should be prioritized more heavily than other objectives. This input collection may provide a package-planning baseline more specific than a generic part search.

In block 1378, the processing system may determine package constraints and, in some embodiments, generate a suggested budget for the selected vehicle. For example, the processing system may analyze the vehicle's estimated market value, previous spending patterns associated with similar vehicles, prior modification histories, or observed spending ranges for comparable user vehicles to determine a suggested budget or recommended budget band. In addition, the processing system may apply rule-based or AI-generated constraints that exclude unsuitable parts categories, define preferred performance ranges, or enforce initial weighting criteria. This operation may improve package relevance before candidate package generation begins.

In block 1380, the processing system may enrich package-generation context using stored vehicle data, historical modification outcomes, and retrieval-augmented generation data. For example, the processing system may access structured vehicle records, historical build results, community-validated modification outcomes, or records associated with similar vehicles sharing the same year, make, model, trim, engine, or installed component profile. In some embodiments, the processing system may retrieve popular or highly rated combinations of modifications associated with similar vehicles and include those retrieved records as contextual input for downstream package generation. This enriched context may allow the AI advisor to generate recommendations based not only on static compatibility data, but also on prior real-world build outcomes and community-observed part combinations.

In block 1382, the processing system may generate multiple candidate package tiers using an orchestration workflow that evaluates different budget bands or performance tiers. For example, the processing system may launch multiple package-generation operations that execute sequentially or in parallel to generate a lower-cost package, a target-budget package, and a higher-performance package. Each package-generation operation may receive a structured schema that specifies required outputs, including candidate parts, package cost, predicted performance effects, explanatory rationale, and compatibility constraints. In some embodiments, the package-generation operations may use one or more LXMs, neural network models, recommender models, or RAG-enhanced AI modules to produce grouped modification packages tailored to the selected vehicle and user objectives.

In block 1384, the processing system may receive structured outputs for the generated candidate packages and calculate projected package-level performance results. For example, the processing system may combine the selected vehicle's currently installed modifications with the candidate package components and estimate predicted horsepower, torque, throttle response, suspension behavior, braking response, reliability impact, or other performance outcomes. In some embodiments, the processing system may generate package-level performance curves relative to a stock baseline or current-vehicle baseline. In addition, the processing system may derive secondary performance metrics, including torque estimates, from predicted horsepower and vehicle-specific operating parameters. The processing system may also retrieve images associated with package components from internal records, previously stored vehicle records, or external image sources to construct structured package presentation objects.

In block 1386, the processing system may present the generated candidate packages to the user through an interactive AI advisor interface. For example, the processing system may display multiple grouped packages, each including a parts list, predicted performance gains, projected costs, explanatory summaries, and a package confidence indicator. In some embodiments, the package confidence indicator may be derived by assigning credibility values to the sources used during package generation and aggregating those credibility values into a package-level confidence score. The interface may further provide controls for bookmarking packages, viewing prior package-generation history, comparing package tiers, or selecting a package for further editing or storage.

FIG. 13E is a process flow diagram illustrating a method 1388 for editing, validating, and storing an AI-generated vehicle modification package in some embodiments. Method 1388 may be performed by a processing system implemented in one or more computing devices described in this application.

In block 1390, the processing system may receive a user selection associated with a displayed AI-generated package. For example, the user may bookmark a package, retrieve a previously generated package from a package history, designate one package as preferred, or request that the package be added to the selected vehicle. In some embodiments, the user may request further package refinement rather than immediate acceptance of the package as generated.

In block 1392, the processing system may receive user edits that replace, remove, or add one or more components within a selected package and may recalculate projected outcomes for the edited package. For example, the user may swap one brand of intake system for another, replace a recommended suspension kit with a different suspension kit, or remove one recommended component while keeping the remainder of the package unchanged. In response, the processing system may re-evaluate compatibility, recalculate cost totals, and update projected performance metrics and package trade-offs. This iterative package-editing process may allow users to adapt AI-generated packages without restarting package generation from the beginning.

In block 1394, the processing system may resolve package components against stored modification records and validate structured package data before storing the selected package. For example, the processing system may map package components to known brand records, known part records, or existing modification records associated with a modification database. In some embodiments, when a component does not map cleanly to an existing record, the processing system may create a provisional or flagged record for later validation while still preserving the selected package structure. This validation and record-resolution process may improve package consistency and support future retrieval or purchasing operations.

In block 1396, the processing system may store the selected or edited package as a smart package or smart collection associated with the selected vehicle. For example, the processing system may create a grouped vehicle record containing the package's components, projected performance outputs, confidence data, and package metadata indicating whether the package is planned, bookmarked, recommended, installed, or partially installed. In some embodiments, the stored package may update a vehicle history, modification history, or predicted performance profile associated with the selected vehicle. The stored package may also be used later to drive marketplace presentation, professional installation recommendations, community sharing, or future refinement of recommendations.

In block 1398, the processing system may output the stored smart package via the user interface and retain it for future retrieval and continued refinement. For example, the processing system may display the package within a vehicle garage view, a modification history view, or a package comparison interface. In addition, the processing system may allow users to revisit the package later, compare it with later-generated packages, share it with other users or businesses, or convert the stored package into a purchase workflow, installation workflow, or updated vehicle specification profile. Over time, interactions with stored smart packages may yield additional feedback signals that improve the accuracy of future package generation and the quality of user-specific recommendations.

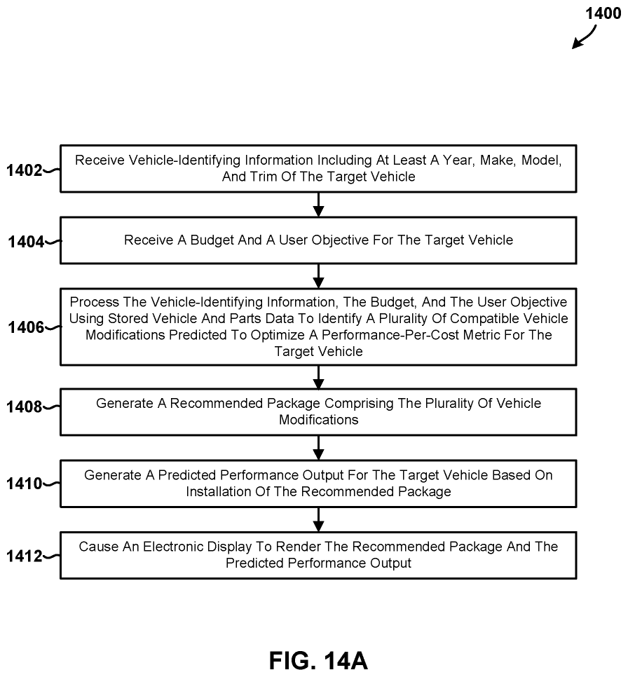

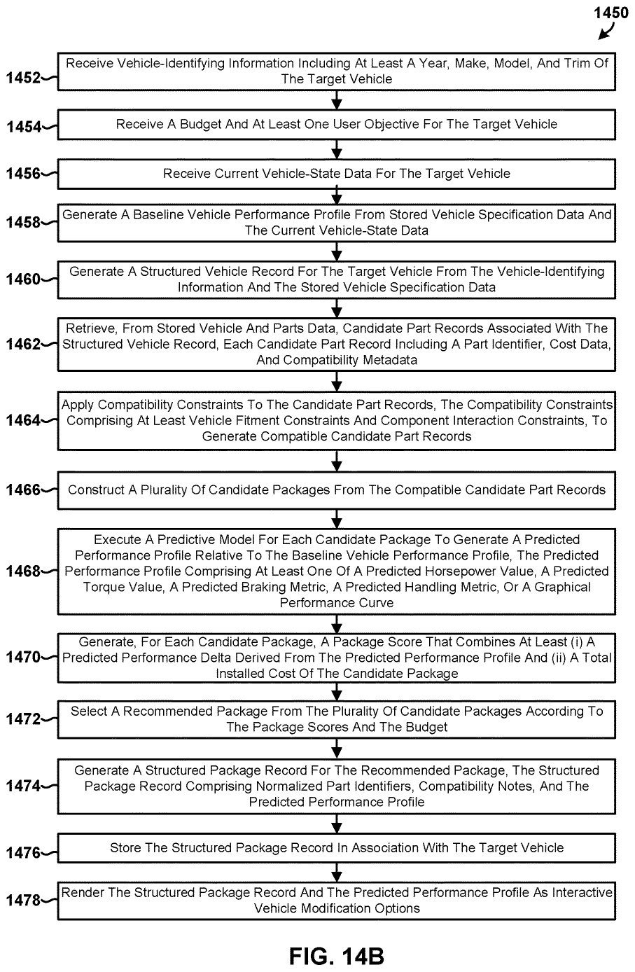

FIG. 14A is a process flow diagram illustrating a method 1400 for generating a vehicle modification recommendation for a target vehicle in accordance with some embodiments. Method 1400 may be performed by a processing system implemented in one or more computing devices described in this application. In some embodiments, the processing system may include one or more application servers, AI inference engines, vector-search services, rules engines, database services, and client devices operating together to receive vehicle data, evaluate compatible modifications, generate package outputs, and store vehicle-linked package records.

In block 1402, the processing system may receive vehicle-identifying information including at least a year, make, model, and trim of the target vehicle. For example, the processing system may receive the vehicle-identifying information through a mobile application, web interface, dealer or shop portal, application programming interface (API), connected-vehicle interface, or user profile stored in a virtual garage, and may normalize the received information into a canonical vehicle record by resolving synonyms, decoding a VIN, resolving a trim package identifier, and retrieving associated engine, drivetrain, body-style, generation, and emissions-package attributes from a vehicle specifications database. Accurate vehicle identification narrows the fitment universe before compatibility scoring and package generation. In some embodiments, the vehicle-identifying information may further include a VIN, engine code, transmission type, drivetrain type, body style, mileage, region, emissions configuration, wheelbase, axle ratio, tire size, wheel size, or one or more previously installed modifications.

In block 1404, the processing system may receive a budget and a user objective for the target vehicle. For example, the processing system may receive a numeric budget value, a budget range, or a budget ceiling through a graphical user interface, natural-language input, voice input, or a stored preference profile, and may parse the user objective into one or more machine-readable objective fields such as horsepower increase, torque increase, off-road capability, towing capacity, braking improvement, ride comfort, appearance, reliability, fuel economy, track performance, or daily-driver usability. Representing the budget and objective in structured fields may allow the processing system to constrain candidate packages and optimize recommendations against the priorities selected for the target vehicle. In some embodiments, the processing system may convert currency values, apply taxes or estimated labor charges, separate parts budgets from installed budgets, and map free-text user intent to standardized objective tags and objective weights.

In some embodiments, the method may further include receiving currently installed vehicle modifications for the target vehicle, receiving real-time vehicle data for the target vehicle, receiving a driving purpose and one or more priority weights for the user objective, and generating a current vehicle state from the currently installed vehicle modifications and the real-time vehicle data. For example, the processing system may retrieve a modification history from a user garage, parse service invoices, scan prior part records, or read installed-part metadata already associated with the target vehicle to determine currently installed components, may receive real-time vehicle data from an OBD-II adapter, CAN bus gateway, telematics unit, dyno session, GPS source, accelerometer, or mobile-device sensor, and may fuse the received data into a current vehicle state object that identifies baseline operating conditions, current constraints, fault states, and presently installed parts. The current vehicle state may prevent the system from recommending duplicate or incompatible components and may allow the recommendation logic to account for the vehicle as it actually exists rather than as a stock configuration. In some embodiments, the driving purpose may include drag racing, circuit racing, towing, daily commuting, overlanding, rock crawling, street appearance, or mixed use, and the priority weights may emphasize one or more of acceleration, braking, suspension response, reliability, emissions compliance, noise level, cost, or ease of installation.

In some embodiments, the method may further include generating a request embedding from at least a portion of the vehicle-identifying information, the budget, and the user objective, retrieving a candidate set of vehicle-build documents using semantic similarity between the request embedding and respective stored vehicle-build-document embeddings, ranking the candidate set of vehicle-build documents according to semantic relevance and one or more popularity, quality, or trust scores, and identifying at least part of compatible vehicle modifications from the ranked candidate set of vehicle-build documents. For example, the processing system may concatenate tokens representing the year, make, model, trim, budget band, objective tags, and optionally installed modifications into an input sequence, encode the input sequence with an embedding model to generate a dense vector, execute a nearest-neighbor search against a vector database storing embeddings for prior vehicle builds, and rerank retrieved documents using engagement metrics, verified fitment events, source recency, shop or manufacturer trust levels, and recorded outcome quality. Using ranked vehicle-build documents allows the processing system to ground package generation in modification combinations that have already been observed on similar vehicles. In some embodiments, a vehicle-build document may include a structured or semi-structured record containing one or more part identifiers, brand identifiers, installation states, performance outcomes, budget data, fitment metadata, user feedback, installer provenance, media references, and associated confidence values.

In some embodiments, the method may further include determining a plurality of budget bands from the budget, generating a plurality of candidate packages corresponding to budget bands, associating a respective plurality of compatible vehicle modifications with each candidate package, ranking candidate packages according to a respective predicted value of the performance-per-cost metric, and selecting the recommended package from candidate packages according to the ranking. For example, the processing system may create lower, target, and higher budget bands or other dynamic budget partitions, allocate candidate parts within each band using compatibility and dependency rules, estimate installed cost for each candidate package by aggregating part prices, shipping, taxes, and labor, and compute a predicted performance-per-cost value for each package before selecting one or more recommended packages for output. Evaluating multiple budget bands enables the system to present packages that remain useful even when the user later increases or decreases the allowed spend.

In some embodiments, the method may further include retrieving vehicle value data associated with the target vehicle and historical spending data associated with vehicles matching the vehicle-identifying information at least in part, generating a suggested budget range for the target vehicle from the vehicle value data and the historical spending data, and updating budget bands from the suggested budget range before generating candidate packages. For example, the processing system may query one or more valuation databases, auction datasets, dealership feeds, or internal sales records to obtain market value information for the target vehicle, may retrieve historical modification spend distributions for similar vehicles, and may apply a budget model that outputs one or more recommended spend ranges based on vehicle value, user segment, modification category, and historical adoption patterns. In some embodiments, the suggested budget range may be presented as a default setting or may automatically replace an initially entered budget when the user authorizes guided budget generation.

In block 1406, the processing system may process the vehicle-identifying information, the budget, and the user objective using stored vehicle and parts data to identify a plurality of compatible vehicle modifications predicted to optimize a performance-per-cost metric for the target vehicle. In some embodiments, in block 1406, the processing system may process the vehicle-identifying information, the budget, and the user objective using stored vehicle and parts data to identify, for the target vehicle, a plurality of vehicle modifications that are compatible with the target vehicle and with one another and that are predicted, in combination, to optimize a performance-per-cost metric for the target vehicle. For example, the processing system may query one or more fitment tables, parts catalogs, brand-and-part validation databases, price databases, vehicle-build documents, and historical outcome datasets, may eliminate parts that fail fitment rules, emissions constraints, dependency rules, or safety thresholds, may score remaining parts using one or more machine-learning models together with rules-based constraints, and may solve an optimization problem that maximizes a weighted performance-per-cost metric subject to budget, compatibility, safety, emissions, packaging, and installation constraints. This processing may reduce a large aftermarket search space to a smaller set of technically compatible and economically efficient modification candidates, thereby improving the performance and responsiveness of the device and reducing latency and resource consumption (e.g., bandwidth, processing, memory, etc.). In some embodiments, the performance-per-cost metric may be a weighted ratio, composite score, or utility function that combines predicted horsepower, torque, braking, handling, ride quality, reliability, appearance, fuel economy, resale impact, or other predicted performance effects with part cost, labor cost, installation complexity, maintenance cost, warranty impact, or lifecycle cost.

In block 1408, the processing system may generate a recommended package including vehicle modifications. For example, the processing system may assemble the selected modifications into a package data structure that includes part identifiers, brand identifiers, quantities, dependency relationships, supporting components, estimated labor, install sequence, fitment notes, and aggregated cost data, and may optionally generate more than one package representation such as a base package, an upgraded package, or a staged installation plan. Grouping the modifications into a package allows the user to evaluate interdependent parts as a coordinated build rather than as isolated line items. In some embodiments, the recommended package may include one or more OEM parts, aftermarket parts, software calibrations, fluids, tools, service operations, alignment or tuning steps, or professional-install recommendations.

In some embodiments, the method may further include retrieving structured metadata from a top-ranked subset of the candidate set of vehicle-build documents, formatting the structured metadata as model context, processing the model context with the vehicle-identifying information, the budget, and the user objective to identify a recurring subset of compatible vehicle modifications across the top-ranked subset of the candidate set of vehicle-build documents, generating a package confidence score for the recommended package from source credibility, historical outcome consistency, and community-validated fitment data associated with the recurring subset of compatible vehicle modifications, and causing display of the package confidence score with the recommended package. For example, the processing system may extract from the top-ranked build documents normalized part IDs, brand IDs, install counts, observed performance deltas, failure rates, verified fitment records, installer identities, and user ratings, may encode the extracted fields into a prompt or structured context object provided to a language model or ranking model, and may compute the package confidence score by combining document-level trust weights, recurrence frequency of the part combination, consistency of observed outcomes, and confirmed fitment events for similar vehicles. The package confidence score may help distinguish a package supported by repeatable evidence from a package based only on sparse or conflicting source data. In some embodiments, the confidence score may be displayed as a numeric score, a percentage, a band, or a graphical indicator and may be accompanied by one or more explanation fields identifying factors that increased or decreased confidence.

In block 1410, the processing system may generate a predicted performance output for the target vehicle based on installation of the recommended package. For example, the processing system may apply one or more predictive models, simulation models, regression models, lookup tables, digital twin models, or physics-informed transforms to the target vehicle record and the selected package to estimate post-installation operating characteristics such as horsepower, torque, acceleration, braking distance, lap time, ride height, fuel economy, towing capacity, exhaust flow, intake flow, cooling margin, wheel clearance, or suspension response, and may encode the resulting predictions as scalar values, ranges, confidence intervals, or graphical curves. The predicted performance output may convert a candidate package from a parts list into an expected vehicle outcome that may be compared against the user's objective. In some embodiments, the predicted performance output may include category-specific warnings, prerequisite upgrades, thermal limits, driveline-stress indicators, calibration requirements, or projected trade-offs between competing objectives.

In some embodiments, the method may further include generating a baseline performance profile for the target vehicle from stored vehicle specification data and the current vehicle state, calculating the predicted performance output relative to the baseline performance profile, generating the predicted performance output to include at least one predicted horsepower value, one predicted torque value, or one graphical performance curve, and causing display of the baseline performance profile together with the predicted performance output. For example, the processing system may combine OEM specification data with real-time sensor measurements, dyno traces, ECU logs, or user-confirmed modification records to generate a baseline torque curve, baseline horsepower value, baseline braking metric, or baseline handling profile, and may then compute delta outputs that quantify projected gains or losses attributable to the recommended package. In some embodiments, the graphical performance curve may include an engine-speed-to-torque plot, engine-speed-to-horsepower plot, boost curve, fuel-efficiency curve, braking-distance curve, or suspension-response plot.

In block 1412, the processing system may cause an electronic display of the computing device to render the vehicle modification package and the predicted performance output to provide users with vehicle-specific, compatibility-constrained, package-level optimization of multiple modifications based on projected performance-per-cost. For example, the processing system may serialize the recommended package, predicted performance output, confidence score, fitment notes, baseline comparison data, and related package metadata into a structured response transmitted to a mobile application, browser client, in-vehicle display, shop dashboard, or XR interface, and the client may render the response as one or more package cards, graphs, tables, warnings, cost summaries, swap controls, or save controls. Presenting the recommended package and predicted performance output together allows the user to review cost, compatibility, and expected results within a single decision interface. In some embodiments, the display may further include links to supporting sources, alternative packages, installation guidance, financing options, marketplace listings, supplier inventory indicators, or service-provider recommendations.

In some embodiments, the method may further include receiving an edit input that replaces, removes, or adds at least one vehicle modification in the recommended package, generating an edited recommended package from the edit input, resolving each vehicle modification in the edited recommended package against the stored vehicle and parts data, recalculating the performance-per-cost metric and the predicted performance output for the edited recommended package, and causing display of the edited recommended package together with the recalculated predicted performance output. For example, the processing system may receive a user selection that swaps one brake kit for another, removes a tune, adds supporting fuel components, or substitutes one brand for a different brand, may map the edited line items to canonical part records in a part database, may re-run compatibility checks and dependency checks on the edited package, and may then execute the package ranking and prediction pipeline again to produce updated cost and performance outputs. In some embodiments, the edit input may be received through drag-and-drop controls, package comparison controls, natural-language editing commands, or shop-assisted editing workflows.

In some embodiments, the method may further include storing the edited recommended package as a smart package associated with the target vehicle, storing package metadata for the smart package, storing in the package metadata at least one planned state, at least one installed state, or the recalculated predicted performance output, receiving post-installation outcome data for the smart package, and updating the smart package and the stored vehicle and parts data using the post-installation outcome data. For example, the processing system may assign a package identifier to the edited recommended package, store the package in association with a vehicle record and user account, save metadata that identifies selected part IDs, quantities, pricing, creation time, revision history, predicted outputs, install status, and supporting documents, and later ingest post-installation outcome data from user confirmations, invoices, shop records, dyno charts, telematics feeds, sensor logs, images, or user reviews to update the package record and improve future fitment and performance predictions. Storing the smart package with outcome feedback allows the system to learn from completed builds and to treat the package as a reusable vehicle-linked build object in later recommendation, marketplace, and garage workflows.

The embodiments (e.g., method 1400, etc.) may provide a number of technical advantages, implementation effects, improved functionalities, performance improvements for the computing device, and additional functionalities. Unlike conventional solutions that merely collect, analyze, or present automotive information, the processing system may generate and maintain synchronized vehicle-state records, compatibility-filtered part records, structured package records, and feedback-updated performance data that may be used in subsequent automated package-selection, validation, storage, and update operations for the target vehicle. By reducing incompatible candidate evaluations, narrowing the computational search space to technically relevant modification sets, and preserving persistent machine-readable build states that drive later processing by the device, the embodiments improve the performance, accuracy, and practical functionality of the computing device in a vehicle-specific technical workflow.

The embodiments (e.g., method 1400, etc.) may improve computer-assisted vehicle build planning by transforming heterogeneous automotive inputs, including year, make, model, and trim data, vehicle specification data, installed-part data, onboard diagnostic data, aftermarket fitment data, pricing data, and historical build-outcome data, into interoperable machine-readable records that may be processed together within a package-generation pipeline. Conventional systems frequently treat these inputs as isolated catalogs, forum posts, or static rule tables, which may cause incompatible or incomplete recommendations. By maintaining a synchronized digital representation of the target vehicle and candidate parts, the processing system may reduce computational ambiguity, constrain subsequent package searches to technically relevant options, and generate package outputs that remain tied to the target vehicle's actual configuration.

In some embodiments, the processing system may generate a structured vehicle record for the target vehicle and a plurality of candidate part records that include normalized identifiers, compatibility metadata, cost data, fitment attributes, and dependency relationships. The processing system may apply vehicle fitment constraints and component interaction constraints to remove candidate modifications that conflict with one another or with the target vehicle's mechanical, electrical, emissions, packaging, or supporting-component requirements. The vehicle modification package may thereby represent a vehicle-specific build definition generated from compatibility-filtered machine records rather than a generic ranking of unrelated parts.

In some embodiments, the processing system may receive currently installed vehicle modifications and real-time vehicle data from an onboard diagnostic interface or other vehicle sensors, and may generate a current vehicle state from those inputs. The processing system may merge the current vehicle state with stored vehicle specification data to generate a baseline performance profile for the target vehicle and may calculate predicted performance outputs relative to the baseline performance profile. This may enable package generation and validation to be performed against the actual operating condition of the target vehicle, including presently installed components and measured performance conditions, rather than an assumed stock condition.

In some embodiments, the predicted performance output may include one or more predicted horsepower values, predicted torque values, braking metrics, handling metrics, feasibility values, or graphical performance curves generated from the selected package and the baseline performance profile. The electronic display may render the vehicle modification package together with package-level and part-level technical outputs, fitment notes, tradeoff indicators, and baseline-versus-predicted comparisons, so that the rendered interface functions as an interactive technical output structure for package evaluation, modification, validation, and storage.

In some embodiments, the processing system may generate request embeddings from vehicle-identifying information, budget data, user objective data, and optionally current vehicle state data, and may use the request embeddings to retrieve vehicle-build documents or other automotive records from a structured vector database. The processing system may rank retrieved records using semantic similarity together with fitment quality, popularity, source credibility, or historical outcome data, and may extract normalized part identifiers and associated metadata from top-ranked records for use in package generation. This retrieval architecture may improve the technical relevance of the retrieved automotive records by retrieving build data associated with technically similar vehicles and configurations, thereby reducing incompatible recommendations and improving package confidence.

In some embodiments, the processing system may determine multiple budget bands from an entered budget or a suggested budget range and may generate candidate packages corresponding to different budget bands. For each candidate package, the processing system may aggregate part costs, supporting-component costs, and estimated installation costs, calculate a package score from predicted performance deltas and installed cost, and select a recommended package according to the resulting scores. Constraining package generation to budget-bounded, compatibility-validated candidate sets may reduce the search space for multi-part build generation while preserving vehicle-specific technical constraints.

In some embodiments, the recommended package may be materialized as a structured package record associated with a digital vehicle record or smart package record. The structured package record may include normalized part identifiers, predicted performance outputs, package confidence data, planned-state data, installed-state data, and revision metadata. When an edit input replaces, removes, or adds a vehicle modification, the processing system may resolve the edited package against stored vehicle and parts data, reapply compatibility constraints, regenerate predicted outputs, and update the associated digital vehicle record. The digital vehicle record may thereby preserve a persistent and technically coherent build state across package creation, package editing, installation planning, and later vehicle updates.

In some embodiments, the processing system may receive post-installation outcome data, including sensor logs, dyno data, installer records, invoices, user confirmations, or later vehicle telemetry, and may use the post-installation outcome data to update package metadata, performance profiles, confidence scores, fitment relationships, or candidate part records. This feedback-driven update path may allow the processing system to refine later package generation using confirmed outcomes from previously installed packages and to maintain improved digital relationships between parts, vehicle states, and resulting performance behavior.

In some embodiments, an AI model, language model, or neural-network model may operate within a bounded automotive-modification workflow in which normalized vehicle data, fitment constraints, package metadata, and baseline performance profiles define an available solution space for a specific target vehicle. Outputs of the model may be consumed by later compatibility checking, package scoring, performance prediction, edit validation, and digital record updating operations. The model may thereby function as one component of a larger vehicle-analysis architecture that generates technically actionable package outputs for the target vehicle.

FIG. 14B is a process flow diagram illustrating a method 1450 for generating, evaluating, and storing a vehicle modification package for a target vehicle in some embodiments. Method 1450 may be performed by a processing system implemented in one or more computing devices described in this application. In some embodiments, the processing system may include one or more application servers, recommendation engines, rules engines, vector-search services, predictive-model services, database services, and client devices configured to exchange vehicle data, package data, fitment data, and performance data over one or more wired or wireless networks.

In block 1452, the processing system may receive vehicle-identifying information including at least a year, make, model, and trim of the target vehicle. For example, the processing system may receive the vehicle-identifying information through a user interface, a stored garage record, a VIN decoder, a dealership or shop portal, or an application programming interface (API), and may normalize the received information into a canonical vehicle identity by resolving synonyms, trim ambiguities, platform designations, engine variants, and drivetrain attributes. Accurate vehicle identification may narrow the candidate fitment universe before package construction and may reduce false matches between similar vehicles that differ in engine configuration, emissions configuration, wheelbase, brake package, or other compatibility-relevant parameters. In some embodiments, the vehicle-identifying information may further include a VIN, engine code, body style, transmission type, drivetrain type, region, emissions package, wheel size, axle ratio, or previously installed part identifiers.

In block 1454, the processing system may receive a budget and at least one user objective for the target vehicle, and the user objective may include at least one of acceleration, braking, handling, suspension response, towing capacity, off-road capability, appearance, or fuel economy. For example, the processing system may receive a numeric budget value, a budget range, a budget ceiling, or a natural-language budget instruction through a graphical user interface or API, and may parse the user objective into one or more structured objective fields, objective tags, or objective weights that may be consumed by downstream optimization logic. Representing the budget and the user objective in structured form may allow the processing system to constrain candidate packages according to cost while still optimizing for the outcomes the user values most. In some embodiments, the processing system may also apply currency normalization, estimated tax calculations, estimated shipping calculations, or installed labor estimates before later scoring candidate packages.

In block 1456, the processing system may receive current vehicle-state data for the target vehicle. The current vehicle-state data may include at least one of currently installed vehicle modifications or real-time vehicle sensor data obtained through an onboard diagnostic interface associated with the target vehicle. For example, in block 1456, the processing system may query a user garage, modification history, scanned invoices, or structured part records to identify currently installed modifications, and may communicate with an onboard diagnostic interface, telematics module, CAN bus gateway, OBD-II adapter, or other sensor interface to obtain real-time parameters such as airflow, boost pressure, fuel trims, ignition timing, coolant temperature, brake temperatures, wheel-speed signals, suspension sensor outputs, or similar measurements. This current vehicle-state data may allow the processing system to evaluate the target vehicle as actually configured rather than as a stock vehicle and may prevent recommendation of duplicate, incompatible, or unnecessary modifications. In some embodiments, receiving current vehicle-state data may include generating a current vehicle state from the currently installed vehicle modifications and the real-time vehicle sensor data and storing the current vehicle state in a structured data object linked to the target vehicle.

In block 1458, the processing system may generate a baseline vehicle performance profile from stored vehicle specification data and the current vehicle-state data. For example, the processing system may combine manufacturer specifications, historical baseline performance records, drivetrain parameters, currently installed modification records, and sensor-derived measurements to generate baseline values or curves corresponding to horsepower, torque, braking, handling, acceleration, thermal behavior, or other vehicle characteristics. Generating the baseline vehicle performance profile may allow later package predictions to be expressed as deltas relative to the actual target vehicle, rather than relative only to a generalized stock reference. In some embodiments, the baseline vehicle performance profile may include one or more scalar values, ranges, confidence intervals, lookup-table outputs, or graphical curves.

In block 1460, the processing system may generate a structured vehicle record for the target vehicle from the vehicle-identifying information and the stored vehicle specification data. For example, the processing system may build a normalized record in a relational database, document database, graph database, or other structured storage format, the record including canonical vehicle identifiers, configuration attributes, baseline specifications, current vehicle-state data, installed modification identifiers, and other metadata associated with the target vehicle. The structured vehicle record may provide a consistent internal representation that may be reused across retrieval, fitment, scoring, package generation, marketplace, and garage workflows. In some embodiments, the structured vehicle record may be stored as a machine-readable object such as a JSON object, protocol buffer, or document-oriented record.

In some embodiments, the method may further include generating a request embedding from at least a portion of the structured vehicle record, the budget, and the at least one user objective; retrieving a candidate set of vehicle-build records using semantic similarity between the request embedding and stored vehicle-build-record embeddings in a structured vector database; retrieving, from a top-ranked subset of the candidate set, normalized part identifiers and associated fitment metadata; and supplementing candidate part records with the normalized part identifiers and associated fitment metadata before the constructing. For example, the processing system may encode a structured prompt or feature string derived from the structured vehicle record, budget fields, and objective fields into a dense vector, execute a nearest-neighbor search over vector embeddings corresponding to historical or community-derived vehicle-build records, rerank retrieved build records according to semantic similarity or other relevance metrics, and inject part identifiers and fitment metadata from the top-ranked build records into the candidate part universe before package construction. This retrieval-augmented operation may help ground package generation in records associated with similar vehicles and previously observed combinations of parts.

In block 1462, the processing system may retrieve, from stored vehicle and parts data, candidate part records associated with the structured vehicle record, each candidate part record including a part identifier, cost data, and compatibility metadata. For example, the processing system may query one or more validated part catalogs, brand-and-part knowledge bases, OEM parts databases, aftermarket parts databases, scraped product databases, fitment tables, or internal part repositories using the structured vehicle record to identify candidate parts that could be relevant to the target vehicle and the user objective. Retrieving candidate part records from structured sources may provide a bounded set of potentially relevant parts for subsequent filtering and package construction while preserving traceability to normalized part identifiers, pricing sources, and compatibility constraints. In some embodiments, cost data may include part price, shipping cost, tax estimate, labor estimate, or installed-cost estimate, and compatibility metadata may include fitment notes, generation-level restrictions, required supporting components, emissions restrictions, or installation dependencies.

In block 1464, the processing system may apply compatibility constraints to the candidate part records, the compatibility constraints including at least vehicle fitment constraints and component interaction constraints, to generate compatible candidate part records. For example, the processing system may execute a rules engine or compatibility engine that filters or scores candidate part records according to vehicle fitment rules, engine-specific rules, brake-clearance rules, suspension geometry rules, emissions rules, voltage or ECU compatibility rules, and dependency rules requiring companion parts, tunes, fasteners, fluids, adapters, or supporting hardware. Applying compatibility constraints may reduce the likelihood that the processing system constructs packages that are individually plausible in isolation but incompatible when considered as a system for the target vehicle. In some embodiments, the processing system may also remove parts that violate safety thresholds, duplication constraints, or incompatibility rules associated with already installed modifications.

In block 1466, the processing system may construct a plurality of candidate packages from the compatible candidate part records. For example, the processing system may use combinatorial search, constraint satisfaction, heuristic search, beam search, graph traversal, mixed-integer optimization, or other package-construction logic to assemble compatible subsets of the compatible candidate part records into candidate packages, each candidate package corresponding to a potentially installable modification set for the target vehicle. Constructing multiple candidate packages may allow the processing system to compare alternative approaches for the same vehicle objective rather than forcing a single premature selection from a large part universe.

In some embodiments, the method may further include determining a plurality of budget bands from the budget; generating at least one candidate package for each budget band of budget bands; associating a respective compatible subset of the compatible candidate part records with each candidate package; and ranking the candidate packages according to respective package scores, in which selecting the recommended package includes selecting the recommended package from the ranked candidate packages. For example, the processing system may derive one or more budget bands below, at, or above a target budget, assign candidate part combinations to the budget bands according to estimated installed cost, and maintain separate package populations for different spending levels before later selection. This may allow the processing system to present users with multiple viable package options that remain aligned with the user's financial constraints.

In some embodiments, the method may further include retrieving vehicle value data associated with the target vehicle and historical modification spending data associated with vehicles matching the vehicle-identifying information at least in part; generating a suggested budget range for the target vehicle from the vehicle value data and the historical modification spending data; and updating budget bands from the suggested budget range before generating the at least one candidate package for each budget band. For example, the processing system may query valuation databases, auction databases, resale databases, market-analytics systems, or historical garage records to estimate the value of the target vehicle and observed modification spending for similar vehicles, and may generate a suggested budget range based on those values before re-centering or resizing the budget bands. This may allow the processing system to anchor package generation to realistic or data-driven spending boundaries rather than relying only on an arbitrary user-provided value.

In block 1468, the processing system may execute a predictive model for each candidate package to generate a predicted performance profile relative to the baseline vehicle performance profile, the predicted performance profile including at least one of a predicted horsepower value, a predicted torque value, a predicted braking metric, a predicted handling metric, or a graphical performance curve. For example, the processing system may execute one or more machine learning models, regression models, simulation models, digital twin models, or rules-enhanced predictive models that consume the baseline vehicle performance profile together with the part composition of each candidate package to estimate package-specific deltas in one or more performance dimensions. Generating a predicted performance profile for each candidate package may convert a candidate package from a mere list of parts into an expected vehicle outcome that may be compared directly against the user objective and cost constraints. In some embodiments, the predicted performance profile may include scalar values, ranges, confidence intervals, torque curves, horsepower curves, braking-distance estimates, handling metrics, thermal estimates, or trade-off indicators.

In some embodiments, the method may further include outputting the baseline vehicle performance profile together with the predicted performance profile, in which the predicted performance profile includes at least one predicted horsepower value, one predicted torque value, or one graphical performance curve. For example, the processing system may render side-by-side or overlaid baseline-versus-predicted outputs in a user interface so that a user may view a stock or current-state torque curve against a candidate-package torque curve, compare predicted braking metrics, or evaluate predicted handling changes relative to the baseline vehicle performance profile. Presenting the baseline vehicle performance profile together with the predicted performance profile may improve interpretability of the recommendation and may allow users to understand not only the package itself but also the projected change attributable to the package.

In block 1470, the processing system may generate, for each candidate package, a package score that combines at least (i) a predicted performance delta derived from the predicted performance profile and (ii) a total installed cost of the candidate package. For example, the processing system may apply a weighted scoring function, optimization function, ratio, or composite utility model that combines predicted horsepower gains, torque gains, braking improvements, handling gains, thermal effects, or other predicted performance deltas with installed cost components such as parts cost, shipping, tax, labor, or supporting-component costs. Generating the package score may provide a common basis for ranking candidate packages that differ in both price and technical outcome. In some embodiments, the package score may also incorporate reliability factors, source-confidence weights, emissions constraints, or install-complexity penalties.

In some embodiments, the method may further include determining a recurring subset of the normalized part identifiers across the top-ranked subset of the candidate set; generating a package confidence score from (i) recurrence counts of the recurring subset, (ii) source credibility, (iii) historical outcome consistency, and (iv) community-validated fitment data associated with the recurring subset; and outputting the package confidence score with the structured package record. For example, the processing system may evaluate how often particular normalized part identifiers recur across top-ranked vehicle-build records, apply trust weights to the underlying sources, compare reported outcomes for consistency, and incorporate validated fitment confirmations to calculate a package confidence score associated with the recommended package. This package confidence score may distinguish packages that are repeatedly supported by credible and validated evidence from packages that rely on sparse or less trustworthy support.

In block 1472, the processing system may select a recommended package from the plurality of candidate packages according to the package scores and the budget. For example, the processing system may rank the candidate packages according to their package scores, discard candidate packages that exceed a hard or soft budget constraint, and then select a highest-ranked or otherwise preferred package according to one or more selection rules, tie-breaking rules, or business rules. Selecting the recommended package according to package scores and budget may produce a package that is responsive to both technical performance targets and economic feasibility for the target vehicle.

In block 1474, the processing system may generate a structured package record for the recommended package, the structured package record including normalized part identifiers, compatibility notes, and the predicted performance profile. For example, the processing system may serialize the recommended package into a normalized data structure that includes canonical part identifiers, quantities, brand identifiers, dependency notes, compatibility notes, cost summaries, baseline links, predicted performance outputs, and associated metadata such as timestamps, ranking data, or confidence values. Generating the structured package record may allow the recommended package to be stored, displayed, revised, shared, compared, or reused in later workflows. In some embodiments, the structured package record may also include supplier identifiers, fitment exceptions, installation-sequence notes, or references to associated vehicle-build records.

In block 1476, the processing system may store the structured package record in association with the target vehicle. For example, the processing system may write the structured package record to a vehicle-linked database table, document collection, garage record, or smart-collection store and may associate the stored structured package record with a user account, a target vehicle identifier, and one or more history records. Storing the structured package record in association with the target vehicle may allow the package to be surfaced later as part of the vehicle's modification history, a saved package, a planned package, a bookmarked package, or a future marketplace or service workflow.

In block 1478, the processing system may output, to a display device, the structured package record and the predicted performance profile as interactive vehicle modification options. For example, the processing system may cause a mobile device, web client, shop dashboard, or other display device to render one or more package cards, predicted performance graphs, baseline-versus-predicted views, fitment notes, compatibility notices, cost summaries, or selectable line items that allow a user to inspect the recommended package and related alternatives. Outputting the structured package record and the predicted performance profile as interactive vehicle modification options may allow a user to compare, save, reject, or modify a recommended package in a technically informed manner.

In some embodiments, the method may further include receiving an edit input that replaces, removes, or adds at least one vehicle modification in the recommended package; generating an edited package from the edit input; resolving each vehicle modification in the edited package against the stored vehicle and parts data to identify a corresponding part record; reapplying the compatibility constraints to the edited package; regenerating the predicted performance profile for the edited package; and outputting the edited package together with the regenerated predicted performance profile. For example, the processing system may receive a user selection that swaps one brand for another brand, removes a supporting part, adds a tune, or substitutes one wheel-and-tire combination for another, may resolve the edited line items against normalized part records in the stored vehicle and parts data, and may rerun compatibility filtering and predictive modeling before displaying updated package results. This edit flow may allow iterative refinement of an AI-generated package without requiring the processing system to discard the package and restart the entire recommendation process.

In some embodiments, the method may further include storing the edited package as a smart package associated with the target vehicle; storing package metadata for the smart package, the package metadata including at least a package identifier and at least one of a planned state, an installed state, or the regenerated predicted performance profile; receiving post-installation outcome data for the smart package; and updating the smart package and the stored vehicle and parts data using the post-installation outcome data. For example, the processing system may create a persistent smart-package object linked to the target vehicle, store revision history, install-state metadata, predicted outputs, and package notes, and later receive post-installation outcome data from user confirmations, dyno sheets, invoices, shop submissions, sensor logs, or telematics updates to refine the stored vehicle and parts data. Storing and updating the smart package in this manner may allow the platform to treat a recommended package as a reusable vehicle-linked object that may support later recommendations, analytics, garage presentation, and marketplace operations.

The various embodiments may include methods of generating and presenting a vehicle modification recommendation for a target vehicle, which may include receiving vehicle data for the target vehicle, the vehicle data which may include one or more of vehicle identifying information, installed modification data, performance data, and user preference data, retrieving industry data associated with the target vehicle, the industry data which may include one or more of manufacturer specification data, historical performance data, compatibility data, and safety data, normalizing the vehicle data and the industry data into structured vehicle data by mapping component descriptors in the vehicle data and the industry data to canonical vehicle component identifiers and standardized parameter fields, extracting recommendation features from the structured vehicle data, assigning relevance weights to the recommendation features, generating candidate modification sets for the target vehicle from the recommendation features by applying compatibility constraints represented in the structured vehicle data, executing a trained artificial intelligence model on the candidate modification sets and the structured vehicle data to generate projected outcome data and projected cost data for each candidate modification set, generating a performance per cost metric for each candidate modification set from the projected outcome data and the projected cost data, ranking the candidate modification sets according to the projected outcome data and the performance per cost metric, selecting a recommended candidate modification set from the candidate modification sets according to the ranking, generating a modification recommendation for the target vehicle from the recommended candidate modification set, generating a projected performance output for the modification recommendation from the projected outcome data corresponding to the recommended candidate modification set, and causing an electronic display to render the modification recommendation and the projected performance output.

Some embodiments may further include converting parameter values in the vehicle data and the industry data into standardized measurement units, and resolving missing or conflicting values in the vehicle data and the industry data while normalizing the vehicle data and the industry data into the structured vehicle data. Some embodiments may further include retrieving reference vehicle records associated with reference vehicles of other users, the reference vehicle records which may include installed modification data and modification outcome data, generating similarity scores between the target vehicle and the reference vehicles from the vehicle data and the reference vehicle records, and weighting at least one candidate modification set according to the modification outcome data for the reference vehicles having similarity scores that satisfy a similarity threshold. Some embodiments may further include receiving real time vehicle data from an onboard diagnostic interface or a sensor network associated with the target vehicle, updating the structured vehicle data with the real time vehicle data, and regenerating at least one of the projected outcome data, the projected cost data, the performance per cost metric, or the ranking responsive to the updated structured vehicle data. Some embodiments may further include extracting the recommendation features by identifying engine configuration data, drivetrain configuration data, suspension configuration data, tire configuration data, and installed modification state data from the structured vehicle data, and assigning the relevance weights according to safety priorities represented in the safety data and preference priorities represented in the user preference data.

Some embodiments may further include generating the candidate modification sets by applying fitment constraints between modification components and vehicle components, interdependency constraints among modification components, and safety constraints represented in the structured vehicle data, and excluding incompatible modification components from the candidate modification sets. Some embodiments may further include executing the trained artificial intelligence model to generate the projected outcome data which may include projected changes to at least one of horsepower, torque, acceleration, braking, handling, fuel efficiency, thermal load, emissions, or reliability for each candidate modification set. Some embodiments may further include generating a feasibility score for each candidate modification set from the projected outcome data, the compatibility constraints, and the safety data, and ranking the candidate modification sets further according to the feasibility score. Some embodiments may further include storing the structured vehicle data and historical modification outcome data in a vector database, retrieving contextual records for at least one candidate modification set by performing a similarity search against the vector database, and generating explanatory recommendation content for the modification recommendation from the contextual records. Some embodiments may further include receiving feedback data identifying user selection of the modification recommendation and post-installation performance data for the target vehicle, storing the feedback data and the post-installation performance data in an outcomes dataset, and retraining the trained artificial intelligence model using the outcomes dataset.

The various embodiments may also include methods of generating a vehicle-specific grouped modification package, the method which may include receiving vehicle profile data identifying a selected vehicle, installed modifications for the selected vehicle, an intended driving purpose for the selected vehicle, and a target budget for the selected vehicle, retrieving build documents from a document repository by matching vehicle parameters of the selected vehicle and semantic similarity to a recommendation objective derived from the intended driving purpose, assigning a document score to each retrieved build document by using semantic relevance, at least one validation signal, and at least one engagement signal associated with the retrieved build document, selecting a ranked subset of the retrieved build documents by comparing the document score assigned to each retrieved build document to a threshold, generating candidate part records for the selected vehicle from a validated automotive part knowledge base by using the ranked subset of the retrieved build documents, generating the grouped modification package from the candidate part records by applying compatibility constraints for the selected vehicle and package-level cost constraints for the target budget, generating a projected performance output for the grouped modification package relative to a current vehicle state of the selected vehicle, generating a package confidence score from source-confidence values and validation states associated with the candidate part records and the ranked subset of the retrieved build documents, and outputting the grouped modification package, the projected performance output, and the package confidence score.

Some embodiments may further include generating a suggested budget from vehicle valuation data, spending data for similar vehicles, and historical package outcome data, and assigning the suggested budget as the target budget after determining that the target budget may be absent. Some embodiments may further include generating a lower-cost grouped modification package, a target-budget grouped modification package, and a premium grouped modification package from the candidate part records, and outputting the lower-cost grouped modification package, the target-budget grouped modification package, and the premium grouped modification package.

Some embodiments may further include generating source-confidence values for the candidate part records and the ranked subset of the retrieved build documents, and generating the package confidence score from the source-confidence values, historical outcome consistency data, and community validation data. Some embodiments may further include generating a baseline performance curve for the current vehicle state, and generating a package performance curve for the grouped modification package relative to the baseline performance curve. Some embodiments may further include retrieving component images from at least one of internal vehicle records, internal part records, and external image sources, and outputting a package presentation object containing the grouped modification package and the component images. Some embodiments may further include receiving an edit input replacing a first candidate part record in the grouped modification package with a replacement part record, recalculating the projected performance output and the package confidence score, and outputting an edited grouped modification package. Some embodiments may further include storing the grouped modification package as a smart package linked to a vehicle record for the selected vehicle, and outputting the smart package through a garage interface.

Some embodiments include methods for maintaining a vehicle-build document repository for vehicle-modification recommendation generation, which may include receiving build-event data associated with a reference vehicle, generating or updating a build document for the reference vehicle by using the build-event data, generating or updating a composite repository score for the build document by using engagement data and validation data associated with the reference vehicle, generating a vector embedding for the build document, storing the build document in a document repository and storing the vector embedding in a vector database, receiving a recommendation request for a selected vehicle, retrieving candidate build documents by filtering the document repository according to vehicle parameters of the selected vehicle and by searching the vector database according to semantic similarity to the recommendation request, selecting a ranked subset of the candidate build documents by comparing the candidate build documents according to the composite repository score and the semantic similarity, and formatting structured context for a recommendation model from the ranked subset.

Some embodiments may further include storing a current-configuration subdocument, a historical-configuration subdocument, a performance subdocument, and an engagement subdocument in association with the build document. Some embodiments may further include generating the composite repository score by weighting views, likes, saves, comments, follows, verified installation outcomes, dyno uploads, and measured performance confirmations. Some embodiments may further include decrementing the composite repository score in response to flagged invalid parts, fitment failures, contradicted performance claims, or low-confidence source data. Some embodiments may further include generating a popularity-weighted grouped modification package from recurring part combinations identified across the ranked subset. Some embodiments may further include fine-tuning a recommendation model by using accepted grouped modification packages, actual installed-part outcomes, and updated build documents.

Some embodiments may include methods of generating a validated automotive brand and part knowledge base, which may include receiving candidate automotive data from multiple source systems, parsing the candidate automotive data into candidate brand objects and candidate part objects, resolving each candidate brand object against existing brand records by applying multiple matching operations, validating each unresolved candidate brand object by querying external automotive data and by evaluating semantic similarity outputs, assigning a brand validation state to each candidate brand object, creating or updating a canonical brand record for each candidate brand object according to the brand validation state, resolving each candidate part object against existing part records associated with the canonical brand record by comparing at least a normalized part number, a normalized part name, a semantic representation, and fitment metadata, assigning a part validation state to each candidate part object, creating or updating a canonical part record associated with the canonical brand record for each candidate part object according to the part validation state, and generating and storing vector embeddings for the canonical brand record and the canonical part record in a verified automotive data store.

Some embodiments may further include resolving each candidate brand object by applying exact matching, normalized-text matching, prefix matching, reverse-prefix matching, abbreviation matching, and vector-similarity matching.

Some embodiments may further include assigning the brand validation state and the part validation state from a set consisting of verified, provisionally verified, flagged for review, rejected, and user-limited. Some embodiments may further include weighting manufacturer-source data, distributor-source data, and normalized part-number matches more heavily than user-generated free text and single-source product descriptions while resolving each candidate part object. Some embodiments may further include creating a user-limited canonical part record after determining that the part validation state may be user-limited, and restricting exposure of the user-limited canonical part record to a user-specific workflow. Some embodiments may further include updating the canonical part record in response to confirmed installations, confirmed fitment, dyno results, reliability outcomes, counterfeit indicators, or incompatibility reports. Some embodiments may further include exposing the canonical brand records and the canonical part records through query interfaces to a recommendation engine, a marketplace engine, a visualization engine, and an authenticity engine. Some embodiments may further include storing source-confidence values, fitment metadata, performance metadata, reliability metadata, provenance data, and vector embeddings in association with each canonical part record.

Some embodiments may include methods of creating a structured modification record from a candidate automotive input, which may include receiving a candidate automotive input that includes one of a product URL and a free-form automotive text input, retrieving webpage content responsive to the product URL or parsing the free-form automotive text input into extracted automotive attributes, generating an extraction-ready representation from the webpage content or the extracted automotive attributes, determining whether the extraction-ready representation corresponds to an automotive component, generating a structured data object from the extraction-ready representation after determining that the extraction-ready representation corresponds to the automotive component, resolving a brand field and a part field in the structured data object against a validated automotive brand and part knowledge base, creating a modification record associated with at least one of a vehicle record, a user record, and a collection record by using the resolved brand field and the resolved part field, and outputting the modification record.

Some embodiments may further include validating a syntax of the product URL through client-side validation, and validating reachability of the product URL through server-side validation. Some embodiments may further include outputting a rejection message identifying a reason for rejection after determining that the extraction-ready representation does not correspond to the automotive component. Some embodiments may further include generating a preview object containing the resolved brand field, the resolved part field, and source data from the structured data object, and receiving a confirmation input selecting acceptance of the preview object before creating the modification record. Some embodiments may further include persisting a newly created brand record or a newly created part record after resolving the brand field and the part field and before receiving a confirmation input selecting acceptance of the preview object. Some embodiments may further include querying a verified automotive brand and part knowledge base, querying a secondary automotive data store after failing to identify a threshold match in the verified automotive brand and part knowledge base, and invoking web-based or model-based validation after failing to identify a threshold match in the secondary automotive data store. Some embodiments may further include generating an image record from an image URL or from search-based image retrieval, associating the image record with the modification record, and assigning the modification record to a vehicle collection or a smart collection.

Some embodiments may further include methods for generating fitment-aware marketplace outputs for a selected vehicle, which may include receiving marketplace listing data and vehicle profile data for the selected vehicle, normalizing the marketplace listing data and the vehicle profile data into a common listing schema, generating a fitment score for each marketplace listing by comparing listing attributes to vehicle specifications, installed modifications, and supporting modification requirements in the vehicle profile data, generating a relevance score for each marketplace listing by evaluating user interaction data, budget data, seller data, and inventory condition data, ranking the marketplace listings according to the fitment score and the relevance score, generating at least one of a personalized bundle, a recommended seller result, and a promotional offer from ranked marketplace listings that satisfy a compatibility condition for the selected vehicle, and outputting a vehicle-specific marketplace interface containing the ranked marketplace listings and the at least one of the personalized bundle, the recommended seller result, and the promotional offer.

Some embodiments may further include classifying the fitment score for each marketplace listing as exact fit, conditional fit, likely fit, or incompatible. Some embodiments may further include generating a recommended cart or a staged upgrade path by combining multiple ranked marketplace listings that satisfy the compatibility condition for the selected vehicle. Some embodiments may further include generating the promotional offer in response to over-inventory data, discount data, or campaign data associated with a seller and in response to a purchase-likelihood condition satisfied by the selected vehicle and a user profile associated with the selected vehicle. Some embodiments may further include generating the relevance score by weighting watchlist data, saved-item data, prior purchase data, followed-brand data, followed-seller data, and cart-addition data. Some embodiments may further include receiving vehicle listing data in addition to parts listing data, associating disclosed installed modifications in a vehicle listing to canonical part records, and ranking the vehicle listing according to the relevance score. Some embodiments may further include capturing views, saves, watchlist additions, cart additions, purchases, seller messages, confirmed fitment results, and confirmed installation results, and updating the fitment score or the relevance score from the captured outcomes.

Some embodiments may include methods for maintaining a vehicle-centric collaboration record and a publishable garage view, which may include receiving profile data for a user profile, a business profile, and a vehicle record, receiving build contribution data identifying at least one of an installed component, a performed service, captured media, an invoice, and a validation document associated with the vehicle record, generating a collaboration record linking the user profile, the business profile, and the vehicle record, storing permission data and attribution data in association with the collaboration record, generating a garage page from the vehicle record and the collaboration record, generating a short link that resolves to the garage page, and outputting the short link and the garage page.

Some embodiments may further include generating a business garage view containing a business identity section, a supported-service section, a portfolio-vehicle section, a gallery section, and at least one of an inventory section and a promotion section. Some embodiments may further include receiving an invitation input or a completed-transaction input, and generating the collaboration record in response to the invitation input or the completed-transaction input. Some embodiments may further include outputting the collaboration record through a user garage view, a business garage view, and an authorized group or feed view, and generating engagement analytics for the garage page or the collaboration record.

Some embodiments may include methods of generating a modified-vehicle valuation output, which may include receiving base vehicle valuation data for a vehicle record, receiving modification data associated with the vehicle record, the modification data which may include canonical part records, validation states, installation provenance, measured or predicted performance data, reliability data, popularity data, and fitment confidence data, generating a modification-specific adjustment from the modification data, generating a modified-vehicle score by combining the base vehicle valuation data and the modification-specific adjustment, selecting comparable modified vehicle records from a vehicle-build repository, generating a modified-vehicle price index from the comparable modified vehicle records and the modified-vehicle score, and outputting at least one of the modified-vehicle score and the modified-vehicle price index.

Some embodiments may further include generating the modification-specific adjustment by weighting measured or predicted performance impact, verified part value, component depreciation, brand quality, installation status, collaboration provenance, reliability history, community popularity, community trust, and fitment confidence. Some embodiments may further include weighting professionally installed modifications and modifications linked to confirmed business collaboration records more heavily than unverified self-reported modifications while generating the modification-specific adjustment. Some embodiments may further include generating the modified-vehicle price index by aggregating transaction data, valuation outcomes, community feedback, and verified build data for the comparable modified vehicle records. Some embodiments may further include outputting a valuation state identifying the vehicle record as under-valued, fairly valued, or over-valued relative to the comparable modified vehicle records, and outputting pricing guidance to a listing interface, an offer interface, or a transaction-review interface.

Further embodiments may include a computing device having a processor configured with processor-executable instructions to perform various operations corresponding to the methods discussed above. Further embodiments may include a computing device with various means to perform functions corresponding to the method operations discussed above. Further embodiments may include a non-transitory processor-readable storage medium having stored thereon processor-executable instructions configured to cause a processor to perform various operations corresponding to the method operations discussed above.

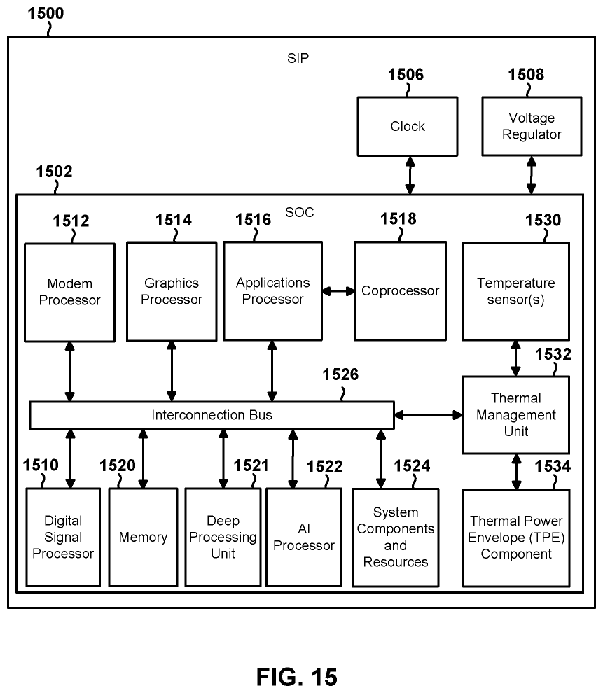

Various embodiments may be implemented on single-processor or multiprocessor computing systems, including a system-on-chip (SoC) or a system-in-package (SiP). FIG. 15 illustrates an example computing system architecture 1500 that may be used in computing devices implementing the various embodiments described herein, including generating vehicle-specific grouped modification packages, maintaining a validated automotive brand and part knowledge base, generating and ranking vehicle-build documents, creating collaboration records, generating fitment-aware marketplace outputs, and generating modified-vehicle valuation outputs.

With reference to FIG. 15, the computing system 1500 includes at least one SoC 1502, a clock 1506, and a voltage regulator 1508. The SoC 1502 may include a digital signal processor (DSP) 1510, a modem processor 1512, a graphics processor 1514, an application processor 1516, one or more coprocessors 1518, memory 1520, a deep processing unit (DPU) 1521, an artificial intelligence processor 1522, system components and resources 1524, an interconnection bus 1526, one or more temperature sensors 1530, a thermal management unit 1532, and a thermal power envelope (TPE) component 1534. These components may be interconnected via the bus 1526, which may utilize a high-performance network-on-chip (NoC).

In some embodiments, the application processor 1516 may be configured to manage higher-level workflows such as receiving vehicle profile data, installed-modification data, driving-purpose data, and budget data; maintaining vehicle records, business records, and collaboration records; coordinating build-document retrieval requests; managing package-editing sessions; and presenting recommendation, marketplace, publication, or valuation interfaces.

In some embodiments, the DPU 1521, the artificial intelligence processor 1522, and the one or more coprocessors 1518 may be configured to execute model-based operations including generating vector embeddings for vehicle-build documents, ranking retrieved vehicle-build documents according to semantic relevance and popularity or trust factors, classifying candidate inputs as automotive components, resolving brand and part entities against validated records, generating grouped modification packages across multiple budget bands, generating confidence scores, and generating predicted performance outputs.

In some embodiments, memory 1520 and the system components and resources 1524 may store canonical brand records, canonical part records, fitment metadata, vector embeddings, vehicle records, collaboration records, smart-package records, valuation data, user-signal data, seller-signal data, permissions data, and associated validation states. Such stored data may be used by one or more recommendation engines, marketplace engines, collaboration engines, valuation engines, or publication workflows.

In some embodiments, the DSP 1510 may be configured to process image data, audio data, telematics data, sensor data, or document data received from local or remote sources. For example, the DSP 1510 may support preprocessing operations for images of vehicles or parts, invoices, installation records, dyno charts, diagnostic outputs, receipts, or other source data used to verify modifications, update a vehicle record, or enrich a collaboration record. The graphics processor 1514 may render vehicle-specific recommendation interfaces, package-comparison interfaces, business-garage pages, sharable garage pages, fitment-aware marketplace interfaces, and valuation outputs.

In some embodiments, the modem processor 1512 and related communication circuitry may be configured to support wired or wireless communications with remote repositories, external data sources, marketplace services, business profiles, and user devices. Such communications may be used to retrieve build documents, synchronize canonical part data, upload collaboration evidence, retrieve inventory or promotional data, or update package, marketplace, or valuation outputs.

In some embodiments, the temperature sensors 1530, the thermal management unit 1532, and the TPE component 1534 may support sustained local inference or other compute-intensive processing while generating packages, embeddings, rankings, or valuation results. In some embodiments, certain operations may be performed locally at an edge device while other operations may be performed remotely at one or more server systems.

Although FIG. 15 illustrates one example architecture, embodiments may be implemented in single-processor systems, multiprocessor systems, cloud platforms, distributed processing environments, or combinations thereof. In some embodiments, local devices may capture and present data while remote systems perform large-scale data normalization, repository maintenance, retrieval, ranking, model execution, or model updates.

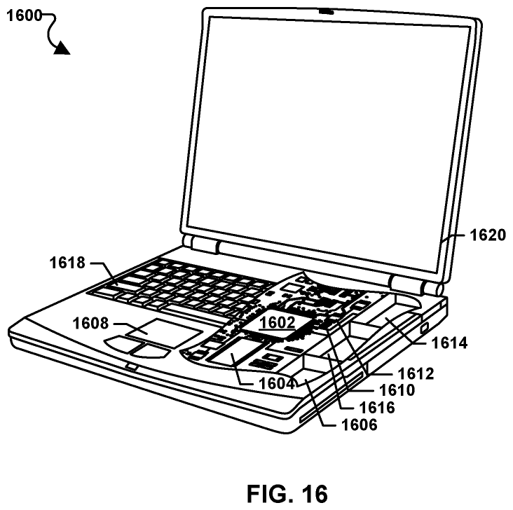

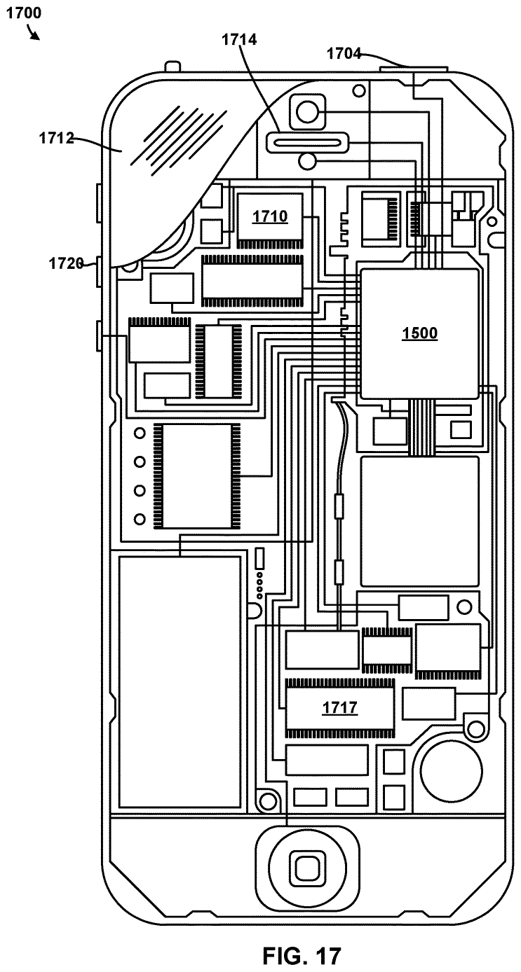

FIG. 16 illustrates an example laptop computing device 1600 configured to implement one or more operations described herein. The laptop 1600 may include a processor 1602, memory 1604, one or more communication or interface components 1606-1616, a keyboard 1618, and a display 1620. In some embodiments, the laptop 1600 may be used by an enthusiast user, a business user, or an administrative user to create or edit vehicle records, review grouped modification packages, validate candidate brand or part data, manage business-garage content, review collaboration records, manage seller inventory, or review fitment-aware marketplace outputs.

In some embodiments, the display 1620 and keyboard 1618 may support multi-pane workflows in which a user compares grouped modification package tiers, edits a smart package by replacing candidate parts or brands, reviews predicted performance outputs, confirms uploaded modification records, reviews validation states, or publishes sharable garage pages. A business user may additionally use the laptop 1600 to review portfolio vehicles, attach services or installed parts to collaboration records, review seller analytics, publish promotional content, or manage bundled part or service offerings.

FIG. 17 illustrates an example mobile computing device 1700 configured for in-field or on-vehicle use. The mobile computing device 1700 may include a touch-sensitive display 1712, one or more acoustic or output components 1714, one or more capture or sensor components 1704, a system-on-chip 1500, and one or more additional processing or memory components 1710 and 1717. The device 1700 may further include one or more side controls 1720 or other user input components. In some embodiments, the mobile computing device 1700 may be used to capture vehicle images, part images, receipts, installation evidence, or other source data; to add modifications to a vehicle record; to confirm collaboration events; to review grouped modification packages; to view fitment-aware marketplace listings; or to publish and share a vehicle-specific garage page.

The mobile computing device 1700 may travel with the user, and thus may be used at a vehicle location, a shop location, an event location, or a sales location to create or update vehicle-build documents in near real time. For example, a user may capture images or documents associated with a newly installed component, confirm a recommended package, upload data supporting a collaboration record, browse compatible marketplace listings for a selected vehicle, or view a modified-vehicle valuation output generated from locally captured or remotely retrieved data.

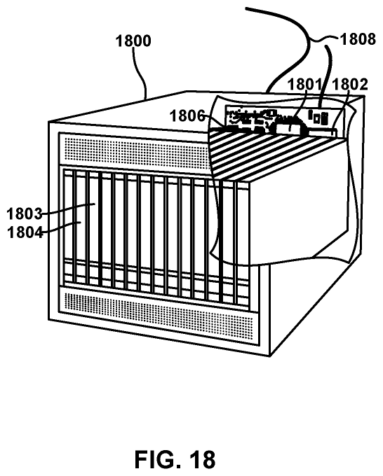

FIG. 18 illustrates an example server computing device 1800 that may support cloud-based or distributed execution of the disclosed methods. The server computing device 1800 may include one or more processing components 1801, one or more memory components 1802, one or more storage components 1803 and 1804, one or more internal interfaces 1806, and one or more network access ports 1808. In some embodiments, the server computing device 1800 may store or manage a vehicle-build document repository, a vector database, a validated automotive brand and part knowledge base, a fitment repository, collaboration records, business-garage records, marketplace records, package records, valuation records, and associated models or indexes.

In some embodiments, the server computing device 1800 may perform higher-scale operations such as large-batch data normalization, canonical brand and part resolution, embedding generation, build-document ranking, package generation across multiple budget bands, popularity-weighted recommendation generation, collaboration-record synchronization, fitment-aware listing ranking, bundle generation, valuation-index generation, and model training or model updates. In some embodiments, the server computing device 1800 may coordinate with one or more laptop computing devices 1600, one or more mobile computing devices 1700, or other client systems so that capture, editing, recommendation, commerce, collaboration, and valuation functions are distributed across local and remote computing resources.

For the sake of clarity and ease of presentation, the methods discussed in this application are presented as separate embodiments. While each method is delineated for illustrative purposes, it should be clear to those skilled in the art that various combinations or omissions of these methods, blocks, operations, etc. could be used to achieve a desired result or a specific outcome. It should also be understood that the descriptions herein do not preclude the integration or adaptation of different embodiments of the methods, blocks, operations, etc. from producing a modified or alternative result or solution. The presentation of individual methods, blocks, operations, etc. should not be interpreted as mutually exclusive, limiting, or as being required unless expressly recited as such in the claims.

The processors discussed in this application may be any programmable microprocessor, microcomputer, or a combination of multiple processor chips configured by software instructions (applications) to perform diverse functions, including those of the various embodiments described herein. Servers often include multiple processors, with dedicated processors for specific tasks such as managing cloud computing operations, data analytics, or wireless communication functions. Software applications may be stored in the internal memory before being accessed and executed by the processor. Modern processors may include extensive internal memory, often augmented with fast access cache memory, to efficiently store and process application software instructions.

As used in this application, terminology such as “component,” “module,” “system,” etc., is intended to encompass a computer-related entity. These entities may involve, among other possibilities, hardware, firmware, a blend of hardware and software, software alone, or software in an operational state. As examples, a component may encompass a running process on a processor, the processor itself, an object, an executable file, a thread of execution, a program, or a computing device. To illustrate further, both an application operating on a computing device and the computing device itself may be designated as a component. A component might be situated within a single process or thread of execution or could be distributed across multiple processors or cores. In addition, these components may operate based on various non-volatile computer-readable media that store diverse instructions and/or data structures. Communication between components may take place through local or remote processes, function, or procedure calls, electronic signaling, data packet exchanges, memory interactions, among other known methods of network, computer, processor, or process-related communications.

A variety of memory types and technologies, both currently available and anticipated for future development, may be incorporated into systems and computing devices that implement the various embodiments. These memory technologies may include non-volatile random-access memories (NVRAM) such as magnetoresistive RAM (MRAM), resistive random-access memory (ReRAM or RRAM), phase-change memory (PCM, PC-RAM, or PRAM), ferroelectric RAM (FRAM), spin-transfer torque magnetoresistive RAM (STT-MRAM), and three-dimensional cross point (3D XPoint) memory. Non-volatile or read-only memory (ROM) technologies may also be included, such as programmable read-only memory (PROM), field programmable read-only memory (FPROM), and one-time programmable non-volatile memory (OTP NVM). Volatile random-access memory (RAM) technologies may further be utilized, including dynamic random-access memory (DRAM), double data rate synchronous dynamic random-access memory (DDR SDRAM), static random-access memory (SRAM), and pseudostatic random-access memory (PSRAM). Additionally, systems and computing devices implementing these embodiments may use solid-state non-volatile storage mediums, such as FLASH memory. The aforementioned memory technologies may store instructions, programs, control signals, and/or data for use in computing devices, system-on-chip (SoC) components, or other electronic systems. Any references to specific memory types, interfaces, standards, or technologies are provided for illustrative purposes and do not limit the claims to any particular memory system or technology unless explicitly recited in the claim language.

The foregoing method descriptions and the process flow diagrams are provided merely as illustrative examples and are not intended to require or imply that the blocks of the various aspects must be performed in the order presented. As may be appreciated by one of skill in the art the order of steps in the foregoing aspects may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithmic steps described in connection with the aspects disclosed herein may be implemented as electronic hardware, computer software, or combinations of both. To clearly illustrate the interchangeability of hardware and software, various components, blocks, modules, circuits, and steps have been described in terms of their functionality. Whether such functionality is implemented as hardware or software may depend on the specific application and the design constraints of the overall system. Skilled artisans may implement the described functionality in different ways for each particular application, and such implementation decisions should not be interpreted as limiting or altering the scope of the claims unless explicitly recited in the claim language.

The hardware used to implement the various illustrative logics, logical blocks, modules, and circuits described in connection with the embodiments disclosed herein may include or be performed by a general-purpose processor, a digital signal processor (DSP), an application-specific integrated circuit (ASIC), a field-programmable gate array (FPGA), a graphics processing unit (GPU), a tensor processing unit (TPU), or other programmable logic devices, discrete gate or transistor logic, discrete hardware components, or any combination thereof, designed to perform the functions described. A general-purpose processor may be a microprocessor, or alternatively, it may be any conventional processor, controller, microcontroller, or state machine. A processor may also be implemented as a combination of computing devices, such as a DSP combined with a microprocessor, multiple microprocessors, one or more microprocessors used in conjunction with a DSP core, a GPU, or AI accelerators such as TPUs. Alternatively, some operations or methods may be performed by circuitry designed specifically for a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module that resides on a non-transitory computer-readable or processor-readable storage medium. Non-transitory computer-readable or processor-readable storage media include any storage media that may be accessed by a computer or processor. By way of example, but not limitation, such non-transitory computer-readable or processor-readable media may include RAM, ROM, EEPROM, flash memory, SSDs, NVMe drives, 3D NAND flash, or any other medium capable of storing program code in the form of instructions or data structures that may be accessed by a computer. Cloud-based storage solutions, including infrastructure-as-a-service (IaaS) platforms, may provide scalable and distributed options for storing and accessing program code. In addition, the operations of a method or algorithm may reside as one or more sets of instructions or code on a non-transitory processor-readable or computer-readable medium, which may be incorporated into a computer program product. Emerging technologies, such as quantum computing storage media and blockchain-based storage solutions, may enhance data integrity and security. AI and ML-optimized hardware accelerators, such as GPUs, TPUs, and other dedicated processing units, may be used to efficiently execute complex algorithms.

The preceding description of the disclosed aspects is provided to enable any person skilled in the art to make or use the claims. Various modifications to these aspects may be apparent to those skilled in the art, and the generic principles defined herein may be applied to other aspects without departing from the scope of the claims. Thus, the present disclosure is not intended to be limited to the aspects shown herein but is to be accorded the widest scope consistent with the following claims and the principles and novel features disclosed herein.

What is claimed is:

1. A computing device, comprising:
a processing system configured to:
receive vehicle-identifying information including at least a year, make, model, and trim of a target vehicle;
receive a budget and a user objective for the target vehicle;
process the vehicle-identifying information, the budget, and the user objective using stored vehicle and parts data to identify, for the target vehicle, a plurality of vehicle modifications that are compatible with the target vehicle and with one another and to select, from candidate package-level combinations formed from the plurality of vehicle modifications, a recommended package according to a projected performance-per-cost score for the target vehicle;
generate a vehicle modification package as the recommended package comprising at least a subset of the plurality of vehicle modifications;
generate a predicted performance output for the target vehicle based on installation of the recommended package; and
cause an electronic display of a user device to render the vehicle modification package and the predicted performance output.

2. The computing device of claim 1, wherein the processing system is configured to process the vehicle-identifying information, the budget, and the user objective by:
generating a structured vehicle record for the target vehicle from the vehicle-identifying information;
retrieving, using the structured vehicle record, candidate part records for the target vehicle, each candidate part record including a part identifier, compatibility metadata, and cost data;
generating the candidate package-level combinations from the candidate part records;
applying vehicle fitment constraints and component interaction constraints to the candidate package-level combinations to identify candidate package-level combinations that satisfy the vehicle fitment constraints and the component interaction constraints;
obtaining, for each candidate package-level combination that satisfies the vehicle fitment constraints and the component interaction constraints, predicted performance data and total installed cost;
generating, for each candidate package-level combination that satisfies the vehicle fitment constraints and the component interaction constraints, a respective projected performance-per-cost score from the predicted performance data and the total installed cost; and
selecting, from the candidate package-level combinations that satisfy the vehicle fitment constraints and the component interaction constraints, the recommended package according to the respective projected performance-per-cost scores, the budget, and the user objective.

3. The computing device of claim 2, wherein the processing system is further configured to:
generate a structured package record for the vehicle modification package, the structured package record comprising normalized part identifiers for the subset of the plurality of vehicle modifications and the predicted performance output; and
cause a digital vehicle record associated with the target vehicle to be updated with the structured package record to store the vehicle modification package in association with the target vehicle.

4. The computing device of claim 2, wherein the processing system is configured to retrieve the candidate part records by:
generating a request embedding from at least a portion of the vehicle-identifying information, the budget, and the user objective;
retrieving a candidate set of vehicle-build records using semantic similarity between the request embedding and stored vehicle-build-record embeddings in a vector database;
ranking the candidate set of vehicle-build records according to semantic relevance and at least one of a popularity score, a source-credibility score, a historical-outcome-consistency score, or community-validated fitment data; and
supplementing the candidate part records with normalized part identifiers and associated fitment metadata retrieved from a top-ranked subset of the candidate set.

5. The computing device of claim 4, wherein the processing system is further configured to:
determine a recurring subset of the normalized part identifiers across the top-ranked subset of the candidate set;
generate a package confidence score based on (i) recurrence counts for the recurring subset, (ii) one or more source-credibility scores associated with the top-ranked subset, (iii) historical-outcome-consistency data associated with the recurring subset, and (iv) community-validated fitment data associated with the recurring subset; and
cause the electronic display of the user device to render the package confidence score with the vehicle modification package.

6. The computing device of claim 2, wherein:
the processing system is further configured to:
receive currently installed vehicle modifications for the target vehicle;
receive real-time vehicle sensor data from an onboard diagnostic interface associated with the target vehicle;
receive a driving purpose and one or more priority weights for the user objective; and
generate a current vehicle state from the currently installed vehicle modifications and the real-time vehicle sensor data, and
the processing system is configured to obtain, for each candidate package-level combination that satisfies the vehicle fitment constraints and the component interaction constraints, the predicted performance data by obtaining the predicted performance data based further on the current vehicle state, the driving purpose, and the one or more priority weights.

7. The computing device of claim 6, wherein the processing system is configured to generate the predicted performance output by:
generating a baseline performance profile for the target vehicle from stored vehicle specification data and the current vehicle state; and
generating the predicted performance output relative to the baseline performance profile.

8. The computing device of claim 7, wherein the processing system is configured to:
generate the predicted performance output to include at least one predicted horsepower value, at least one predicted torque value, at least one predicted braking metric, at least one predicted handling metric, or at least one graphical performance curve; and
cause the electronic display of the user device to render the vehicle modification package and the predicted performance output by causing the electronic display of the user device to render the baseline performance profile together with the predicted performance output.

9. The computing device of claim 2, wherein the processing system is configured to generate the candidate package-level combinations by:
determining a plurality of budget bands from the budget;
generating a plurality of candidate packages corresponding to the plurality of budget bands;
obtaining, for each candidate package, respective predicted performance data and respective total installed cost;
generating, for each candidate package, a respective projected performance-per-cost score from the respective predicted performance data and the respective total installed cost;
ranking the plurality of candidate packages according to the respective projected performance-per-cost scores; and
selecting the recommended package from the plurality of candidate packages according to the ranking.

10. The computing device of claim 2, wherein the processing system is further configured to:
receive an edit input associated with the vehicle modification package, the edit input specifying replacement, removal, or addition of at least one vehicle modification;
generate an edited vehicle modification package from the edit input;
resolve each vehicle modification in the edited vehicle modification package against the candidate part records to identify a corresponding candidate part record;
reapply the vehicle fitment constraints and the component interaction constraints to the edited vehicle modification package and to the corresponding candidate part records to verify compatibility of the edited vehicle modification package;
regenerate the predicted performance output for the edited vehicle modification package; and
cause the electronic display of the user device to render the edited vehicle modification package together with the regenerated predicted performance output.

11. The computing device of claim 1, wherein the processing system is configured to cause the electronic display of the user device to render the vehicle modification package and the predicted performance output by causing an electronic display of the computing device to render the vehicle modification package and the predicted performance output.

12. The computing device of claim 1, wherein the processing system is configured to cause the electronic display of the user device to render the vehicle modification package and the predicted performance output by causing an electronic display of a remote computing device to render the vehicle modification package and the predicted performance output.

13. A computer-implemented method, performed by a processing system in a computing device, for generating a vehicle modification package for a target vehicle, the method comprising:
receiving vehicle-identifying information including at least a year, make, model, and trim of the target vehicle;
receiving a budget and a user objective for the target vehicle;
processing the vehicle-identifying information, the budget, and the user objective using stored vehicle and parts data to identify, for the target vehicle, a plurality of vehicle modifications that are compatible with the target vehicle and with one another and to select, from candidate package-level combinations formed from the plurality of vehicle modifications, a recommended package according to a projected performance-per-cost score for the target vehicle;
generating the vehicle modification package as the recommended package comprising at least a subset of the plurality of vehicle modifications;
generating a predicted performance output for the target vehicle based on installation of the recommended package; and
causing an electronic display of a user device to render the vehicle modification package and the predicted performance output.

14. The method of claim 13, wherein processing the vehicle-identifying information, the budget, and the user objective comprises:
generating a structured vehicle record for the target vehicle from the vehicle-identifying information;
retrieving, using the structured vehicle record, candidate part records for the target vehicle, each candidate part record including a part identifier, compatibility metadata, and cost data;
generating the candidate package-level combinations from the candidate part records;
applying vehicle fitment constraints and component interaction constraints to the candidate package-level combinations to identify candidate package-level combinations that satisfy the vehicle fitment constraints and the component interaction constraints;
obtaining, for each candidate package-level combination that satisfies the vehicle fitment constraints and the component interaction constraints, predicted performance data and total installed cost;
generating, for each candidate package-level combination that satisfies the vehicle fitment constraints and the component interaction constraints, a respective projected performance-per-cost score from the predicted performance data and the total installed cost; and
selecting, from the candidate package-level combinations that satisfy the vehicle fitment constraints and the component interaction constraints, the recommended package according to the respective projected performance-per-cost scores, the budget, and the user objective.

15. The method of claim 14, further comprising:
generating a structured package record for the vehicle modification package, the structured package record comprising normalized part identifiers for the subset of the plurality of vehicle modifications and the predicted performance output; and
causing a digital vehicle record associated with the target vehicle to be updated with the structured package record to store the vehicle modification package in association with the target vehicle.

16. The method of claim 14, wherein retrieving the candidate part records comprises:
generating a request embedding from at least a portion of the vehicle-identifying information, the budget, and the user objective;
retrieving a candidate set of vehicle-build records using semantic similarity between the request embedding and stored vehicle-build-record embeddings in a vector database;
ranking the candidate set of vehicle-build records according to semantic relevance and at least one of a popularity score, a source-credibility score, a historical-outcome-consistency score, or community-validated fitment data; and
supplementing the candidate part records with normalized part identifiers and associated fitment metadata retrieved from a top-ranked subset of the candidate set.

17. The method of claim 16, further comprising:
determining a recurring subset of the normalized part identifiers across the top-ranked subset of the candidate set;
generating a package confidence score based on (i) recurrence counts for the recurring subset, (ii) one or more source-credibility scores associated with the top-ranked subset, (iii) historical-outcome-consistency data associated with the recurring subset, and (iv) community-validated fitment data associated with the recurring subset; and
causing the electronic display of the user device to render the package confidence score with the vehicle modification package.

18. The method of claim 14, further comprising:
receiving currently installed vehicle modifications for the target vehicle;
receiving real-time vehicle sensor data from an onboard diagnostic interface associated with the target vehicle;
receiving a driving purpose and one or more priority weights for the user objective; and
generating a current vehicle state from the currently installed vehicle modifications and the real-time vehicle sensor data,
wherein obtaining, for each candidate package-level combination that satisfies the vehicle fitment constraints and the component interaction constraints, the predicted performance data comprises obtaining the predicted performance data based further on the current vehicle state, the driving purpose, and the one or more priority weights.

19. The method of claim 14, wherein generating the candidate package-level combinations comprises:
determining a plurality of budget bands from the budget;
generating a plurality of candidate packages corresponding to the plurality of budget bands;
obtaining, for each candidate package, respective predicted performance data and respective total installed cost;
generating, for each candidate package, a respective projected performance-per-cost score from the respective predicted performance data and the respective total installed cost;
ranking the plurality of candidate packages according to the respective projected performance-per-cost scores; and
selecting the recommended package from the plurality of candidate packages according to the ranking.

20. A non-transitory processor-readable medium having stored thereon data, configurations, or processor-readable instructions to cause at least one processor in a processing system in a computing device to perform operations for generating a vehicle modification package for a target vehicle, the operations comprising:
receiving vehicle-identifying information including at least a year, make, model, and trim of the target vehicle;
receiving a budget and a user objective for the target vehicle;
processing the vehicle-identifying information, the budget, and the user objective using stored vehicle and parts data to identify, for the target vehicle, a plurality of vehicle modifications that are compatible with the target vehicle and with one another and to select, from candidate package-level combinations formed from the plurality of vehicle modifications, a recommended package according to a projected performance-per-cost score for the target vehicle;
generating the vehicle modification package as the recommended package comprising at least a subset of the plurality of vehicle modifications;
generating a predicted performance output for the target vehicle based on installation of the recommended package; and
causing an electronic display of a user device to render the vehicle modification package and the predicted performance output.
